(19) United States
(12) Patent Application Publication
(10) Pub. No.: US 2010/0254447 A1
(43) Pub. Date: Oct. 7, 2010

(54) INFORMATION PROCESSING APPARATUS, INFORMATION PROCESSING METHOD, PROGRAM AND RECORDING MEDIUM

(75) Inventor: Shinobu Hattori, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/750,982

(22) Filed: Mar. 31, 2010

(30) Foreign Application Priority Data
Apr. 7, 2009 (JP) 2009-093160

(51) Int. Cl. H04N 11/02; H04N 5/00

(52) U.S. Cl. 375/240.01; 386/126; 375/E07.026; 386/E05.061

(57) ABSTRACT

A circuit includes a setting unit that sets Clip type information that is information indicating a Clip of Base view video to a Clip information file describing information about a Clip that is a playback zone of a stream of the Base view video generated by encoding a plurality of video data with predetermined encoding format, and sets Clip type information indicating a Clip of Dependent view video to a Clip information file of the Clip of the Dependent view video generated by the encoding.

### BACKGROUND OF THE INVENTION

1. Field of the Invention

The present invention relates to an information processing apparatus, an information processing method, a program and a recording medium, and particularly to an information processing apparatus, an information processing method, a program and a recording medium that enables appropriate playback of three-dimensional (3D) image content from a recording medium.

2. Description of the Related Art

For example, there has been mostly two-dimensional (2D) image content as content of movies or the like, but in recent years, three-dimensional (3D) image (graphic) content that enables a stereoscopic view has gained attention.

As a display mode of 3D images (hereinafter, also referred to as stereo images), there are various modes, but even though any mode is employed, the data amount of 3D images is greater than the data amount of 2D images.

In addition, images content with high resolution such as movies or the like are mostly with a large amount of capacity, and a recording medium with great capacity is necessary for recording image content with a large amount of capacity by converting into 3D images that have a great amount of data.

As such a recording medium with such great capacity, for example, there are Blu-Ray (registered trademark) disc (hereinafter, referred to as “BD”) such as Blu-Ray (registered trademark) Disc (BD)-Read Only Memory (ROM), or the like.

Here, there was suggested a file management device that a recording position in a recording medium for signals is designated with a predetermined unit smaller than a sector by filing means to be a file, and in an editing process where the filed signals are divided or combined in an optional position, the editing process can be performed only on file management information and thereby the editing process can be gradually simplified without a necessity of re-recording only an editing target portion of the appropriate signals on the recording medium so as to be filed (Japanese Unexamined Patent Application Publication No. 11-195287).

### SUMMARY OF THE INVENTION

The current BD standard does not prescribe that how 3D image content is to be recorded or played back on a BD.

However, there is a concern that, if a method of recording or playing back of 3D image content is entrusted to an author that performs authoring of the 3D image content, the 3D image content is not able to be appropriately played back.

The present invention took into consideration such matters and it is desirable that it can appropriately play back stereo image (3D image) content from a recording medium such as a BD or the like.

According to a first embodiment of the present invention, there is provided an information processing apparatus including a setting unit configured to set Clip type information that is information indicating a Clip of Base view video to a Clip information file describing information about a Clip that is a playback zone of a stream of the Base view video generated by encoding a plurality of video data with predetermined encoding format, and set Clip type information indicating a Clip of Dependent view video to a Clip information file of the Clip of the Dependent view video generated by the encoding.

According to the above embodiment of the present invention, the setting unit can set application type information that is information indicating a type of an application that performs a process by using a Clip to each of the Clip information file of the Base view video and the Clip information file of the Dependent view video.

According to the above embodiment of the present invention, the setting unit can set identification information of the Clip information file of the Clip of the Dependent view video used in the playback of three-dimensional images together with the data of the Clip of the Base view video to an extended region of the Clip information file of the Base view video.

According to the above embodiment of the present invention, the setting unit can further set identification information of a virtual file that manages data of the Clip of the Base view video and data of the Clip of the Dependent view video to an extended region of the Clip information file of the Base view video.

According to the above embodiment of the present invention, when the data of the Clip of the Base view video and the data of the Clip of the Dependent view video are recorded on an optical disc in a state of being interleaved in an Extent unit that is a predetermined data unit, the setting unit can set information about the Extent of the Base view video to an extended region of the Clip information file of the Base view video and sets information about the Extent of the Dependent view video to an extended region of the Clip information file of the Clip of the Dependent view video.

According to the above embodiment of the present invention, the information about the Extents can include position information and length information in the optical disc of each of the Extents.

According to a second embodiment of the present invention, there is provided an information processing method including the steps of setting Clip type information that is information indicating a Clip of Base view video to a Clip information file describing information about a Clip that is a playback zone of a stream of the Base view video generated by encoding a plurality of video data with predetermined encoding format, and setting Clip type information indicating a Clip of Dependent view video to a Clip information file of the Clip of the Dependent view video generated by the encoding.

According to a third embodiment of the present invention, there is provided a program prompting a computer to execute a process including the steps of setting Clip type information that is information indicating a Clip of Base view video to a Clip information file describing information about a Clip that is a playback zone of a stream of the Base view video generated by encoding a plurality of video data with predetermined encoding format, and setting Clip type information indicating a Clip of Dependent view video to a Clip information file of the Clip of the Dependent view video generated by the encoding.

According to a fourth embodiment of the present invention, there is provided a recording medium that is set with Clip type information that is information indicating a Clip of Base view video to a Clip information file describing information about a Clip that is a playback zone of a stream of the Base view video generated by encoding a plurality of video data with predetermined encoding format, and set with Clip type information indicating a Clip of Dependent view video to a Clip information file of the Clip of the Dependent view video generated by the encoding.

According to a fifth embodiment of the present invention, a Clip information file describing information about a Clip that is a playback zone of a stream of Base view video generated by encoding a plurality of video data with predetermined encoding format is set with Clip type information that is information indicating a Clip of the Base view video, and a Clip information file of a Clip of Dependent view video generated by the encoding is set with Clip type information indicating the Clip of the Dependent view video.

According to the present invention, it is possible to appropriately play back stereo image (3D image) content.

### BRIEF DESCRIPTION OF THE DRAWINGS

FIG. 1 is a diagram explaining the outline of a BDMV format;

FIG. 2 is a diagram explaining a management structure of files on a BD;

FIG. 3 is a block diagram illustrating an example of a composition of an embodiment of a playback device to which an information processing apparatus of the present invention is applied;

FIGS. 4A to 4D are diagrams explaining streams and files recorded on a disc;

FIG. 5 is a diagram explaining the management of files on the disc by a file system;

FIG. 6 is a diagram explaining the reading of Extents from the disc by the file system;

FIG. 7 is a diagram explaining a method of dividing virtual Extents read from files for 3D Type 1 playback into an Extent Ext2 of a first enhanced stream and an Extent Ext1 of a Base stream;

FIG. 8 is a block diagram illustrating an example of a composition of a 3D file controller;

FIG. 9 is a block diagram illustrating an example of a composition of an embodiment of a recording device to which the information processing apparatus of the present invention is applied;

FIGS. 10A to 10D are diagrams explaining streams and files recorded on the disc;

FIG. 11 is a diagram explaining the management of files on the disc by the file system;

FIG. 12 is a diagram explaining reading of Extents from the disc by the file system;

FIG. 13 is a diagram explaining a method of dividing virtual Extents read from files for 3D Type 1 playback into an Extent Ext2 of a first enhanced stream and an Extent Ext1 of a Base stream;

FIG. 14 is a block diagram illustrating an example of a composition of an embodiment of a computer to which the present invention is applied;

FIG. 15 is a diagram illustrating an example of a composition of a playback system including a playback device to which the present invention is applied;

FIG. 16 is a diagram illustrating an example of imaging;

FIG. 17 is a block diagram illustrating an example of a composition of an MVC encoder;

FIG. 18 is a diagram illustrating an example of reference images;

FIG. 19 is a diagram illustrating an example of the composition of TS;

FIG. 20 is a diagram illustrating another example of the composition of the TS;

FIG. 21 is a diagram illustrating still another example of the composition of the TS;

FIG. 22 is a diagram illustrating an example of the management of AV streams;

FIG. 23 is a diagram illustrating the structure of Main Path and Sub Path;

FIG. 24 is a diagram illustrating an example of the management structure of files recorded on an optical disc;

FIG. 25 is a diagram illustrating the syntax of a PlayList file;

FIG. 26 is a diagram illustrating the syntax of PlayList( ) of FIG. 25;

FIG. 27 is a diagram illustrating the syntax of SubPath( ) of FIG. 26;

FIG. 28 is a diagram illustrating the syntax of SubPlayItem(i) of FIG. 27;

FIG. 29 is a diagram illustrating the syntax of PlayItem( ) of FIG. 26;

FIG. 30 is a diagram illustrating the syntax of STN_table( ) of FIG. 29;

FIG. 31 is a diagram illustrating a specific example of 3D_PlayList;

FIG. 32 is a diagram illustrating the meanings of types;

FIG. 33 is a diagram illustrating the meanings of SubPath_type;

FIG. 34 is a block diagram illustrating an example of a composition of a playback device;

FIG. 35 is a diagram illustrating an example of a composition of a decoder unit shown in FIG. 34;

FIG. 36 is a diagram illustrating an example of 3D_PlayList;

FIGS. 37A to 37C are diagrams illustrating the syntax of a clpi file;

FIG. 38 is a diagram illustrating the concept of file management performed by using the data of FIG. 36 and FIGS. 37A to 37C;

FIG. 39 is a flowchart explaining a playback process performed according to the 3D_PlayList file of FIG. 36;

FIG. 40 is a diagram illustrating an example of the syntax of chunk_map( );

FIGS. 41A to 41C are diagrams illustrating a specific example of chunk_map( );

FIGS. 42A to 42D are diagrams illustrating the separation of chunks;

FIG. 43 is a diagram illustrating another example of the 3D_PlayList;

FIGS. 44A and 44B are diagrams illustrating the syntax of a clpi file;

FIG. 45 is a diagram illustrating the concept of file management performed by using the data of FIG. 43 and FIGS. 44A and 44B;

FIG. 46 is a flowchart explaining a playback process performed according to the 3D_PlayList file of FIG. 43;

FIG. 47 is a diagram illustrating still another example of the 3D_PlayList;

FIGS. 48A and 48B are diagrams illustrating the syntax of a clpi file;

FIG. 49 is a diagram illustrating the concept of file management performed by using the data of FIG. 47 and FIGS. 48A and 48B;

FIG. 50 is a flowchart explaining a playback process performed according to the 3D_PlayList file of FIG. 47;

FIG. 51 is a diagram illustrating the gathered contents of the chunk_map( ) in FIGS. 41A to 41C;

FIG. 52 is a diagram illustrating the syntax of EP_map( );

FIG. 53 is a flowchart explaining a random access process of a playback device;

FIG. 54 is a diagram illustrating an example of a position specified by the process of Step S44 and Step S45;

FIG. 55 is a diagram illustrating SPN_chunk_start[k] specified by the process of Step S46;

FIG. 56 is a diagram illustrating a structure of AV stream recorded on an optical disc;

FIG. 57 is a diagram illustrating an example of Clip AV stream;

FIG. 58 is a diagram illustrating an example of EP_map;

FIG. 59 is a diagram illustrating an example of the structure of source packet data that SPN_EP_start indicates;

FIG. 60 is a diagram illustrating an example of file management by a playback device;

FIG. 61 is a diagram illustrating the meanings of 3D_Clip_types;

FIG. 62 is a diagram illustrating the meanings of 3D_App_types;

FIG. 63 is a diagram illustrating an example of setting 3D_Clip_type and 3D_App_type;

FIG. 64 is a diagram illustrating the syntax of a clpi file;

FIG. 65 is a diagram illustrating a specific example of the description in ExtensionData( ) of a clpi file;

FIG. 66 is a diagram illustrating another specific example of the description in ExtensionData( ) of a clpi file;

FIG. 67 is a diagram illustrating another example of file management by a playback device;

FIG. 68 is a diagram illustrating an example of the file management structure;

FIG. 69 is a diagram illustrating the syntax of an Interleave ClipInfo file;

FIG. 70 is a block diagram illustrating an example of the composition of a software production processing unit; and

FIG. 71 is a diagram illustrating an example of a composition including the software production processing unit.

### DESCRIPTION OF THE PREFERRED EMBODIMENTS

### First Embodiment

Hereinbelow, an embodiment of the present invention will be described exemplifying a case where the present invention is applied to a BD.

### Management Structure of BD

First of all, with respect to the present BD, the management structure of AV (Audio/Video) data and the like as content recorded on a BD-ROM which is a BD of a reading-dedicated type prescribed in “Blu-ray Disc Read-Only Format Ver. 1.0 part 3 Audio Visual Specifications” (hereinafter referred to as a BDMV format) will be described.

In the BD standard, for example, a bit stream which is encoded with methods for encoding MPEG (Moving Picture Experts Group) video, MPEG audio or the like, and multiplexed according to an MPEG 2 system is called a Clip AV stream (or AV stream). The Clip AV stream is recorded on a BD as a file by a file system defined with “Blu-ray Disc Read-Only Format part 2”, which is one of BD standards. The file of the Clip AV stream is called a Clip AV stream file (or AV stream file).

The Clip AV stream file is a management unit on the file system, and information and so on necessary for playing back the Clip AV stream file (of a Clip AV stream) is recorded on a BD as database. The database is prescribed by “Blu-ray Disc Read-Only Format part 3”, which is one of the BD standards.

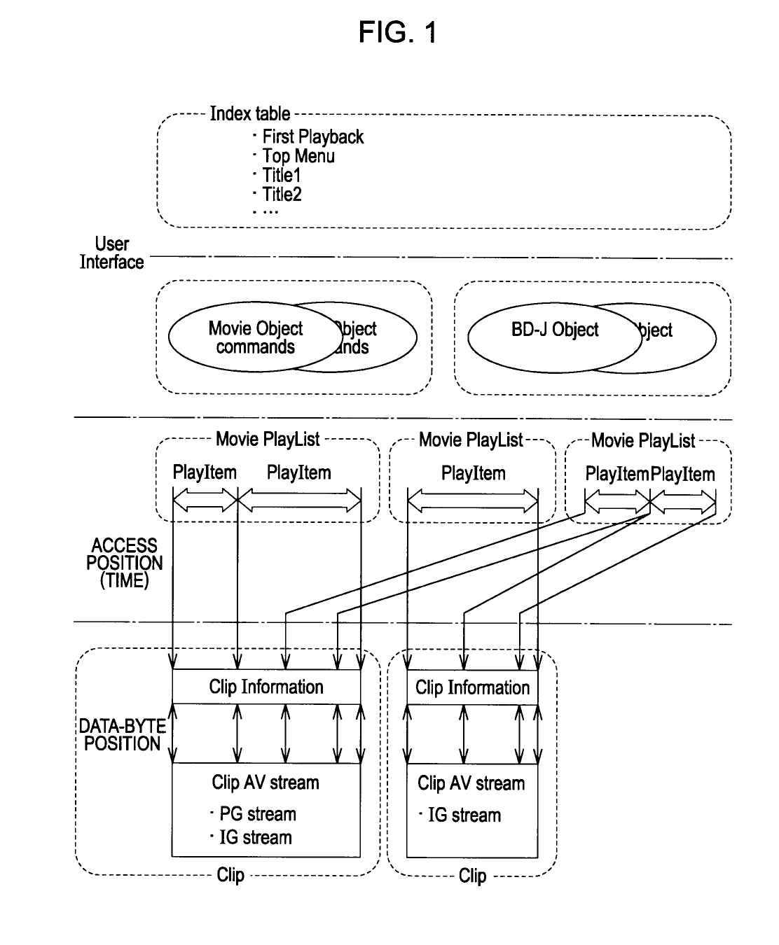

FIG. 1 is a diagram explaining the outline of a BDMV format.

The BDMV format is formed with 4-tier layers.

The lowest layer is a layer including a Clip AV stream, and hereinbelow, will be appropriately referred to as a Clip layer.

The layer one tier above the Clip layer is a layer including a PlayList (Movie PlayList) for designating a playback place for the Clip AV stream, and hereinbelow, will be referred to as a PlayList layer.

The layer one tier above the PlayList layer is a layer including a Movie Object and so on formed of commands for designating a playback order and so on for the PlayList, and hereinbelow, will be referred to as an Object layer.

The layer one tier above the Object layer (the highest layer) is a layer including Index table managing titles and the like accommodated in a BD, and hereinbelow, will be referred to as an Index layer.

The Clip layer, PlayList layer, Object layer, and Index layer will be further described.

The Clip layer includes Clip AV streams, Clip Information, and the like.

The Clip AV stream is a stream formed by making video data or audio data as contents data into a TS (MPEG2 TS (Transport Stream)) form.

The Clip Information is information on the Clip AV stream and recorded on a BD as a file.

Furthermore, the Clip AV stream includes graphic streams such as subtitles, menus or the like if necessary.

A stream of (graphics of) subtitles is called a presentation graphic (PG) stream, and a stream of (graphics of) menus is called an interactive graphics (IG) stream.

In addition, a set of a Clip AV stream file and a file of corresponding Clip information (Clip information on a Clip AV stream of the Clip AV stream file) (Clip information file) is called a Clip.

A Clip is one object formed of a Clip AV stream and Clip information.

A plurality of positions including a first and a final positions (times) when content corresponding to a Clip AV stream forming a Clip is developed on a time axis can be set as access points. An access point is mainly designated by PlayList of an upper layer with a time stamp.

Clip information forming a Clip includes an address of a position of a Clip AV stream (logical address) indicated by an access point that PlayList designates with the time stamp.

The PlayList layer includes PlayList (Movie PlayList).

The PlayList is formed of PlayItem that includes an AV stream file for playback, and a playback starting point (IN point) and a playback ending point (OUT point) for designating a place to playback of the AV stream file.

Therefore, the PlayList is formed of a group of PlayItem.

Here, the playback of the PlayItem refers to the playback in a Clip AV stream zone specified by an IN point and OUT point included in the PlayItem.

The Object layer includes Movie Object or BD-J Object (Blu-ray (registered trademark) Disc Java (registered trademark) Object).

The Movie Object includes terminal information linking a HDMV (High Definition Movie) navigation command program (navi command) and the Movie Object.

The navi command is a command for controlling the playback of PlayList. The terminal information includes information for permitting interactive operation by a user toward a BD player for playing back a BD. In the BD player, user operation such as retrieving a menu or a title search is controlled based on the terminal information.

The BD-J Object is a Java (registered trademark) program, and advanced (sophisticated) interactive functions can be provided to users more with the BD-J Object (BD-J Title or BD-J Application) than the navi command.

The Index layer includes an Index table.

The Index table is a table of the top level that defines titles of a BD-ROM disc.

Entries (fields) of the Index table corresponds to titles and from each of the entries, Object (Movie Object and BD-J Object) of titles (HDMV title and BD-J title) corresponding to the entries is attached with a link.

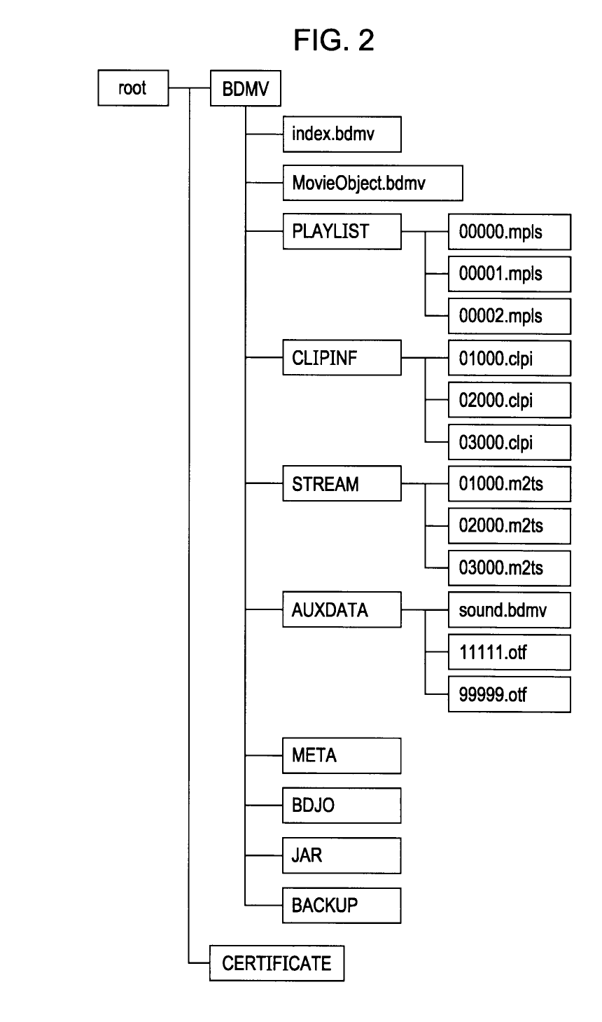

FIG. 2 is a diagram explaining a management structure of files on a BD prescribed by the “Blu-ray Disc Read-Only Format part3”.

In a BD, files are managed in a directory structure by stages.

Here, in FIG. 2, files under a directory (including the directory) refers to files located right below the directory, and files included in a directory refers to files located right below the directory and files located under a so-called sub directory of the directory.

A directory in an uppermost stage of a BD is a root directory, and there exists a directory “BDMV’ and a directory “CERTIFICATE” right below the root directory.

The directory “CERTIFICATE” accommodates information on copyright (a file).

The directory “BDMV” accommodates a file in the BDMV format described in FIG. 1.

Right below the directory “BDMV”, two files of “index.bdmv” and “MovieObject.bdmv” are accommodated. In addition, right below the directory “BDMV”, files other than a file “index.bdmv” and “MovieObject.bdmv” (excluding directories) are not able to be accommodated.

The file “index.bdmv” includes the Index table described in FIG. 1 as information about a menu for playing back a BD.

A BD player plays back (a screen of) a start-up menu including items of contents, for example, playing back all contents on a BD, playing back only a specific chapter, playing back repeatedly, and displaying a predetermined menu based on the file “index.bdmv”.

In addition, in the file “index.bdmv”, Movie Object executed when each of the items is selected can be set, and when a user selects one item from the start-up menu screen, the BD player executes a command of Movie Object set in the file “index.bdmv”.

The file “MovieObject.bdmv” is a file including information of the Movie Object. The Movie Object includes a command for controlling the playback of PlayList recorded on a BD, and, for example, a BD player plays back content (title) recorded on a BD by selecting one out of Movie Objects recorded in the BD and executing it.

Right below the directory “BDMV”, directories of “PLAYLIST”, “CLIPINF”, “STREAM”, “AUXDATA”, “META”, “BDJO”, “JAR” and “BACKUP” are provided.

In the directory “PLAYLIST”, the database of PlayList is accommodated. In other words, in the directory “PLAYLIST”, a file “xxxxx.mpls” of the PlayList is accommodated. For a file name of the file “xxxxx.mpls” of the PlayList, a file name formed with a 5-digit number “xxxxx” and an extension “mpls” is used.

The directory “CLIPINF”, the database of Clip is accommodated. In other words, in the directory “CLIPINF”, a Clip information file “xxxxx.clpi” for each Clip AV stream file is accommodated. For a file name of the Clip information file “xxxxx.clpi”, a file name formed with a 5-digit number “xxxxx” and an extension “clpi” is used.

In the directory “STREAM”, a Clip AV stream file “xxxxxx.m2ts” is accommodated. In the Clip AV stream file “xxxxxx.m2ts”, TS is accommodated. For a file name of the Clip AV stream file “xxxxxx.m2ts”, a file name formed with a 5-digit number “xxxxx” and an extension “m2ts” is used.

Furthermore, for file names of a Clip information file “xxxxx.clpi” forming a certain Clip and a Clip AV stream file “xxxxxx.m2ts”, a file name that coincides with each other except for the extension is used. Accordingly, a Clip information file “xxxxx.clpi” forming a certain Clip and a Clip AV stream file “xxxxxx.m2ts” can be easily specified.

In the directory “AUXDATA”, a sound file, a font file, a font index file, a bitmap file, and the like used for the display of menus or the like are accommodated.

In FIG. 2, the directory “AUXDATA” accommodates a file “sound.bdmv” or a file with an extension of “otf”.

In the file “sound.bdmv”, predetermined sound data (audio data) is accommodated. For a file name of the file “sound.bdmv”, “sound.bdmv” is fixed for the use.

In a file with the extension of “otf”, font data used in displaying subtitles, BD-J Object (Application) or the like is accommodated. A 5-digit number is used for a portion except for the extension in the file name with the extension of “otf”.

In the directory “META”, a file of metadata is accommodated. The directory “BDJO” and directory “JAR” accommodates a file of BD-J. Object. The directory “BACKUP” accommodates backup of a file recorded on the BD.

Composition Example of Playback Device applied with the Present Invention

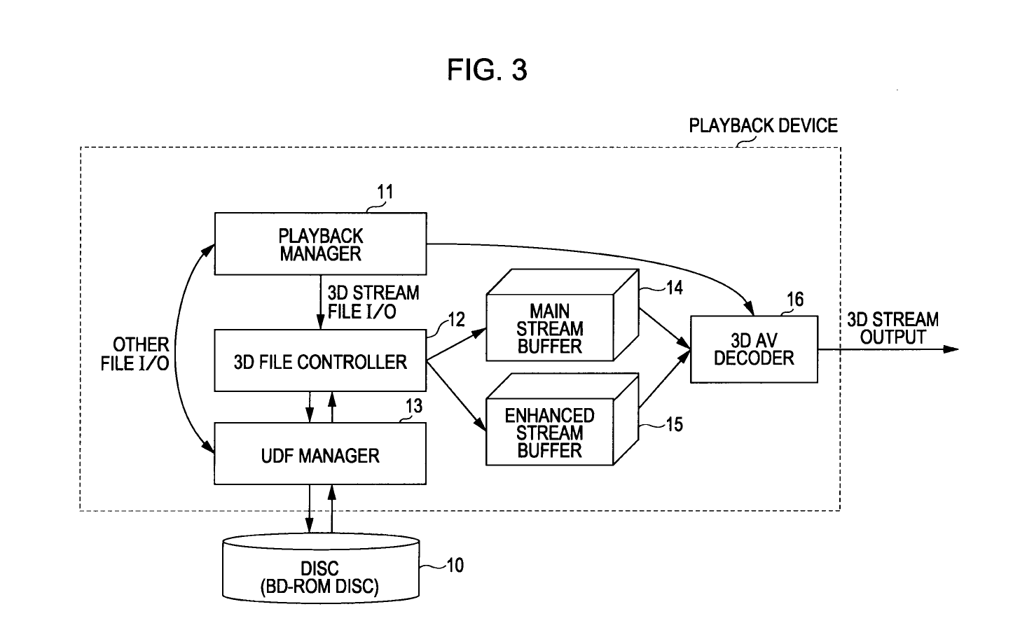

FIG. 3 is a block diagram illustrating an example of a composition of an embodiment of a playback device to which the present invention is applied.

The playback device of FIG. 3 is, for example, a BD player that can perform playback of 3D image content in addition to 2D image content, and performs playback of a disc 10 loaded thereon.

In other words, the disc 10 is, for example, a BD, and recorded with files in the management structure shown in FIG. 2 as the current BD on which 2D image content is recorded. Moreover, the disc 10 is recorded with files for playing back 3D image content as to be described later.

Therefore, the disc 10 can be played back in a legacy player and can be used in playing back 3D image content and in a BD player as the playback device in FIG. 3 (hereinafter, also referred to as a 3D player).

Here, a legacy player is a BD player that is used only for a current BD on which 2D image content is recorded and not able to play back 3D image content.

In the legacy player, 2D image content can be played back from the disc 10, but 3D image content is not able to be played back.

On the other hand, in the playback device of FIG. 3 as a 3D player, 2D image content can be played back from the disc 10, and 3D image content can be played back.

In FIG. 3, the disc 10 is attachable in the playback device.

In addition, the playback device performs playback of the disc 10 loaded thereon.

In other words, the playback device includes a playback manager (BD playback manager) 11, a 3D file controller 12, a UDF manager 13, a main stream buffer 14, an enhanced stream buffer 15 and a 3D AV decoder 16.

The playback manager 11 supplies a request of a file to be played back (to be read out) to the 3D file controller 12, for example, according to operation by a user or the like.

In other words, the playback manager 11 requests a file necessary for the playback of 3D image content to the 3D file controller 12 when the playback of the 3D image content is instructed, for example, according to the operation of a user.

Furthermore, the playback manager 11 supplies a request of a file to the UDF manager 13 (directly) for the request of a file other than a file necessary for the playback of the 3D image content.

The 3D file controller 12 supplies of a request of a file necessary for the playback of the 3D image content and other information to the UDF manager 13 according to the request of the file from the playback manager 11.

In addition, when the file and information necessary for the playback of the 3D image content requested to the UDF manager 13 are supplied from the UDF manager 13, the 3D file controller 12 divides a stream accommodated in the file from the UDF manager 13 into (Extents of) a main stream and an enhanced stream to be described later by using the information from the UDF manager 13 in the same manner.

In addition, the 3D file controller 12 supplies the main stream to the main stream buffer 14 and the enhanced stream to the enhanced stream buffer 15.

The UDF manager 13 is a UDF driver that is a file system adopted in the disc 10 as a BD, reads from the disc 10 files or information requested from the 3D file controller 12, and supplies the files or information to the 3D file controller 12.

Furthermore, when there is a request of a file from the playback manager 11, the UDF manager 13 reads the file from the disc 10, but a processing of the file is the same as the processing performed by the legacy player, and therefore, description thereof will not be repeated.

The main stream buffer 14 temporarily stores the main stream from the 3D file controller 12.

The enhanced stream buffer 15 temporarily stores the enhanced stream from the 3D file controller 12.

The 3D AV decoder 16 reads the main stream stored in the main stream buffer 14 therefrom, if necessary, and reads the enhanced stream stored in the enhanced stream buffer 15 therefrom according to the request.

In addition, the 3D AV decoder 16 decodes the main stream read from the main stream buffer 14 and the enhanced stream read from the enhanced stream buffer 15, and furthermore, obtains image data (3D stream) necessary for display of 3D images by subjecting to a necessary process and outputs the image to a display device not shown in the drawing. In the display device not shown in the drawing, the 3D images are displayed corresponding to the image data from the 3D AV decoder 16.

### Description of Disc 10

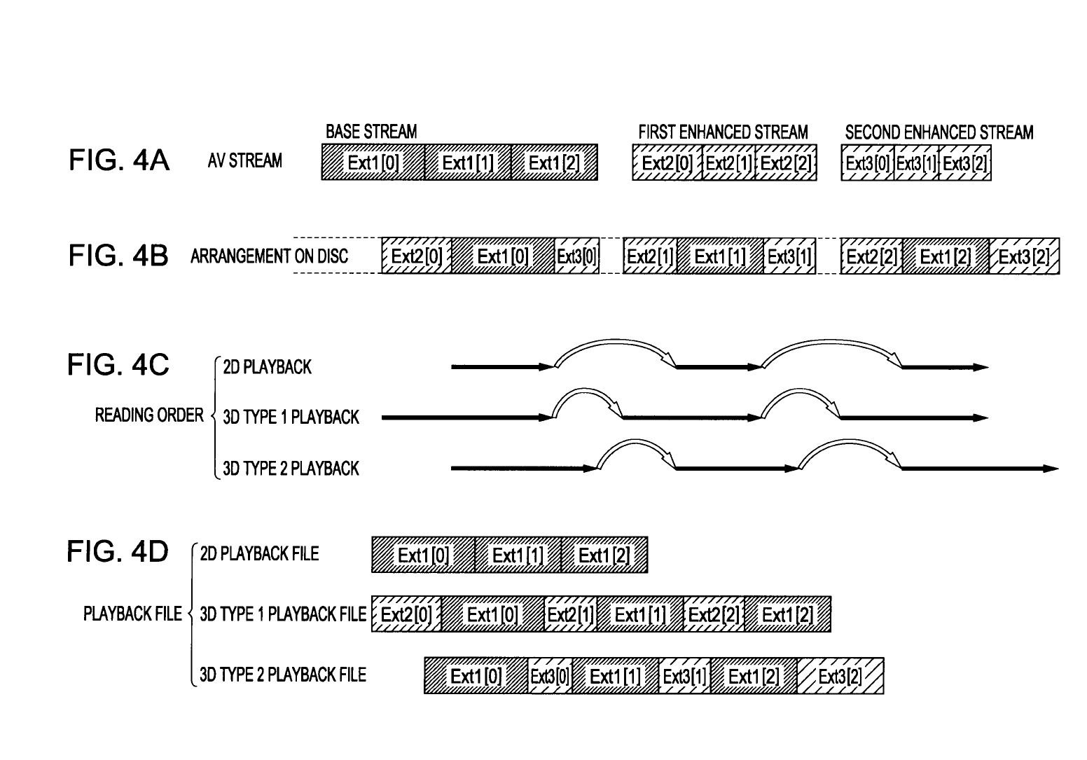

FIGS. 4A to 4D are diagrams explaining streams and files relating to 3D images recorded on the disc 10.

The disc 10 is a Blu-Ray (registered trademark) disc (hereinafter, also referred to as a “BD”), for example, BD (Blu-Ray (registered trademark) Disc)-ROM (Read Only Memory), or the like, and the disc 10 is recorded with streams necessary for displaying stereo images having two viewpoints as stereoscopic images that can be stereoscopically seen (so-called three-dimensional (3D) images).

Furthermore, the playback of 3D images described in the present specification can be applied to the playback of stereoscopic images that can be stereoscopically seen with three or more viewpoints.

Until now, various modes have been suggested as a mode for displaying 3D images (stereo images). Here, as modes for displaying 3D images, for example, a Type 1 display mode (a first display mode) and a Type 2 display mode (a second display mode) below are employed.

The Type 1 display mode is composed of image data obtained by observing the data of 3D images with a left eye (hereinafter, referred to as images for the left eye) and image data obtained by observing the data of 3D images with a right eye (hereinafter, referred to as images for the right eye), and displays 3D images by displaying the images for the left eye and the images for the right eye.

In the Type 2 display mode, data of 3D images are composed of source image data which is the source for generation 3D images, and disparity data for generating images for the left eye and images for the right eye from the source images by causing disparity in the source images. In addition, the display of 3D images can be performed by displaying the images for the left eye and the images for the right eyes generated from the source images.

The disc 10 is recorded with a stream (audio visual (AV) stream) so as to be able to display 3D images in any display mode of the Type 1 and Type 2.

In other words, FIG. 4A shows an AV stream recorded on the disc 10.

In the AV stream recorded on the disc 10, there are three AV streams of a base stream, a first enhanced stream, and a second enhanced stream.

The base stream is a stream obtained by encoding one side of data between images for the left eye and images for the right eye (or images having a center point between the left eye and the right eye as a viewpoint), and is used for displaying 3D images in any display mode between the Type 1 and Type 2.

The first enhanced stream is a stream obtained by encoding the other side of data between the images for the left eye and the images for the right eye, and is used for displaying 3D images in the Type 1 display mode.

The second enhanced stream is, for example, a stream of disparity data for generating the images for the left eye and the images for the right eye by causing the disparity in images that have become the base stream (or a stream obtained by encoding the disparity data), and is used for displaying 3D images in the Type 2 display mode.

Furthermore, for data encoding modes, for example, H.264 advanced video coding (AVC)/multi-view video coding (MVC) or the like can be employed.

Here, for the H.264 AVC/MVC, an image stream called Base view and an image stream called Dependent view are defined.

In the Base view, predictive encoding having other streams as a reference image is not allowed, but for the Dependent view, predictive encoding having Base view as a reference image is allowed. Therefore, when encoding is performed for the Base view and the Dependent view having images for the left eye as the Base view and image for the right eye as Dependent view for the images for the left eye and the image for the right eye, the data amount of Dependent view encoding stream obtained as the result is quite smaller than the data amount of Base view encoding stream.

In FIG. 4A, the base stream is, for example, a stream obtained by encoding the Base view with the H.264 AVC/MVC.

In addition, the first enhanced stream is, for example, a stream obtained by encoding the Dependent view with the H.264 AVC/MVC.

Here, the second enhanced stream is a disparity data stream as described above, and the data amount is small as the first enhanced stream, which is Dependent view encoding stream, is.

The disc 10 is recorded with the Base stream, the first enhanced stream, and the second enhanced stream described above as AV streams.

In addition, when the playback of 3D images is performed by displaying the 3D images in the Type 1 display mode, the Base stream and the first enhanced stream are read from the disc 10.

Furthermore, in the 3D file controller 12 (FIG. 3) in the Type 1 display mode, the Base stream is supplied to the main stream buffer 14 and stored as a main stream.

In addition, in the 3D file controller 12 (FIG. 3), the first enhanced stream is supplied to the enhanced stream buffer 15 and stored as an enhanced stream.

In addition, 3D images are displayed by having images obtained from the Base stream stored in the main stream buffer 14 as the main stream as one of the images for the left eye and images for the right eye, and images obtained from the first enhanced stream stored in the enhanced stream buffer 15 as the enhanced stream as the other one of the images for the left eye and images for the right eye.

On the other hand, when the playback of 3D images is performed by displaying the 3D images in the Type 2 display mode, the Base stream and the second enhanced stream are read from the disc 10.

Furthermore, in the 3D file controller 12 (FIG. 3) in the Type 2 display mode, the Base stream is supplied to the main stream buffer 14 and stored as a main stream.

In addition, in the 3D file controller 12 (FIG. 3), the second enhanced stream is supplied to the enhanced stream buffer 15 and stored as an enhanced stream.

In addition, 3D images are displayed in a way that disparity obtained from the second enhanced stream stored in the enhanced stream buffer 15 as the enhanced stream is caused on the images obtained from the Base stream stored in the main stream buffer 14 as the main stream, then images for the left eye and images for the right eye are generated, and then the images for the left eye and the images for the right eye are displayed.

Here, the playback of the 3D images (3D playback) performed by displaying 3D images in the Type 1 display mode is referred to as 3D type 1 playback, hereinbelow. In the same manner, the 3D playback performed by displaying 3D images in the Type 2 display mode is referred to as 3D type 2 playback, hereinbelow.

Moreover, in addition to the 3D playback as above performed with the disc 10, only the Base stream is read from the disc 10, and the Base stream makes it possible to perform 2D playback that displays two-dimensional images (2D images) (for example, images for the left eye here).

For example, when a playback device used in the playback of the disc 10 is a legacy player not suitable for 3D playback, 2D playback is performed. In other words, with the legacy player, only the Base stream is read from the disc 10, and thereby the Base stream makes it possible to display 2D images. Accordingly, the disc 10 can be used in playback not only with a legacy player but also with 3D player suitable for 3D playback.

Moreover, in the 3D player, it is possible to decide in advance whether the 3D type 1 playback is to be performed or 3D type 2 playback is to be performed, and possible to decide according to user's operation and the like.

In the 3D playback, the Base stream and the first enhanced stream are read or the Base stream and the second enhanced stream are read from the disc 10 as described above.

For example, if two streams of the Base stream and the first enhanced stream are read from the disc 10, a reading rate of streams from the disc 10 is restricted by seek or the like. Therefore, when the Base stream and the first enhanced stream are not appropriately recorded on the disc 10, the reading of the Base stream and the first enhanced stream fails to be in time for the playback (display) of 3D images. The same is applied to the case when two streams of the Base stream and the second enhanced stream are read.

Therefore, the Base stream, the first enhanced stream, and the second enhanced stream recorded on the disc 10 are split into segments called Extent which is a unit of being consecutively read, as shown in FIG. 4A.

Here, in FIG. 4A, the Base stream is split into Extents Ext1[0], Ext1[1], and Ext1[2] in order from the head. In addition, the first enhanced stream is split into Extents Ext2[0], Ext2[1], and Ext2[2] in order from the head. Furthermore, the second enhanced stream is split into Extents Ext3[0], Ext3[1], and Ext3[2] in order from the head.

Each Extent of the Base stream, the first enhanced stream, and the second enhanced stream is arranged so as to form an interleaving arrangement (interleaved). In addition, interleaving data obtained from the result are recorded on the disc 10 so as to be physically consecutive (as it possibly can be).

Here, in three kinds of streams of the Base stream, the first enhanced stream, and the second enhanced stream, the interleaving arrangement represents a periodic arrangement in which Extents of a same kind of streams are not adjacent to each other.

FIG. 4B shows interleaving data recorded on the disc 10.

In the interleaving data of FIG. 4B, each Extent of the Base stream, the first enhanced stream, and the second enhanced stream is arranged in the order of Extents Ext2[0], Ext1[0], and Ext3[0], Extents Ext2[1], Ext1[1], and Ext3[1], and Extents Ext2[2], Ext1[2], and Ext3[2].

Here, the split of the Base stream, the first enhanced stream, and the second enhanced stream into each Extent is performed so that, for example, data necessary for the same playback time as the 3D playback become one Extent.

In other words, for example, to simplify the description, if a time obtained by dividing playback time of all image content corresponding to the Base stream into three portions is expressed by 0 as a playback starting time, the t1 and t2 in a time series order, the data of the Base stream of the portion necessary for playback time from the playback starting time to the time t1 are split into the Extent Ext1[0].

Furthermore, the data of the Base stream of the portion necessary for playback time from the time t1 to the time t2 are split into the Extent Ext1[1], and the data of the Base stream of the portion necessary for playback time from the time t2 to the playback ending time are split into the Extent Ext1[2].

For the first enhanced stream, the data of the first enhanced stream of the portion necessary for playback time from the playback starting time to the time t1 are split into the Extent Ext2[0] in the same manner.

Furthermore, the data of the first enhanced stream of the portion necessary for playback time from the time t1 to the time t2 are split into the Extent Ext2[1], and the data of the first enhanced stream of the portion necessary for playback time from the time t2 to the playback ending time are split into the Extent Ext2[2].

The second enhanced stream is also split into Extents Ext3[0], Ext3[1], and Ext3[2] in the same manner.

Here, the Extent of the Base stream is appropriately described as Extent Ext1 hereinbelow. In the same manner, the Extent of the first enhanced stream is appropriately described as Extent Ext2, and the Extent of the second enhanced stream is appropriately described as Extent Ext3 hereinbelow.

In interleaving of Extents, the Base stream, the first enhanced stream, and the second enhanced stream are arranged in the interleaving arrangement as described below.

In other words, the Base stream is a so-called essential stream (essence stream) necessary for any kind of playback including 2D playback, the 3D type 1 playback, and the 3D type 2 playback.

On the other hand, the first enhanced stream is a so-called selective stream (selection stream) not necessary for the 2D playback and the 3D type 2 playback, but necessary for the 3D type 1 playback. In the same manner, the second enhanced stream is a selective stream not necessary for the 2D playback and the 3D type 1 playback, but necessary for the 3D type 2 playback.

In the interleaving of the Extents, the Extents are arranged so that the Extents of the selective streams (the first enhanced stream and the second enhanced stream here) are adjacent to the Extents of the essential stream (the Base stream here).

In other words, the Extent Ext2 of the first enhanced stream and the Extent Ext3 of the second enhanced stream as selective streams are arranged so as to be adjacent to the Extent Ext1 of the Base stream as an essential stream.

In FIG. 4B, the Extent Ext2 of the first enhanced stream is arranged to be adjacent to the left side (front side) of the Extent Ext1 of the Base stream in the drawing (in a position side where reading is performed first). In addition, the Extent Ext3 of the second enhanced stream is arranged to be adjacent to the right side (rear side) of the Extent Ext1 of the Base stream in the drawing (in a position side where reading is performed later).

In other words, three kinds of Extents including the Extent Ext1 of the Base stream, Extent Ext2 of the first enhanced stream, and the Extent Ext3 of the second enhanced stream are arranged to be consecutive in the order of Extents Ext2, Ext1, and Ext3 by forming the three kinds of Extents to be one set of Extents (hereinafter, referred to as an Extent set).

Furthermore, in FIG. 4B, the Extent set is recorded on the disc 10 so as to have a small gap formed between adjacent Extent sets, but an Extent set can be recorded on the disc 10 so as not to have a gap formed between adjacent Extent sets.

In addition, in FIG. 4B, the Extent Ext1 of the Base stream, the Extent Ext2 of the first enhanced stream, and the Extent Ext3 of the second enhanced stream forming one set of Extent set are Extents played back in the same playback time.

In other words, Extent Ext1[k] in k+1-th from the head of the Base stream, Extent Ext2[k] in k+1-th from the head of the first enhanced stream, and Extent Ext3[k] in k+1-th from the head of the second enhanced stream are Extents played back at the same playback time, but in FIG. 4B, the Extent Ext1[k], Ext2[k], and Ext3[k] form one set of an Extent set.

As described above, by setting Extent in the interleaving arrangement and recording on the disc 10, it is possible to promptly read (Extents of) two streams that are the Base stream and the first enhanced stream or the Base stream and the second enhanced stream from the disc 10 during the 3D playback.

In other words, FIG. 4C is a drawing explaining reading of Extents from the disc 10.

When 2D playback is performed, the Extent Ext1 of only the Base stream out of the Base stream, the first enhanced stream, and the second enhanced stream is read from the disc 10.

When 3D type 1 playback is performed, the Extent Ext1 of the Base stream and the Extent Ext2 of the first enhanced stream out of the Base stream, the first enhanced stream, and the second enhanced stream are read from the disc 10.

As described above, in an Extent set, since the Extent Ext1 of the Base stream and the Extent Ext2 of the first enhanced stream are recorded adjacently (consecutively), the Extents Ext1 and Ext2 in the Extent set are read without seek, in other words, can be read promptly. Therefore, Extents are read so as to be in time for the playback of 3D images, and 3D image contents can be properly played back.

When 3D type 2 playback is performed, the Extent Ext1 of the Base stream and the Extent Ext3 of the second enhanced stream out of the Base stream, the first enhanced stream, and the second enhanced stream are read from the disc 10.

As described above, in an Extent set, since the Extent Ext1 of the Base stream and the Extent Ext3 of the second enhanced stream are recorded adjacently, the Extents Ext1 and Ext3 in the Extent set are promptly read without seek as the Extents Ext1 and Ext2 are. Therefore, Extents are read so as to be in time for the playback of 3D images, and 3D image contents can be properly played back.

FIG. 4D shows files recorded on the disc 10 when interleaving data obtained by interleaving Extents are recorded on the disc 10 as described above.

The disc 10 is recorded with a 2D playback file, a 3D type 1 playback file, and a 3D type 2 playback file.

The 2D playback file is a file accommodating the Base stream read during the 2D playback (Base file). The 2D playback file accommodates the Extent Ext1 of the Base stream necessary for the 2D playback in the order of Ext1[0], Ext1[1], and Ext1[2] which is the playback order.

The 3D type 1 playback file is a file accommodating a virtual Extent to be described later read during the 3D type 1 playback (virtual Extent file). The 3D type 1 playback file accommodates the Extent Ext1 of the Base stream and the Extent Ext2 of the first enhanced stream necessary for the 3D type 1 playback in the order of a set of Ext2[0] and Ext1[0], a set of Ext2[1] and Ext1[1], and a set of Ext2[2] and Ext1[2] which is the playback order.

The 3D type 2 playback file is a virtual Extent file accommodating a virtual Extent to be described later read during the 3D type 2 playback. The 3D type 2 playback file accommodates the Extent Ext1 of the Base stream and the Extent Ext3 of the second enhanced stream necessary for the 3D type 2 playback in the order of a set of Ext1[0] and Ext3[0], a set of Ext1[1] and Ext3[1], and a set of Ext1[2] and Ext3[2] which is the playback order.

Therefore, the Extent Ext1 of the Base stream is a constituent element of all three files including the 2D playback file, the 3D type 1 playback file, and the 3D type 2 playback file and is shared by the three files.

On the other hand, the Extent Ext2 of the first enhanced stream is a constituent element of the 3D type 1 playback file, but is not a constituent element of the 2D playback file and the 3D type 2 playback file.

In the same manner, the Extent Ext3 of the second enhanced stream is a constituent element of the 3D type 2 playback file, but is not a constituent element of the 2D playback file and the 3D type 1 playback file.

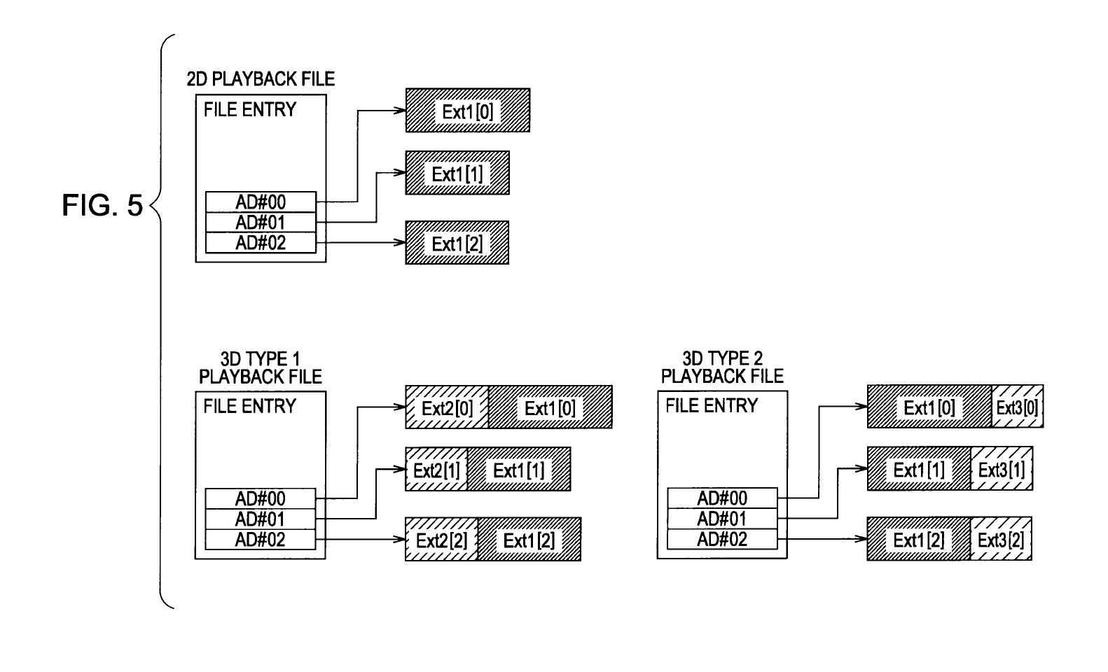

FIG. 5 is a diagram explaining the management of files on the disc 10 by a file system (driver).

As described in FIGS. 4A to 4D, the data (Extents) recorded on the disc 10 are shared in a plurality of files. For that reason, for a file system that manages files on the disc 10 it is necessary to adopt a file system that can share data recorded on the disc 10 with a plurality of files. As such as file system, for example, there is a universal disk format (UDF) or the like based on the standard of European Computer Manufacturer Association (ECMA) 167.

In the file system, a file entry is managed (generated, stored, or the like) which is one piece of file information about files, which is position information or the like indicating a position of data (Extent here) as a file name of a file on the disc 10 or a constituent element forming a file on the disc 10.

FIG. 5 shows file entries including the 2D playback file, the 3D type 1 playback file, and the 3D type 2 playback file.

In the file entry of the 2D playback file, AD (Allocation Descriptor) #00, AD#01, and AD#02 are registered each of which is position information of Extents Ext1[0], Ext1[1], and Ext1[2] which are constituent elements of the 2D playback file.

Here, the position information of the Extent includes, for example, a head address (Extent Position) (for example, a logical sector number or the like) of a position on the disc 10 on which the Extent is recorded and the size of the Extent (Extent Length).

In the file entry of the 3D type 1 playback file, position information of a virtual Extent is registered which is formed in a way that a set of the Extent Ext1 of the Base stream and the Extent Ext2 of the first enhanced stream that are constituent elements of the 3D type 1 playback file and (physically) consecutively recorded on the disc 10 is formed as one virtual Extent (hereinafter, referred to as a virtual Extent).

In other words, the file entry of the 3D type 1 playback file is registered with position information AD#00 of a virtual Extent which is a set of the Extents Ext2[0] and Ext1[0], position information AD#01 of a virtual Extent which is a set of the Extents Ext2[1] and Ext1[1], and position information AD#02 of a virtual Extent which is a set of the Extents Ext2[2] and Ext1[2].

In the file entry of the 3D type 2 playback file, position information of a virtual Extent is registered which is formed in a way that a set of the Extent Ext1 of the Base stream and the Extent Ext3 of the second enhanced stream that are constituent elements of the 3D type 2 playback file and consecutively recorded on the disc 10 is formed as one virtual Extent.

In other words, the file entry of the 3D type 2 playback file is registered with position information AD#00 of a virtual Extent which is a set of the Extents Ext1[0] and Ext3[0], position information AD#01 of a virtual Extent which is a set of the Extents Extent Ext1[1] and Ext3[1], and position information AD#02 of a virtual Extent which is a set of the Extents Ext1[2] and Ext3[2].

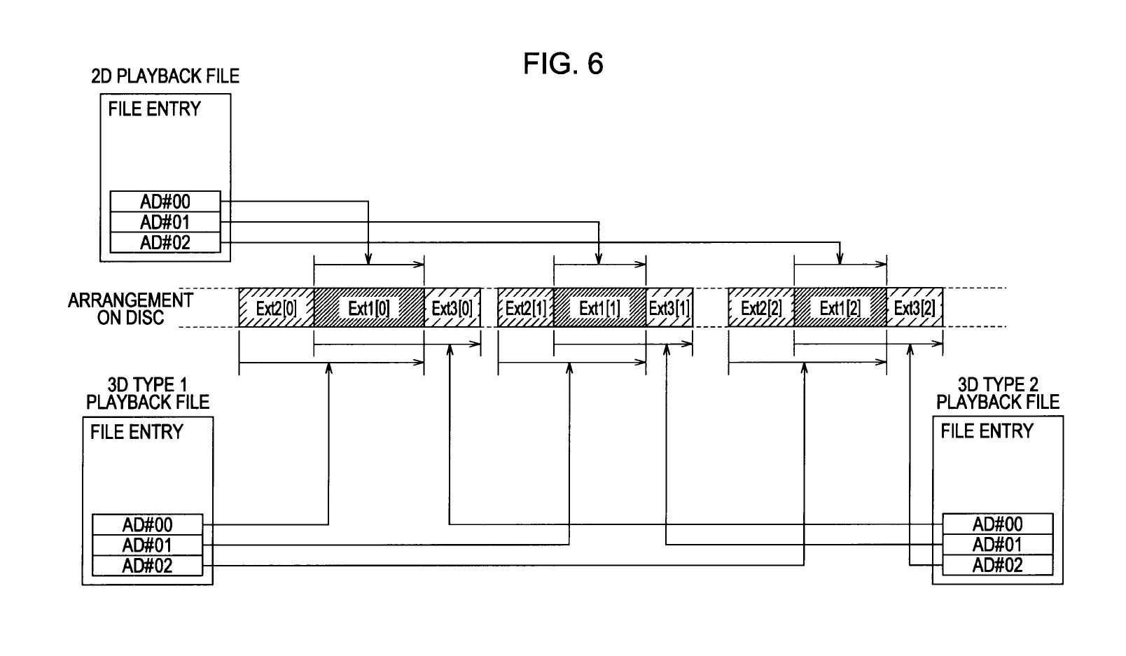

FIG. 6 is a diagram explaining a reading process in which the file system reads Extents (virtual Extents) with reference to the file entries and supplies the Extents to outside.

For example, if an application performing playback such as the playback manager 11, the 3D file controller 12, or the like shown in FIG. 3 (hereinafter, referred to as a playback application) requests reading of a 2D playback file to the file system (the UDF manager 13 of FIG. 3), the file system reads the Extents Ext1[0], Ext1[1], and Ext1[2] from the disc 10 with reference to the file entry of the 2D playback file and provides them.

Since the Extents Ext1[0], Ext1[1], and Ext1[2] read from the disc 10 are Extents of the Base stream, the playback application can perform 2D playback by using the Extents Ext1[0], Ext1[1], and Ext1[2] of the Base stream.

In addition, if the playback application requests reading of a 3D type 1 playback file to the file system, the file system reads a virtual Extent which is a set of the Extents Ext2[0] and Ext1[0], a virtual Extent which is a set of the Extents Ext2[1] and Ext1[1], and a virtual Extent which is a set of the Extents Ext2[2] and Ext1[2] from the disc 10 with reference to file entry of the 3D type 1 playback file and provides them.

In the virtual Extent which is a set of the Extents Ext2[0] and Ext1[0], the virtual Extent which is a set of the Extents Ext2[1] and Ext1[1], and the virtual Extent which is a set of the Extents Ext2[2] and Ext1[2] read from the disc 10, the Extents Ext1[0], Ext1[1], and Ext1[2] are Extents of the Base stream, and the remaining Extents Ext2[0], Ext2[1], and Ext2[2] are Extents of the first enhanced stream.

Therefore, the playback application can perform the 3D type 1 playback by using the Extents Ext1[0], Ext1[1], and Ext1[2] of the Base stream and the Extents Ext2[0], Ext2[1], and Ext2[2] of the first enhanced stream read from the disc 10.

Furthermore, if the playback application requests reading of a 3D type 2 playback file to the file system, the file system reads a virtual Extent which is a set of the Extents Ext1[0] and Ext3[0], a virtual Extent which is a set of the Extents Ext1[1] and Ext3[1], and a virtual Extent which is a set of the Extents Ext1[2] and Ext3[2] from the disc 10 with reference to file entry of the 3D type 2 playback file and provides them.

In the virtual Extent which is a set of the Extents Ext1[0] and Ext3[0], the virtual Extent which is a set of the Extents Ext1[1] and Ext3[1], and the virtual Extent which is a set of the Extents Ext1[2] and Ext3[2] read from the disc 10, the Extents Ext1[0], Ext1[1], and Ext1[2] are Extents of the Base stream, and the remaining Extents Ext3[0], Ext3[1], and Ext3[2] are Extents of the second enhanced stream.

Therefore, the playback application can perform the 3D type 2 playback by using the Extents Ext1[0], Ext1[1], and Ext1[2] of the Base stream, and the Extents Ext3[0], Ext3[1], and Ext3[2] of the second enhanced stream read from the disc 10.

As described above, if the playback application requests reading of the 3D type 1 playback file to the file system, the file system reads a virtual Extent which is a set of the Extents Ext2[0] and Ext1[0], a virtual Extent which is a set of the Extents Ext2[1] and Ext1[1], and a virtual Extent which is a set of the Extents Ext2[2] and Ext1[2] from the disc 10 with reference to the file entry of the 3D type 1 playback file.

On the other hand, it is necessary to decode each of the Base stream and the first enhanced stream in order to perform the 3D type 1 playback. For that reason, it is necessary to split the virtual Extents read from the disc 10 for the playback into the Extent Ext2 of the first enhanced stream and the Extent Ext1 of the Base stream for performing the 3D type 1 playback.

The same execution as described above is also applied to the 3D type 2 playback, and it is necessary to split the virtual Extents read from the disc 10 into the Extent Ext3 of the second enhanced stream and the Extent Ext1 of the Base stream for performing the 3D type 2 playback.

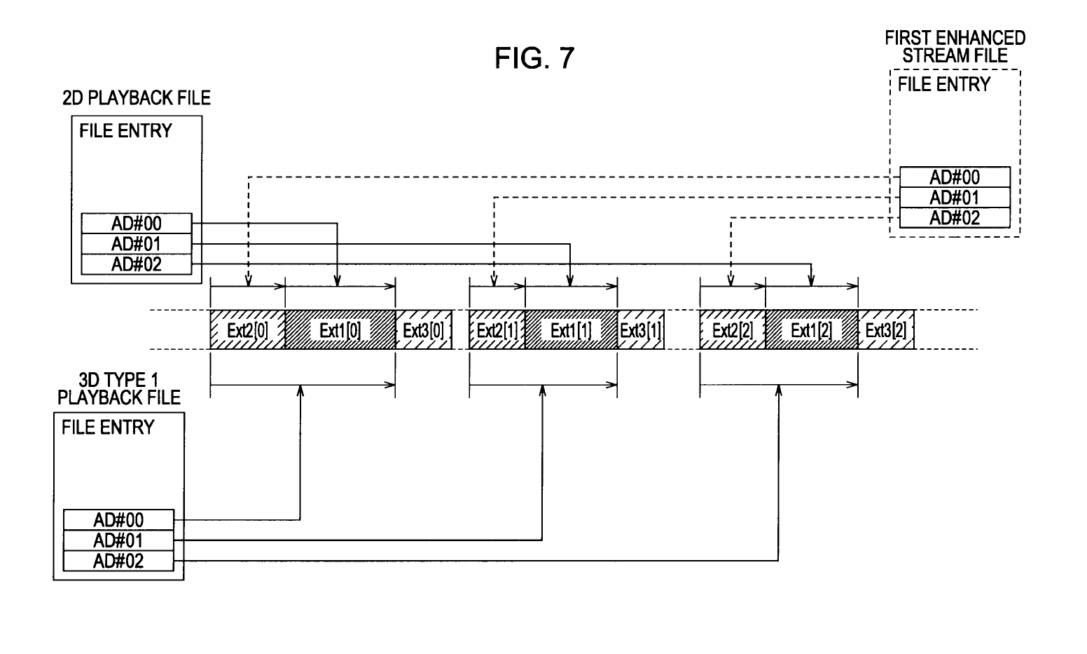

FIG. 7 is a diagram explaining a method of splitting the virtual Extents read from a 3D type 1 playback file into the Extent Ext2 of the first enhanced stream and the Extent Ext1 of the Base stream.

As described above, the file system reads a virtual Extent which is a set of the Extent Ext2 of the first enhanced stream and the Extent Ext1 of the Base stream (a virtual Extent which is a set of Extents Ext2[0] and Ext1[0], a virtual Extent which is a set of Extents Ext2[1] and Ext1[1], and a virtual Extent which is a set of Extents Ext2[2] and Ext1[2]) from the disc 10 with reference to file entry of the 3D type 1 playback file.

The file system manages of the file entry of the 2D playback file, and the file entry is registered with addresses and sizes of Extents as position information AD#00, AD#01, and AD#02 of the Extent Ext1 of the Base stream (Extent Ext1[0], Ext1[1], and Ext1[2]).

Therefore, from the file entry of the 2D playback file, it is possible to recognize the size of the Extent Ext1 of the Base stream. In addition, from the size of the Extent Ext1, it is possible to recognize the boundary between the Extent Ext2 and Ext1 in the virtual Extent which is a set of the Extent Ext2 of the first enhanced stream and the Extent Ext1 of the Base stream.

Based on the above, the virtual Extent which is a set of the Extent Ext2 of the first enhanced stream and the Extent Ext1 of the Base stream (hereinafter, referred to as a virtual Extent of 3D type 1) can be split into the Extent Ext2 of the first enhanced stream and the Extent Ext1 of the Base stream with reference to the file entry of the 2D playback file.

In the same manner, the virtual Extent which is a set of the Extent Ext3 of the second enhanced stream and the Extent Ext1 of the Base stream (hereinafter, referred to as a virtual Extent of 3D type 2) read from the 3D type 2 playback file can be split into the Extent Ext3 of the second enhanced stream and the Extent Ext1 of the Base stream with reference to the file entry of the 2D playback file.

Furthermore, in FIG. 7, the virtual Extent of 3D type 1 read from the 3D type 1 playback file is split into the Extents Ext2 and Ext1 with referent to the file entry of the 2D playback file, but in addition to that, the virtual Extent of 3D type 1 can record a file of the first enhanced stream on the disc 10, for example, and split the file into the Extents Ext2 and Ext1 with reference to file entry of a file of the first enhanced stream.

In other words, in the FIG. 4D described above, three files of the 2D playback file, the 3D type 1 playback file and the 3D type 2 playback file are recorded on the disc 10, and further, a file of the first enhanced stream can be recorded on the disc 10.

Here, the file of the first enhanced stream (first enhanced stream file) is a file accommodating the Extent Ext2 of the first enhanced stream in the order of the Ext2[0], Ext2[1], and Ext2[2] which is a playback order.

Therefore, in the file entry of the first enhanced stream file, as shown by the dotted lines in FIG. 7, the position information AD#00, AD#01, and AD#01 of each of the Extents Ext2[0], Ext2[1], and Ext2[2] which are constituent elements of the first enhanced stream file are registered.

In the same manner as in the case where the file entry of the 2D playback file is referred, it is possible to recognize a boundary between the Extents Ext2 and Ext1 in the virtual Extent of the 3D type 1 (the virtual Extent which is a set of the Extent Ext2 of the first enhanced stream and the Extent Ext1 of the Base stream) by referring to the files entries of the first enhanced stream file.

Therefore, the virtual Extent of the 3D type 1 can be split into the Extent Ext2 of the first enhanced stream and the Extent Ext1 of the Base stream with reference to the file entry of the first enhanced stream file.

In the same manner, it is possible to split the virtual Extent of 3D type 2 read from the 3D type 2 playback file into the Extent Ext1 of the Base stream and the Extent Ext3 of the second enhanced stream with reference to the file entry of the second enhanced stream file, by recording the second enhanced stream file which is a file accommodating the Extent Ext3 of the second enhanced stream in the order of the Ext3[0], Ext3[1], and Ext3[2] that is a playback order on the disc 10.

Furthermore, for example, when the 3D type 1 playback is performed, there is a problem of specifying the position information of the file entry of the 2D playback file used for (referring to) splitting a virtual Extent which is a set of k+1-th virtual Extent read from the 3D type 1 playback file, that is, an Extent Ext2[k] of the first enhanced stream and an Extent Ext1[k] of the Base stream into the Extent Ext2[k] of the first enhanced stream and the Extent Ext1[k] of the Base stream.

Here, the position of the k+1-th virtual Extent of the 3D type 1 playback file is indicated by the k+1-th position information AD#0k of the file entry of the 3D type 1 playback file.

In addition, when the k+1-th virtual Extent is formed of the Extent Ext2[k] of the first enhanced stream and the Extent Ext1[k] of the Base stream played back at the same time, the position of the Extent Ext1[k] of the Base stream forming the k+1-th virtual Extent is indicated by the k+1-th position information AD#0k of the file entry of the 2D playback file.

Therefore, the k+1-th virtual Extent read according to the k+1-th position information AD#0k of the file entry of the 3D type 1 playback file can be split into the Extent Ext2[k] of the first enhanced stream and the Extent Ext1[k] of the Base stream with reference to position information in the same order of the file entry of the 2D playback file, that is, the k+1-th position information AD#0k.

Furthermore, when the file entry of the first enhanced stream file is referred to and the file entry of the 2D playback file is not referred to for splitting the k+1-th virtual Extent into the Extent Ext2[k] of the first enhanced stream and the Extent Ext1[k] of the Base stream as shown by the dotted lines in FIG. 7, after all, the k+1-th position information AD#0k is referred to.

When the 3D type 2 playback is performed, the virtual Extent which is a set of the Extent Ext1[k] of the Base stream and the Extent Ext3[k] of the second enhanced stream read according to the k+1-th position information AD#0k of the file entry of the 3D type 2 file can be split into the Extent Ext1[k] of the Base stream and the Extent Ext3[k] of the second enhanced stream with reference to the k+1-th position information AD#0k which is position information in the same order of the file entry of the 2D playback file (or, the second enhanced stream file).

In addition, in the virtual Extent, since the Extent Ext1 of the Base stream exists in a state of being jammed into the front side (a position side to be read first) or the rear side (a position side to be read later) of the virtual Extent, the specification of the position information of the file entry of the 2D playback file can be performed as follows when the virtual Extent is split into the Extent Ext1 of the Base stream, the extent Ext2 of the first enhanced stream and the Extent Ext3 of the second enhanced stream.

In other words, when the 3D type 1 playback is performed, for example, in the k+1-th virtual Extent read according to the k+1-th position information AD#0k of the file entry of the 3D type 1 playback file, Extents are arranged in the order of the Extent Ext2[k] of the first enhanced stream and the Extent Ext1[k] of the Base stream.

In addition, in the k+1-th virtual Extent, the boundary of the Extent Ext2[k] of the first enhanced stream and the Extent Ext1[k] of the Base stream exists between a starting address As indicated by the k+1-th position information AD#0k of the file entry of the 3D type 1 playback file and an address Ae=As+S obtained by adding a size S indicated by the position information AD#0k to the starting address As.

Therefore, in the file entry of the 2D playback file, the position information AD where the starting address has a value in the range from the address As to the address Ae becomes position information to be referred to when the k+1-th virtual Extent is split into the Extent Ext2[k] of the first enhanced stream and the Extent Ext1[k] of the Base stream.

Furthermore, when the file entry of the first enhanced stream file is referred to, the k+1-th virtual Extent is split into the Extent Ext2[k] of the first enhanced stream and the Extent Ext1[k] of the Base stream, the position information that the starting address from position information of the file entry corresponds with the starting address As indicated by the k+1-th position information AD#0k of the file entry of the 3D type 1 playback file becomes the position information to be referred to.

In the same manner, when the 3D type 2 playback is performed, the position information to be referred to is as follows when the k+1-th virtual Extent is split into the Extent Ext1[k] of the Base stream and the Extent Ext3[k] of the second enhanced stream in which Extents are arranged in the order of the Extent Ext1[k] of the Base stream and Extent Ext3[k] of the second enhanced stream read according to the k+1-th position information AD#0k of the file entry of the 3D type 2 playback file.

In other words, when the file entry of the 2D playback file is referred to, the position information that the starting address from the position information of the file entry corresponds with the starting address As indicated by the k+1-th position information AD#0k of the file entry of the 3D type 2 playback file becomes the position information to be referred to.

In addition, when the file entry of the second enhanced stream file is referred to, the position information in which the starting address from the position information of the file entry has a value in the range from the starting address As indicated by the k+1-th position information AD#0k of the file entry of the 3D type 2 playback file to the address Ae=As+S obtained by adding the size S indicated by the position information AD#0k to the starting address As becomes the position information to be referred to.

Furthermore, in the interleaving of Extents described in FIG. 4B, one set of the Extent set is formed by the k+1-th Extent Ext1[k] from the head of the Base stream, the k+1-th Extent Ext2[k] from the head of the first enhanced stream, and the k+1-th Extent Ext3[k] from the head of the second enhanced stream, but the composition of one set of the Extent set is not limited thereto.

In other words, in the interleaving of the Extents described in FIG. 4B, one set of the Extent set is formed by the k+1-th Extents Ext1[k], Ext2[k], and Ext3[k] that are (or can be) played back at the same playback time, but one set of the Extent set can be formed by Extents played back at a different playback times.

Specifically, for example, it is possible to make the k+1th Extent Ext2[k] from the head of the first enhanced stream, the k+1-th Extent Ext1[k] from the head of the Base stream, and the k+2-th Extent Ext3[k+1] from the head of the second enhanced stream one set of the Extent set by arranging the Extents in that order.

In addition, in the embodiment described from FIGS. 4A, 4B, 4C and 4D to FIG. 7, the disc 10 can be recorded with seven files at the maximum for the Base stream, the first enhanced stream, and the second enhanced stream.

In other words, the disc 10 can be recorded with a file accommodating the arrangement of the Extent Ext1 of the Base stream in the virtual Extent of 3D type 1 accommodated in the 2D playback file, the 3D type 1 playback file, and 3D type 2 playback file described in FIGS. 4A to 4D, and the first enhanced stream file, 2D playback file, and the 3D type 1 playback file described in FIG. 7 (hereinafter, referred to as a type 1 base file), and a file accommodating the arrangement of Extent Ext1 of the Base stream in the virtual Extent of 3D type 2 accommodated in the 3D type 2 playback file (hereinafter, referred to as a type 2 base file).

Furthermore, the substance of the 2D playback file, the type 1 base file, and the type 2 base file are all the arrangement of the Extent Ext1 of the Base stream, and therefore, the substance (content) of the type 1 base file and the type 2 base file are all same as a base file.

Here, the 2D playback file can be said to be a relevant file for the 2D playback. In addition, the 3D type 1 playback file, the first enhanced stream file, and the type 1 base file can be said to be relevant files for the 3D type 1 playback. Furthermore, the 3D type 2 playback file, the second enhanced stream file, and the type 2 base file can be said to be relevant files for the 3D type 2 playback.

In addition, when the 3D type 1 playback is performed, among 3D type 1 playback files, the first enhanced stream file, and the type 1 base file that are relevant files of the 3D type 1 playback, the virtual Extent accommodated in the 3D type 1 playback file is read by the file entry of the 3D type 1 playback file and the first enhanced stream file, or the file entry of the 3D type 1 playback file and the type 1 base file, and the virtual Extent can be split into the Extent Ext2 of the first enhanced stream and the Extent Ext1 of the Base stream.

In the same manner, when the 3D type 2 playback is performed, among 3D type 2 playback files, the second enhanced stream file, and the type 2 base file that are relevant files of the 3D type 2 playback, the virtual Extent accommodated in the 3D type 2 playback file is read by the file entry of the 3D type 2 playback file and the file entry of the second enhanced stream file, or the file entry of the 3D type 2 playback file and the type 2 base file, and the virtual Extent can be split into the Extent Ext3 of the second enhanced stream and the Extent Ext1 of the Base stream.

### 3D File Controller 12

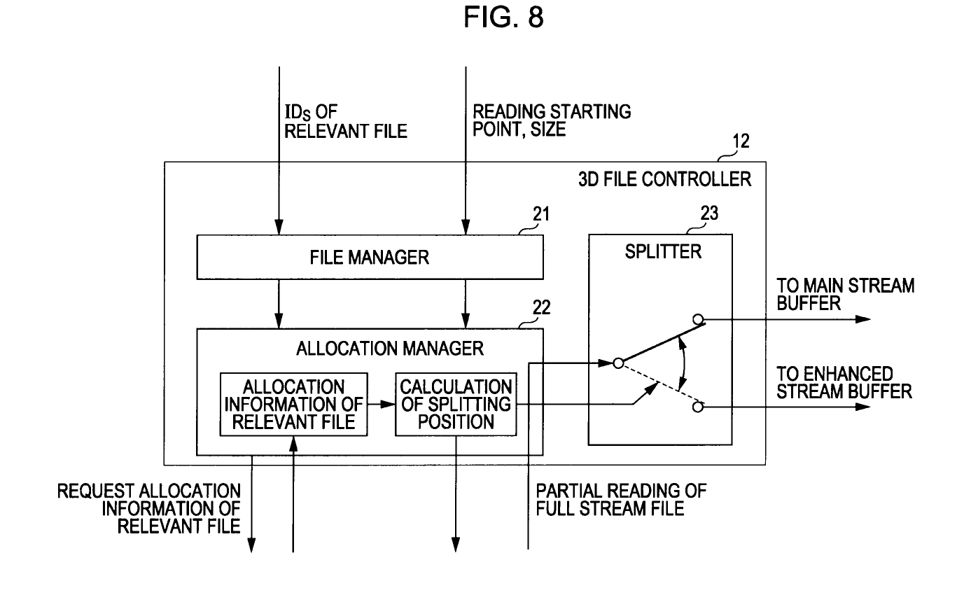

FIG. 8 is a block diagram illustrating an example of a composition of the 3D file controller 12 of FIG. 3.

The 3D file controller 12 obtains a splitting position for splitting the virtual Extent of the virtual Extent file read from the disc 10 (3D type 1 playback file or 3D type 2 playback file) into the Extent Ext1 of the Base stream and an Extent of an enhanced stream (the Extent Ext2 of the first enhanced stream or the Extent Ext3 of the second enhanced stream) from the file entry of the Base file and the virtual Extent file, and splits the virtual Extent at the splitting position. Thereby, the 3D file controller 12 functions as a playback controlling section of splitting the virtual Extent into the Extent Ext1 of the Base stream and the Extent of the enhanced stream.

In other words, the 3D file controller 12 is formed of a file manager 21, an allocation manager 22, and a splitter 23.

For example, when the 3D type 1 playback is performed, the playback manager 11 (FIG. 3) supplies the file manager 21 with, for example, an identification (ID) as information for specifying 3D type 1 playback file, the first enhanced stream file, and the type 1 base file that are relevant files of the 3D type 1 playback, a starting point for reading (reading starting point) the Base stream used for the 3D type 1 playback (Base stream accommodated in the type 1 base file) from the disc 10, and the size of the Base stream read from the disc 10 (reading size), together with a file reading request.

Here, as the reading starting point, for example, a source packet number SPN of the Base stream can be employed, and in this case, as the reading size, the number of packets of the source packet is employed.

In addition, as the reading starting point, for example, an aligned unit number (AUN) of the Base stream can be employed, and in this case as the reading size, the number of units of the aligned unit is employed.

The file manager 21 supplies the IDs of the 3D type 1 playback file, the first enhanced stream file, and the ID of the type 1 base file that are relevant files of the 3D type 1 playback, the reading starting point, and the reading size from the playback manager 11 (FIG. 3) to the allocation manager 22.

Furthermore, the file manager 21 requests the allocation manager 22 for reading of the 3D type 1 playback file and splitting the virtual Extent accommodated in the 3D type 1 playback file into the Extent Ext1 of the Base stream and Extent Ext2 of the first enhanced stream.

The allocation manager 22 acquires the file entry (allocation information) of the 3D type 1 playback file, the first enhanced stream file, and the type 1 base file which are relevant files to which IDs are supplied from the file manager 21 in the same manner by requesting to the UDF manager 13 (FIG. 3) according to the request from the file manager 21, and stores the file entry in a memory not shown in the drawing.

Furthermore, the allocation manager 22 calculates a splitting position where the virtual Extent accommodated in the 3D type 1 playback file is split into the Extent Ext1 of the Base stream and Extent Ext2 of the first enhanced stream.

In addition, the allocation manager 22 acquires the virtual Extent accommodated in the 3D type 1 playback file by requesting to the UDF manager 13 (FIG. 3) and supplies the Extent to the splitter 23.

Furthermore, the allocation manager 22 controls the splitter 23 to split the virtual Extent accommodated in the 3D type 1 playback file from the UDF manager 13 at the splitting position.

In other words, the allocation manager 22 sets the reading starting point from the file manager 21 to a variable pos and sets the reading size from the file manager 21 to a variable size.

In addition, the allocation manager 22 specifies the Extent Ext1 of the Base stream recorded on a position on the disc 10 indicated by the variable pos as a Base Extent Ext1 of interest with reference to the file entry of the type 1 base file acquired from the UDF manager 13 (FIG. 3).

In addition, the allocation manager 22 recognizes the starting address (sector number) EB_start and the size EB_size of the Base Extent Ext1 of interest with reference to the file entry of the type 1 base file acquired from the UDF manager 13.

Furthermore, the allocation manager 22 acquires a position (relative position) EB_pos relative to the position on the disc 10 indicated by the variable pos having the head of the Base Extent Ext1 of interest as a base.

Thereafter, the allocation manager 22 specifies the virtual Extent (a set of the Base Extent Ext1 of interest and the Extent Ext2 of the first enhanced stream) recorded in the starting address EB_start of the Base Extent Ext1 of interest with reference to the file entry of the 3D type 1 playback file acquired from the UDF manager 13.

Furthermore, the allocation manager 22 acquires a starting address EF_start of a virtual Extent of interest and a size EF_size with reference to the file entry of the 3D type 1 playback file acquired from the UDF manager 13.

In addition, the allocation manager 22 acquires a splitting position SP in which the virtual Extent of interest is split based on the starting address EB_start of the Extent Ext1 of the Base of interest and the starting address EF_start of the virtual Extent of interest.

In other words, when the starting address EB_start of the Extent Ext1 of the Base of interest is greater than the starting address EF_start of the virtual Extent of interest (EB_start>EF_start) in other words, in the virtual Extent of interest, when the Extent Ext2 of the first enhanced stream is positioned in the front side (a side to be read first) and the Extent Ext1 of the Base of interest is positioned in the rear side (a side to be read later), the allocation manager 22 sets the splitting position SP to the starting address EB_start of the Extent Ext1 of the Base of interest.

In addition, when the starting address EB_start of the Extent Ext1 of the Base of interest is equal to the starting address EF_start of the virtual Extent of interest (EB_star=EF_start), in other words, when the Extent Ext2 of the first enhanced stream is positioned in the rear side and the Extent Ext1 of the Base of interest is positioned in the front side in the virtual Extent of interest, the allocation manager 22 sets the splitting position SP to an additional value obtained by adding the starting address EB_start of the Extent Ext1 of the Base of interest to the size EB_size thereof.

Thereafter, the allocation manager 22 requests to the UDF manager 13 (FIG. 3) as much data as the size EF_size of the virtual Extent of interest, that is the virtual Extent of interest from the starting address EF_start of the virtual Extent of interest, acquires the data, and supplies the data to the splitter 23.

Furthermore, the allocation manager 22 controls the splitter 23 to split the virtual Extent of interest at the splitting position SP.

The splitter 23 splits the virtual Extent of interest from the allocation manager 22 at the splitting position SP according to the control of the allocation manager 22, and thereby splitting the virtual Extent of interest into Extent (Base Extent of interest) Ext1 of the Base stream and the Extent Ext2 of the first enhanced stream.

In addition, the splitter 23 supplies the Extent Ext1 of the Base stream to the main stream buffer 14 (FIG. 3) as an Extent of the main stream, and supplies the Extent Ext2 of the first enhanced stream to the enhanced stream buffer 15 (FIG. 3) as an Extent of the enhanced stream.

Thereafter, the allocation manager 22 determined whether a subtraction value EB_size-EB_pos obtained by subtracting a relative position EB_pos from the size EB_size of the Extent Ext1 of the Base of interest is equal to or more than a variable size.

When the subtraction value EB_size-EB_pos is not equal to or more than the variable size, the allocation manager 22 newly sets an addition value obtained by adding the variable pos to the value EB_size-EB_pos to the variable pos.

Furthermore, the allocation manager 22 newly sets a subtraction value obtained by subtracting the value EB_size-EB_pos from the variable size to the variable size.

In addition, the allocation manager 22 newly specifies the Extent Ext1 of the Base stream recorded at a position on the disc 10 indicated by the variable pos as the Extent Ext1 of the Base of interest with reference to the file entry of the type 1 base file acquired from the UDF manager 13 (FIG. 3).

On the other hand, when the subtraction value EB_size-EB_pos is equal to or more than the variable size, in other words, when reading of the Extent of the Base stream and the Extent of the first enhanced stream that composes the virtual Extent by forming a set with the Extent of the Base stream is completed as much as a reading size from the reading starting point from the file manager 21, the 3D file controller 12 ends the processing.

When the 3D type 2 playback is performed, the same process is performed in the 3D file controller 12 as in the case where the 3D type 1 playback is performed, and thereby the Extent Ext1 of the Base stream is supplied to the main stream buffer 14 (FIG. 3) as the Extent of the main stream, and the Extent Ext3 of the second enhanced stream is supplied to the enhanced stream buffer 15 (FIG. 3) as the Extent of the enhanced stream.

Example of Composition of Recording Device Applied with the Present Invention

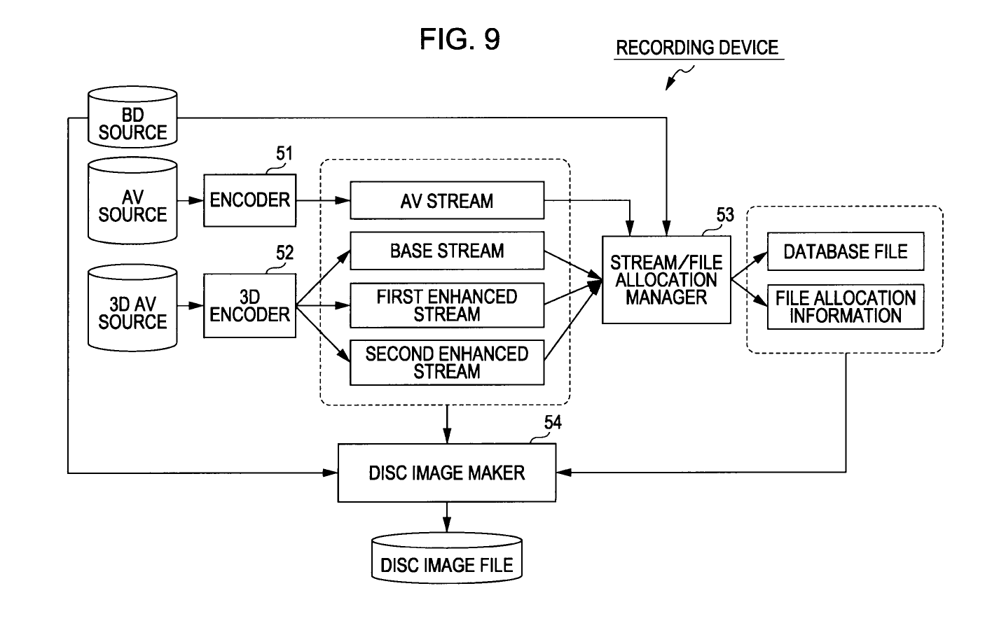

FIG. 9 is a block diagram illustrating an example of a composition of an embodiment of a recording device to which the present invention is applied.

The recording device of FIG. 9 is an authoring device for producing the disc 10 that is a BD, and the disc 10 is recorded with streams, files (file entries, or the like), and other necessary information.

In other words, an encoder 51 is supplied with an AV source not relating to the 3D playback (other AV source (non 3D)) from the outside.

The encoder 51 performs encoding in the MPEG mode or the like, for example, for the AV source supplied thereto, and supplies the AV stream (AV Stream) obtained from the result to an allocation manager 53 and a disc image maker 54.

A 3D encoder 52 is supplied with an AV source for 3D (3D AV source) relating to the 3D playback from the outside.

The 3D encoder 52 performs encoding or the like in the H.264 AVC/MVC mode, for example, for the 3D AV source supplied thereto, and supplies the Base stream (MVC Base view Stream), the first enhanced stream (1st Enhanced view Stream), and the second enhanced stream (2nd Enhanced view Stream) obtained from the result to the allocation manager (stream/file allocation manager) 53 and the disc image maker 54.

The allocation manager 53 is supplied with the AV stream from the encoder 51, and the Base stream, the first enhanced stream, and the second enhanced stream from the 3D encoder 52, as well as a BD source recorded on the disc 10 (other BD source) other than the AV source and the 3D AV source from the outside.

The allocation manager 53 generates and supplies database files of BD database (BD database files) and file allocation information based on the AV stream from the encoder 51, and the Base stream, the first enhanced stream, and the second enhanced stream from the 3D encoder 52, and BD source from outside to the disc image maker 54.

Here, the file allocation information generated by the allocation manager 53 includes at least the file entry of the 2D playback file that is a base file, the 3D type 1 playback file and 3D type 2 playback file that are virtual Extent files.

Therefore, the allocation manager 53 functions as a file entry generating section for generating file entries.

The disc image maker 54 generates the interleaving data described in FIGS. 4A to 4D from the Base stream, the first enhanced stream, and the second enhanced stream from the 3D encoder 52.

Therefore, the disc image maker 54 functions as an interleaving data generating section for generating interleaving data.

Furthermore, the disc image maker 54 generates interleaving data, the AV stream from the encoder 51, a database file from the allocation manager 53, and a disc image file (BD Disc image file) of disc image (image data) of file allocation information.

In addition, the disc image maker 54 records a disc image of a disc image file on the disc 10.

Therefore, the disc image maker 54 functions as a record controlling section performing the recording control to record the interleaving data and file entry on the disc 10.

Furthermore, in the above, the disc 10 is made to be recorded with both of the first enhanced stream and the second enhanced stream in addition to the Base stream so that 3D images can be displayed in any of the modes including the Type 1 display mode and the Type 2 display mode. However, when the 3D images are displayed in any one of the Type 1 display mode or the Type 2 display mode, the disc 10 may be recorded with either the first enhanced stream or the second enhanced stream in addition to the Base stream.

In other words, when the 3D images is displayed in only Type 1 display mode, the disc 10 may be recorded with the Base stream and the first enhanced stream, and when the 3D images are displayed in only Type 2 display mode, the disc 10 may be recorded with the Base stream and the second enhanced stream.

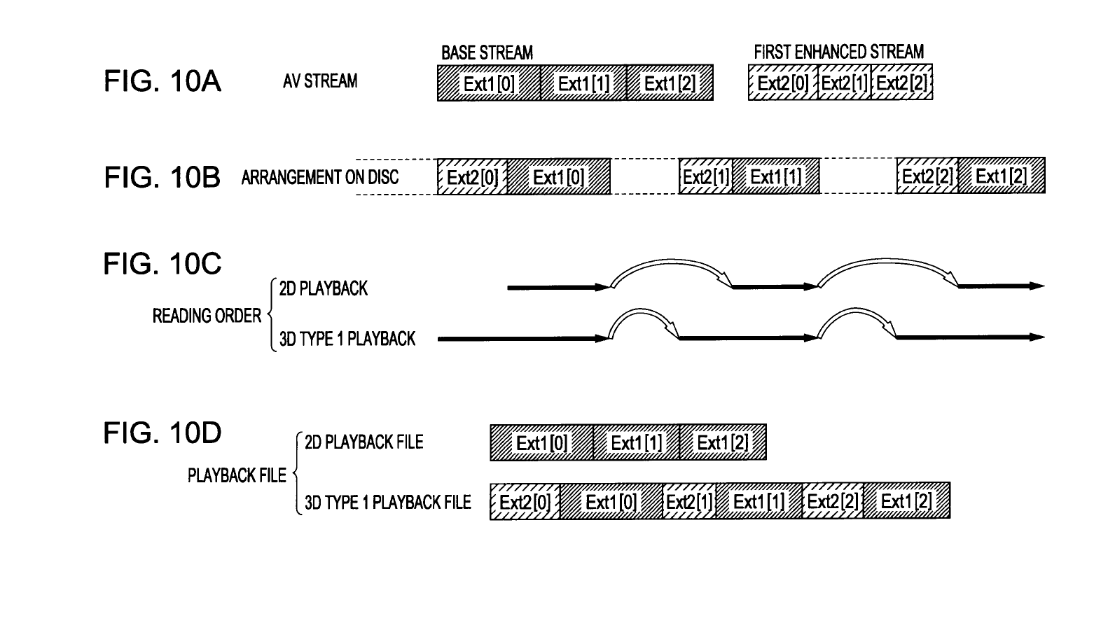

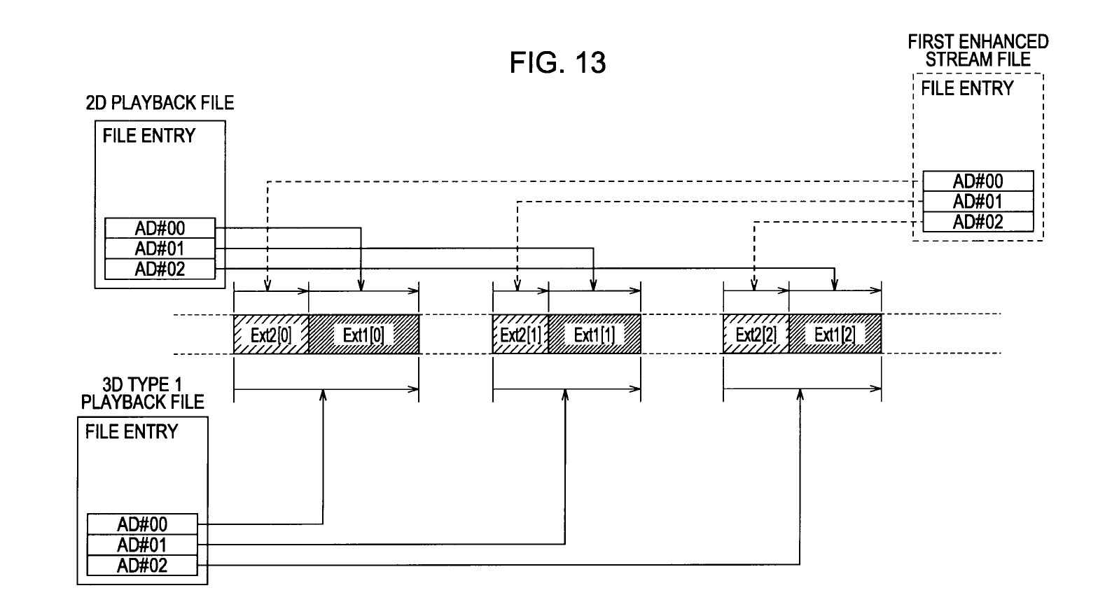

The disc 10 recorded with the Base stream and the first enhanced stream (not recorded with the second enhanced stream) will be described with reference to FIGS. 10A to 10D and to FIG. 13.

FIG. 10 is a diagram explaining the Base stream, the first enhanced stream, and a file recorded on the disc 10.

In other words, FIG. 10A shows the Base stream and the first enhanced stream recorded on the disc 10 and is the same as FIG. 4A.

Both of the Base stream and the first enhanced stream are split into Extents as shown in FIG. 10A.

In addition, each Extent of the Base stream and the first enhanced stream is interleaved and the interleaving data obtained from the result is recorded on the disc 10 so as to be physically consecutive (as possible as they can be).

FIG. 10B shows the interleaving data recorded on the disc 10.

In the interleaving data of FIG. 10B, the Extent Ext1[k] of the Base stream and the Extent Ext2[k] of the first enhanced stream are arranged in the order of Extents Ext2[0], Ext1[0], Extents Ext2[1], Ext1[1], and Extents Ext2[2], Ext1[2].

As described in FIGS. 4A to 4D, in the interleaving data of Extents, the Extents are arranged so that the Extent Ext2 of the first enhanced stream which is a selective stream is adjacent to the Extent Ext1 of the Base stream which is an essential stream.

In other words, two kinds of the Extents that are the Extent Ext1 of the Base stream and the Extent Ext2 of the first enhanced stream are arranged in the order of Extent Ext2 and Ext1 so as to be consecutive as one set of an Extent set.

Furthermore, in FIG. 10B, the Extent sets are recorded on the disc 10 so that small gaps are formed between adjacent Extent sets, but the Extent sets can be recorded on the disc 10 so as not to form the gaps between the adjacent Extent sets.

As described above, by setting the Extents to an interleaving arrangement and recording on the disc 10, two streams (of Extents) including the Base stream and the first enhanced stream can be swiftly read from the disc 10 during the 3D playback so as to be in time for the playback.

In other words, FIG. 100 is a diagram explaining reading of Extents from the disc 10.

When the 2D playback is performed, only the Extent Ext1 of the Base stream is read from the disc 10 among the Base stream and the first enhanced stream.

When the 3D playback is performed (the 3D type 1 playback here), the Extent Ext1 of the Base stream and the Extent Ext2 of the first enhanced stream are read from the disc 10.

As described above, since the Extent Ext1 of the Base stream and the Extent Ext2 of the first enhanced stream are recorded adjacently (consecutively) in an Extent set, the Extents Ext1 and Ext2 (an Extent set) can be read without seek, in other words, swiftly read.

FIG. 10D shows files recorded on the disc 10 when the disc 10 is recorded with interleaving data obtained by interleaving the Extents shown in FIG. 10B.

The disc 10 is recorded with a 2D playback file and 3D type 1 playback file.

As described in FIGS. 4A to 4D, the 2D playback file accommodates the Extent Ext1 of the Base stream necessary for the 2D playback in the order of Ext1[0], Ext1[1], and Ext1[2] which is a playback order.

In the same manner, the 3D type 1 playback file accommodates the Extent Ext1 of the Base stream and the Extent Ext2 of the first enhanced stream necessary for the 3D type 1 playback in the order of a (virtual Extent of) set of Ext2[0] and Ext1[0], a set of Ext2[0] and Ext1[1], and a set of Ext2[2] and Ext1[2] that is a playback order.

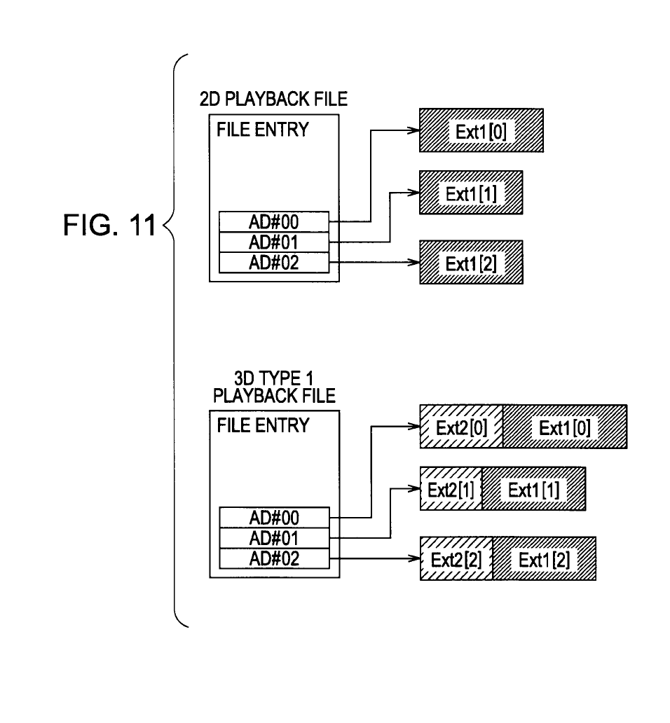

FIG. 11 is a diagram explaining the management of files on the disc 10 described in FIGS. 10A to 10D by a file system (driver).

In other words, FIG. 11 shows file entries of the 2D playback file and the 3D type 1 playback file.

As described in FIG. 5, the file entry of the 2D playback file is registered with position information AD#00, AD#01, and AD#01 of each of the Extents Ext1[0], Ext1[1], and Ext1[2] that are constituent elements of the 2D playback file.

In the same manner, the file entry of the 3D type 1 playback file is registered with position information of a virtual Extent which is one virtual Extent for a set of the Extent Ext1 of the Base stream and the Extent Ext2 of the first enhanced stream that are constituent elements of the 3D type 1 playback file and recorded on the disc 10 physically consecutively.

In other words, the file entry of the 3D type 1 playback file is registered with the position information AD#00 of the virtual Extent that is a set of the Extents Ext2[0] and Ext1[0], the position information AD#01 of the virtual Extent that is a set of the Extents Ext2[0] and Ext1[1], and the position information AD#02 of the virtual Extent that is a set of the Extents Ext2[2] and Ext1[2].

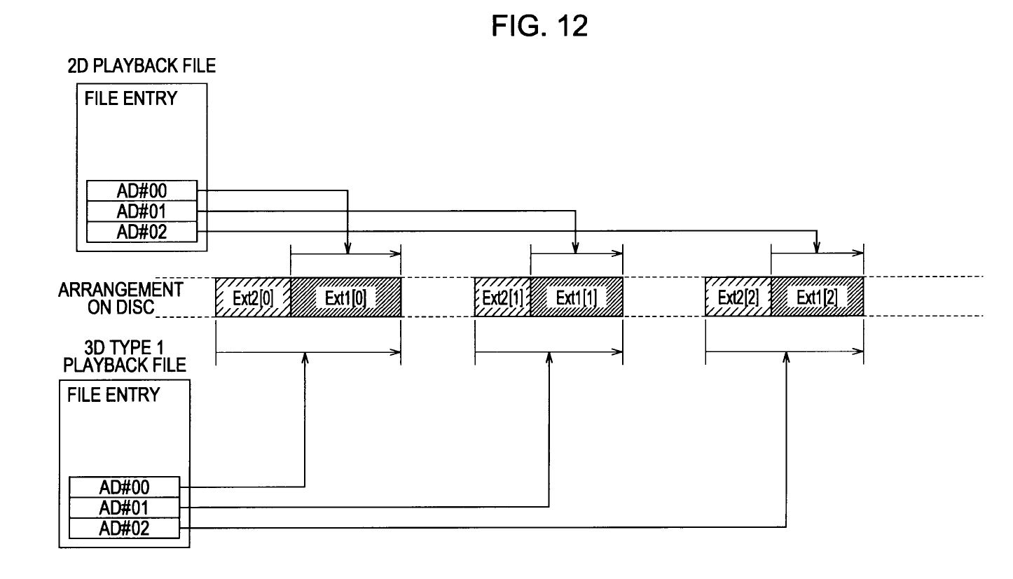

FIG. 12 is a diagram explaining a reading process in which the file system reads Extents (virtual Extents) from the disc 10 described in FIGS. 10A to 10D with reference to the file entries and provides the Extents to the outside.

For example, if a playback application requests the file system for reading of the 2D playback file, the file system reads the Extents Ext1[0], Ext1[1], and Ext1[2] from the disc 10 and provides with reference to the file entry of the 2D playback file.

Since the Extents Ext1[0], Ext1[1], and Ext1[2] read from the disc 10 are Extents of the Base stream, the playback application can perform the 2D playback by using the Extents Ext1[0], Ext1[1], and Ext1[2] of the Base stream.

In addition, if the playback application requests the file system for reading of the 3D type 1 playback file, the file system reads the virtual Extent of a set of the Extents Ext2[0] and Ext1[0], the virtual Extent of a set of the Extents Ext2[1] and Ext1[1], and the virtual Extent of a set of the Extents Ext2[2] and Ext1[2] from the disc 10 and provides them with reference to the file entry of the 3D type 1 playback file.

In the virtual Extent of a set of the Extents Ext2[0] and Ext1[0], the virtual Extent of a set of the Extents Ext2[1] and Ext1[1], and the virtual Extent of a set of the Extents Ext2[2] and Ext1[2] read from the disc 10, the Extents Ext1[0], Ext1[1], and Ext1[2] are Extents of the Base stream and the remaining Extents Ext2[0], Ext2[1], and Ext2[2] are Extents of the first enhanced stream.

Therefore, the playback application can perform the 3D type 1 playback by using the Extents Ext1[0], Ext1[1], and Ext1[2] of the Base stream and the Extents Ext2[0], Ext2[1], and Ext2[2] of the first enhanced stream read from the disc 10.

However, when the 3D type 1 playback is performed, it is necessary to decode each of the Base stream and the first enhanced stream or the like. And therefore, it is necessary for the virtual Extent read from the disc 10 to be split into the Extent Ext2 of the first enhanced stream and the Extent Ext1 of the Base stream.

FIG. 13 is a diagram explaining a method of splitting the virtual Extent read from the 3D type 1 playback file into the Extent Ext2 of the first enhanced stream and the Extent Ext1 of the Base stream as described in FIG. 12.

As described above, the file system reads the virtual Extent which is a set of the Extent Ext2 of the first enhanced stream and the Extent Ext1 of the Base stream (a virtual Extent that is a set of the Extents Ext2[0] and Ext1[0], a virtual Extent that is a set of the Extents Ext2[1] and Ext1[1], and a virtual Extent that is a set of the Extents Ext2[2] and Ext1[2]) from the disc 10 with reference to the file entry of the 3D type 1 playback file.

The file system manages the file entry of the 2D playback file, and can recognize a boundary of the Extents Ext2 and Ext1 in the virtual Extent of Extent Ext2 of the first enhanced stream and the Extent Ext1 of the Base stream with reference to the file entry.

Therefore, the virtual Extent of the Extent Ext2 of the first enhanced stream and the Extent Ext1 of the Base stream can be split into the Extent Ext2 of the first enhanced stream and the Extent Ext1 of the Base stream with reference to the file entry of the 2D playback file.

Furthermore, as shown by the dotted lines in FIG. 13, if the disc 10 is recorded with the first enhanced stream file, the virtual Extent that is a set of the Extent Ext2 of the first enhanced stream and the Extent Ext1 of the Base stream read from the 3D type 1 playback file can be split into the Extents Ext2 and Ext1 with reference to the first enhanced stream file instead of the file entry of the 2D playback file.

In addition, in FIGS. 10A to 10D and to FIG. 13, the Extent Ext2 of the first enhanced stream and the Extent Ext1 of the Base stream are arranged in that order to form the virtual Extent, but the virtual Extent can be formed in a way that the Extent Ext2 of the first enhanced stream and the Extent Ext1 of the Base stream are arranged reversely to the above order, in other words, arranged in the order of the Extent Ext1 of the Base stream and the Extent Ext2 of the first enhanced stream.

However, it is preferable that the virtual Extent is formed in the order of the Extent Ext2 of the first enhanced stream and the Extent Ext1 of the Base stream as described in FIGS. 10A to 10D and to FIG. 13.

In other words, as described above, between the Extent Ext1 of the Base stream and the Extent Ext2 of the first enhanced stream, the Extent Ext1 of the Base stream has a larger amount of data and the Extent Ext2 of the first enhanced stream has a smaller amount of data.

Therefore, when the Extent Ext1 of the Base stream and the Extent Ext2 of the first enhanced stream are arranged in that order in the virtual Extent, in reading of the virtual Extent, the Extent Ext1 of the Base stream is read first, and the Extent Ext2 of the first enhanced stream is read later.

In this case, the display of 3D images is not able to be performed until the Extent Ext1 of the Base stream is read and then the Extent Ext2 of the first enhanced stream starts to be read.

For this reason, it is necessary to temporarily store the Extent Ext1 of the Base stream read first in a buffer, but in this case, a buffer with large capacity is necessary in order to store the Extent Ext1 of the Base stream having a large amount of data.

On the other hand, in the virtual Extent, when the Extent Ext2 of the first enhanced stream is arranged first and then the Extent Ext1 of the Base stream is arranged later, the Extent Ext2 of the first enhanced stream is read first, and the Extent Ext1 of the Base stream is read later.

Also in this case, it is necessary to temporarily store the Extent Ext2 of the first enhanced stream read first in a buffer, but a buffer with small capacity can be employed because the Extent Ext2 of the first enhanced stream has a small amount of data.

Explanation of Computer applied with the Present Invention

Next, a series of the process described above can be performed by hardware, and can be performed by software. When a series of the process is performed by software, a program composing the software is installed in a general computer or the like.

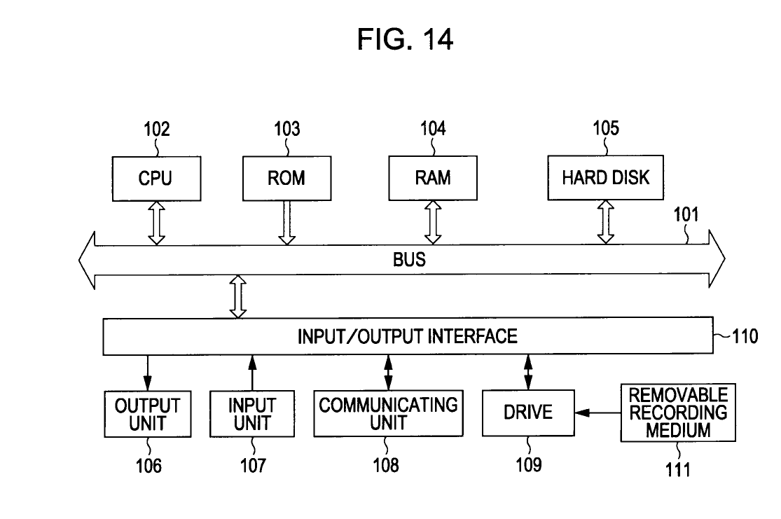

FIG. 14 shows an example of a composition of an embodiment for a computer in which a program executing a series of the process described above is installed.

The program can be recorded in advance in a hard disk 105 or a ROM 103 as a recording medium embedded in a computer.

Or, the program can be accommodated (recorded) in a removable recording medium 111. Such a removable recording medium 111 can be provided as so-called package software. Here, as a removable recording medium 111, for example, there are a flexible disc, a compact disc read only memory (CD-ROM), a magneto optical (MO) disc, a digital versatile disc (DVD), a magnetic disc, a semiconductor memory and the like.

Furthermore, the program can be installed in a computer from the removable recording medium 111 as described above, downloaded on a computer via a communication network or a broadcasting network, and installed in the embedded hard disk 105. In other words, the program can be wirelessly transferred to a computer from a download site via a satellite for digital satellite broadcasting and transferred by wire to a computer via a network such as a local area network (LAN), and the Internet.

The computer is embedded with a central processing unit (CPU) 102 and the CPU 102 is connected to an input/output interface 110 via a bus 101.

If a user inputs an instruction by operating an input unit 107 or the like through the input/output interface 110, the CPU 102 executes the program accommodated in a read only memory (ROM) 103 according to the instruction. Or, the CPU 102 executes the program accommodated in the hard disk 105 by loading on a random access memory (RAM) 104.

Accordingly, the CPU 102 performs a process according to the flowchart described above or a process executed by the composition of the block diagram described above. In addition, the CPU 102 causes the output of the process result from an output unit 106, for example, via the input/output interface 110, transmits the result from a communicating unit 108, records the result in the hard disk 105, or the like depending on the necessity.

Furthermore, the input unit 107 includes a keyboard, a mouse, a microphone, or the like. In addition, the output unit 106 includes a liquid crystal display (LCD), a speaker, or the like.

Here, in the present specification, the process executed by the computer according to the program is not necessary to be performed in time series according to the order described in the flowchart. In other words, the process executed by the computer according to the program includes a process executed in parallel or individually (for example, a parallel process or a process by an object).

In addition, the program may be processed by one computer (processor), or processed by a plurality of computers in a dispersed manner. Furthermore, the program may be processed by being transmitted to a computer in the distance.

Furthermore, the embodiment of the present invention is not limited to the embodiment described above, and can be modified in various ways within a scope not departing from the gist of the present invention.

### Second Embodiment

Hereinafter, the Base stream will be referred to as a Base view video stream. In addition, the enhanced stream will be referred to as a Dependent view video stream.

### Example of Composition of Playback System

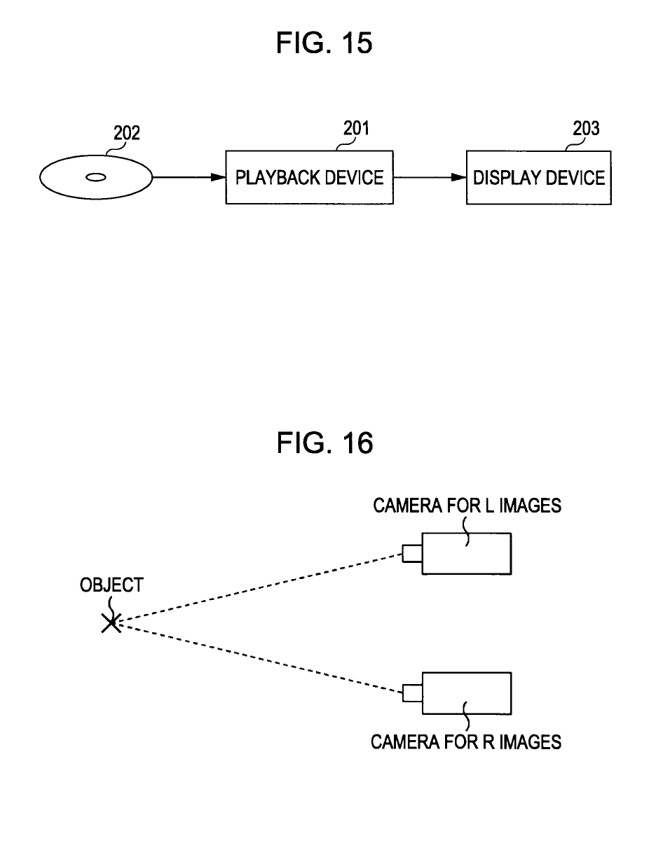

FIG. 15 is a diagram illustrating an example of a composition of a playback system including a playback device 201 to which the present invention is applied.

As shown in FIG. 15, the playback system is configured so that the playback device 201 and a display device 203 are connected to each other with a high definition multimedia interface (HDMI) cable, or the like. The playback device 201 is loaded with an optical disc 202 such as a BD or the like.

The optical disc 202 is recorded with streams necessary for displaying stereo images (3D images) having two viewpoints.

Data of each stream are recorded on the optical disc 202 in a unit of Extent in an interleaved state as described above.

The playback device 201 is a player for 3D playback of streams recorded on the optical disc 202. The playback device 201 plays back streams recorded on the optical disc 202 and causes the display device 203 including a television set to display the 3D images obtained from the playback. Audio also is played back by the playback device 201 in the same manner and output from a speaker provided in the display device 203.

The optical disc 202 is recorded with streams that can be used for displaying 3D images in both of the Type 1 and Type 2 display modes described above. As an encoding method for recording the streams on the optical disc 202, for example, the H.264 advanced video coding (AVC)/multi-view video coding (MVC) is employed.

### H.264 AVC/MVC Profile

In the H.264 AVC/MVC, an image stream called a Base view video and an image stream called Dependent view video are defined. Hereinafter, the H.264 AVC/MVC will be simply and appropriately referred to as an MVC.

FIG. 16 is a diagram illustrating an example of imaging.

As shown in FIG. 16, for the same object as a target, a camera for L images and a camera for R images capture images. Elementary streams of the video imaged by the camera for L images and the camera for R images are input to an MVC encoder.

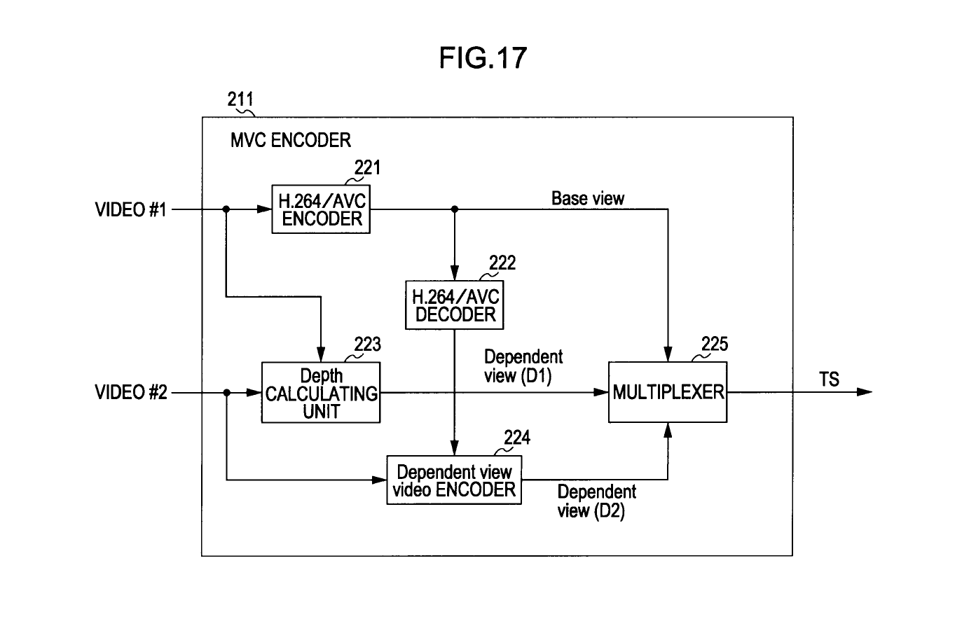

FIG. 17 is a block diagram illustrating an example of a composition of the MVC encoder.

As shown in FIG. 17, the MVC encoder 211 includes a H.264/AVC encoder 221, a H.264/AVC decoder 222, a depth calculating unit 223, a Dependent view video encoder 224, and a multiplexer 225.

The stream of video #1 imaged by the camera for L images is input to the H.264/AVC encoder 221 and the depth calculating unit 223. In addition, the stream of video #2 imaged by the camera for R images is input to the depth calculating unit 223 and the Dependent view video encoder 224. The stream of video #2 may be input to the H.264/AVC encoder 221 and the depth calculating unit 223 and the stream of video #1 may be input to the depth calculating unit 223 and the Dependent view video encoder 224.

The H.264/AVC encoder 221 encodes the stream of video #1 as, for example, a H.264 AVC/high profile video stream. The H.264/AVC encoder 221 outputs the AVC video stream obtained by the encoding to the H.264/AVC decoder 222 and the multiplexer 225 as the Base view video stream.

The H.264/AVC decoder 222 decodes the AVC video stream supplied from the H.264/AVC encoder 221 and outputs the stream of video #1 obtained by the decoding to the Dependent view video encoder 224.

The depth calculating unit 223 calculates depth (disparity) based on the stream of video #1 and the stream of video #2 and outputs the data of the calculated depth to the multiplexer 225.

The Dependent view video encoder 224 encodes the stream of video #1 supplied from the H.264/AVC decoder 222 and the stream of video #2 input from outside, and outputs the Dependent view video stream.

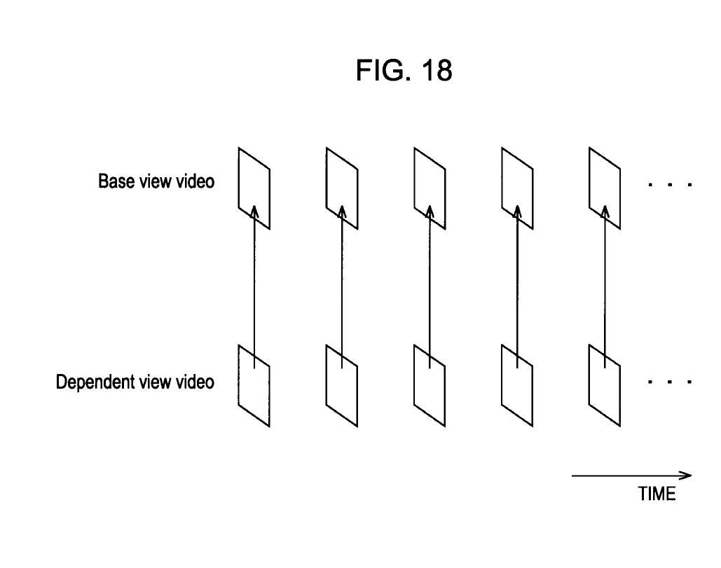

For the Base view video, predictive encoding having another stream as a reference image is not permitted, but as shown in FIG. 18, for the Dependent view video, predictive encoding having the Base view video as a reference image is permitted. For example, when encoding is performed for L images as the Base view video and for R images as the Dependent view video, the data amount of the Dependent view video stream is smaller than the data amount of the Base view video stream.

Furthermore, since the encoding is performed with the H.264/AVC, prediction for the Base view video in the time direction is performed. In addition, prediction between views for the Dependent view video is performed in the time direction. During decoding of the Dependent view video, it is necessary to end decoding of the corresponding Base view video first that is a reference source during encoding.

The Dependent view video encoder 224 outputs the Dependent view video stream obtained by encoding by also using the prediction between views to the multiplexer 225.

The multiplexer 225 multiplexes the Base view video stream supplied from the H.264/AVC encoder 221, the Dependent view video stream supplied from the depth calculating unit 223 (data of depth), and the Dependent view Video stream supplied from the Dependent view video encoder 224, for example, as MPEG2 TS. The Base view video stream and the Dependent view video stream may be multiplexed to one MPEG2 TS, and included in different MPEG2 TS.

The multiplexer 225 outputs the generated TS (MPEG2 TS). The TS output from the multiplexer 225 is recorded on the optical disc 202 with other management data in a recording device, and supplied to the playback device 201 in the form of being recorded on the optical disc 202.

Hereinafter, as shown in FIG. 17, the Dependent view video including depth information is referred to as D1 view video and the Dependent view video including R images is referred to as D2 view video appropriately among two pieces of Dependent view video. Furthermore, it is possible to process the Dependent view video including R images as the D1 view video and to process the Dependent view video including depth information as the D2 view video.

In addition, 3D playback performed by using the Base view video and the D1 view video is referred to as B-D1 playback. 3D playback performed by using the Base view video and the D2 view video is referred to as B-D2 playback.

When the B-D1 playback is performed according to an instruction or the like by a user, the playback device 201 reads the Base view video stream and D1 view video stream from the optical disc 202 and plays back.

In addition, when the B-D2 playback is performed, the playback device 201 reads the view video stream and D2 view video stream from the optical disc 202 and plays back.

Furthermore, when a normal playback of 2D images is performed, the playback device 201 reads only the Base view video stream from the optical disc 202 and plays back.

Since the Base view video stream is the AVC video stream encoded with the H.264/AVC, if there is a player for a BD format, the player can play back the Base view video stream and display 2D images.

### Example of Composition of TS

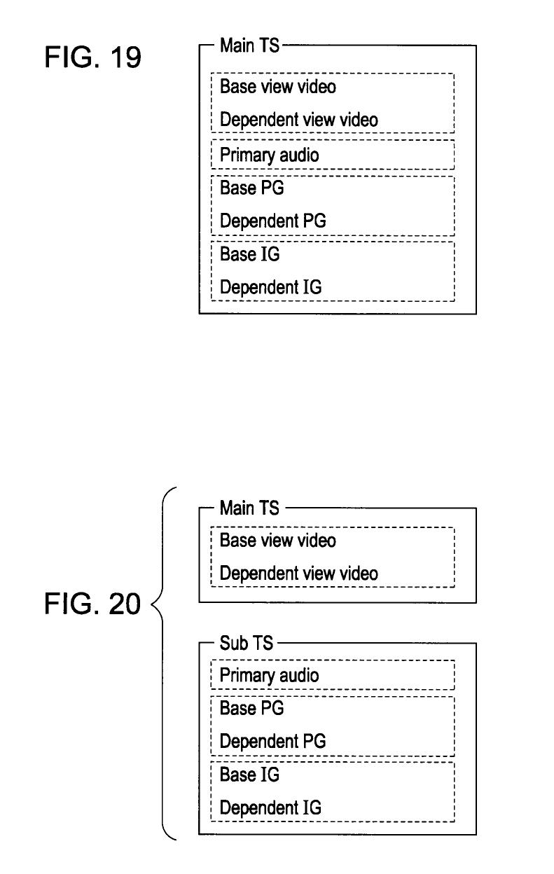

FIG. 19 is a diagram illustrating an example of the composition of TS.

In the Main TS of FIG. 19, each stream of Base view video, Dependent view video, Primary audio, Base PG, Dependent PG, Base IG, and Dependent IG is multiplexed. As such, the Dependent view video stream may be included in the Main TS with the Base view video stream.

The optical disc 202 is recorded with the Main TS and the Sub TS. The Main TS is TS including at least the Base view video stream. The Sub TS includes other streams than the Base view video stream, and is TS used together with the Main TS.

Each stream of the Base view and the Dependent view is prepared for the PG and the IG so as to be three-dimensionally displayed as videos.

FIG. 20 is a diagram illustrating another example of the composition of TS.

In the Main TS of FIG. 20, each stream of the Base view video and the Dependent view video is multiplexed.

On the other hand, each stream of Primary audio, Base PG, Dependent PG, Base IG, and Dependent IG is multiplexed in the Sub TS.

As such, the video stream may be multiplexed in the Main TS, and streams of the PG and the IG may be multiplexed in the Sub TS.

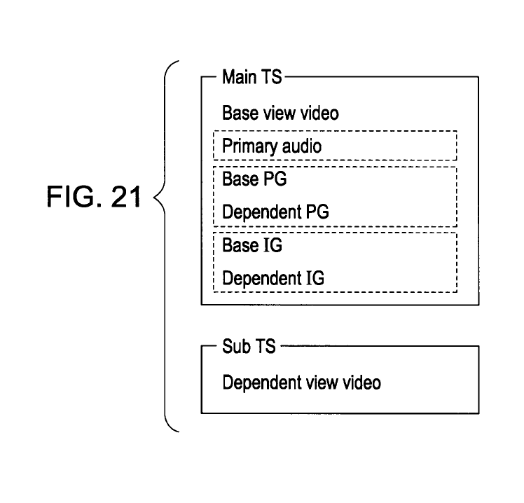

FIG. 21 is a diagram illustrating still another example of the composition of the TS.

In the Main TS of FIG. 21, each stream of Base view video, Primary audio, Base PG, Dependent PG, Base IG, and Dependent IG is multiplexed.

On the other hand, the Sub TS includes the Dependent view video stream.

As such, the Dependent view video stream may be included in another TS different from the Base view video stream.

### Application Format

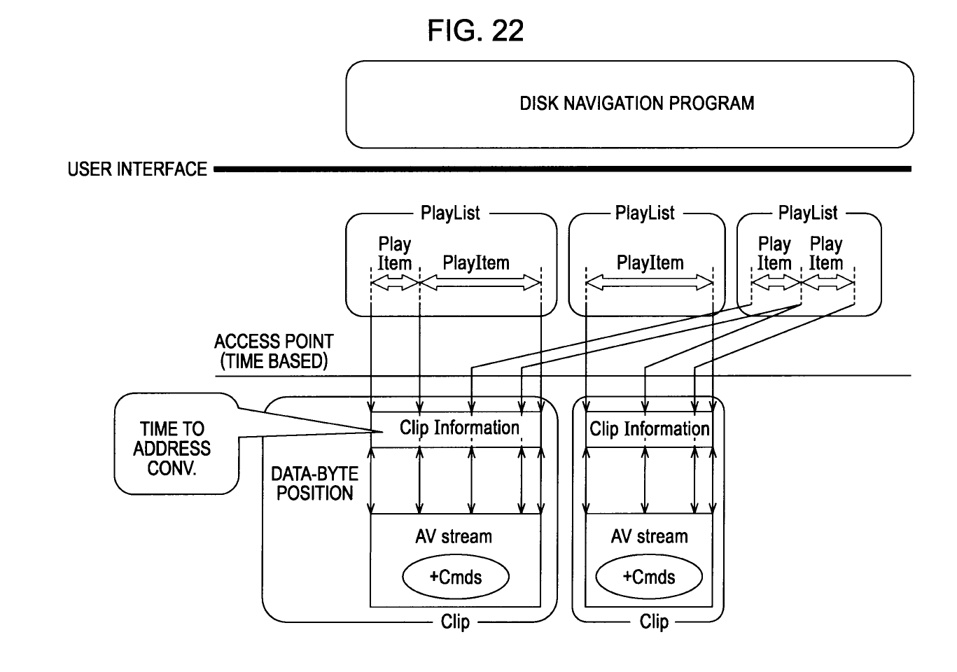

FIG. 22 is a diagram illustrating an example of the management of AV streams by the playback device 201.

The management of the AV stream is performed by using two layers of PlayList and Clip as shown in FIG. 22. The AV stream may be recorded not only on the optical disc 202 but also a local storage of the playback device 201.

Here, a pair of Clip information which includes one AV stream and information accompanying thereto is considered as one object, and the pairs are comprehensively referred to as a Clip. Hereinafter, a file accommodating AV streams is referred to as an AV stream file. In addition, a file accommodating Clip information is referred to as a Clip information file.

An AV stream is developed on a time axis, and an access point of each Clip is mainly designated in a PlayList with a time stamp. A Clip information file is used for finding out an address to be started with decoding in the AV stream.

The PlayList is a gathering of playback zones in an AV stream. One playback zone in the AV stream is called a PlayItem. The PlayItem is indicated by a pair of an IN point and an OUT point of a playback zone on a time axis. As shown in FIG. 22, the PlayList is formed of one or a plurality of PlayItems.

The first PlayList from the left of FIG. 22 is formed of two PlayItems, and the first half and the second half of the AV stream included in the left Clip are each referred to by the two PlayItems.

The second PlayList from the left is formed of one PlayItem, and the whole AV stream included in the right Clip is referred to by the PlayItem.

The third PlayList from the left is formed of two PlayItems, and a portion of the AV stream included in the left Clip and a portion of the AV stream included in the right Clip are each referred to by the two PlayItems.

For example, when the left PlayItem included in the first PlayList from the left is designated as a playback target by a disc navigation program, the first half of the AV stream referred by the PlayItem and included in the left Clip is played back. As such, the PlayList is used as playback management information for managing playback of the AV stream.

In the PlayList, a playback path made of an arrangement of one or more PlayItems is called a Main Path.

In addition, in the PlayList, a playback path made of an arrangement of one or more SubPlayItems in parallel with the Main Path is called a Sub Path.

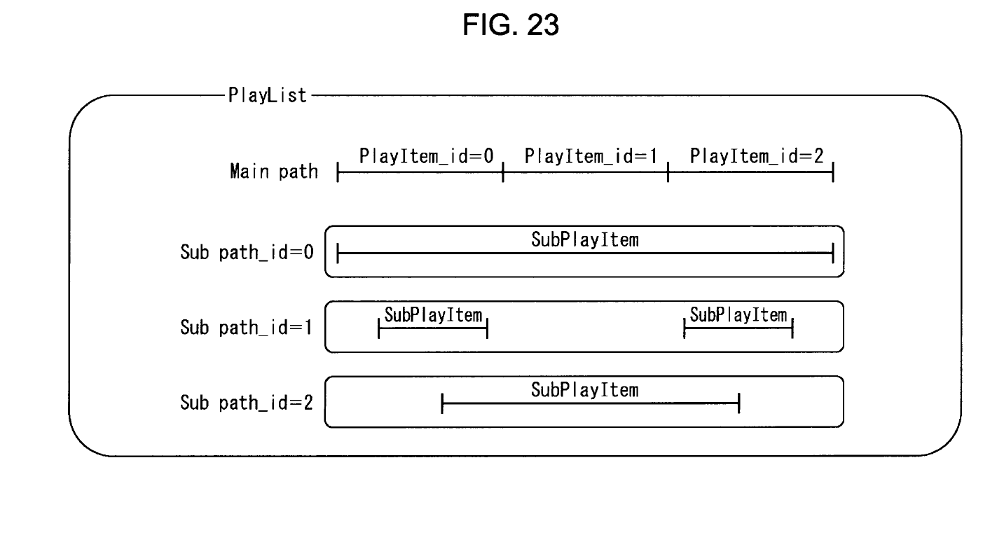

FIG. 23 is a diagram illustrating the structure of the Main Path and the Sub Path.

The PlayList can have one Main Path and one or more Sub Paths.

The Base view video stream described above is managed as a stream that the PlayItem forming the Main Path refers to. In addition, the Dependent view video stream is managed as a stream that the SubPlayItem forming the Sub Path refers to.

The PlayList of FIG. 23 has one Main Path made of the arrangement of three PlayItems and three Sub Paths.

In the PlayItem forming the Main Path, each ID is set in order from the head. In the Sub Path, IDs of Subpath_id=0, Subpath_id=1, and Subpath_id=2 are set in order from the head.

In the example of FIG. 23, the Sub Path of Subpath_id=0 includes one SubPlayItem, and the Sub Path of Subpath_id=1 includes two SubPlayItems. In addition, the Sub Path of Subpath_id=2 includes one SubPlayItem.

The Clip AV stream that one PlayItem refers to includes at least a video stream (main image data).

In addition the Clip AV stream may be or may not be included with one or more audio streams (synchronized and) played back at the same time of the video stream included in the Clip AV stream.

The Clip AV stream may be or may not be included with one or more bitmap subtitle data (presentation graphic (PG)) streams played back in synchronization with the video stream included in the Clip AV stream.

The Clip AV stream may be or may not be included with one or more interactive graphic (IG) streams played back in synchronization with the video stream included in the Clip AV stream file. The IG stream is used for displaying graphics of a button or the like operated by a user.

In the Clip AV stream that one PlayItem refers to, the video stream, zero or more audio streams played back in synchronization therewith, zero or more PG streams, and zero or more IG streams are multiplexed.

In addition, one SubPlayItem refers to the video stream, the audio stream, or the PG stream different from the Clip AV stream that the PlayItem refers to.

The management of the AV stream using the PlayList, PlayItem, and SubPlayItem is described in, for example, Japanese Unexamined Patent Application Publication No. 2008-252740 and Japanese Unexamined Patent Application Publication No. 2005-348314.

### Structure of Directory

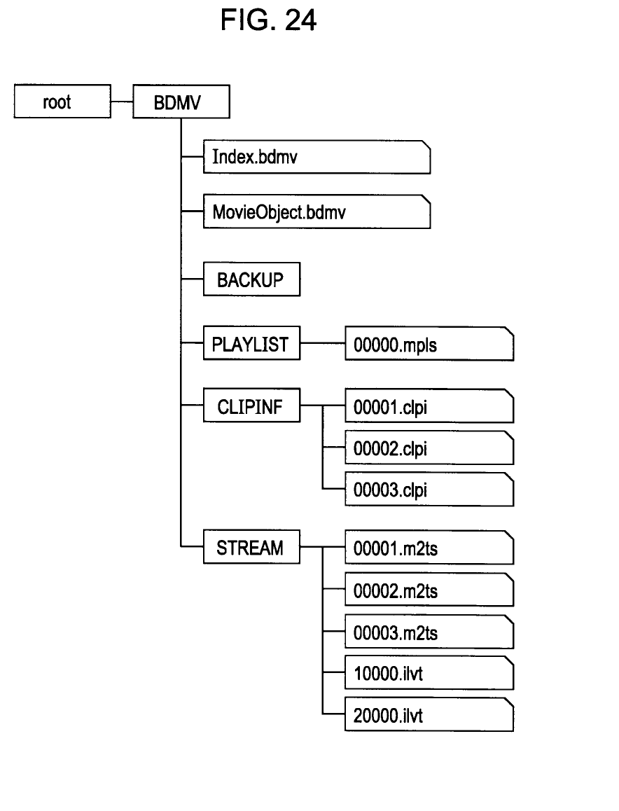

FIG. 24 is a diagram illustrating an example of the management structure for files recorded on the optical disc 202.

As shown in FIG. 24, files are managed hierarchically with the directory structure. One root directory is created on the optical disc 202. The lower part of the root directory is a range to be managed with one recording and playback system.

A BDMV directory is set below the root directory.

An index file, which is a file named as “Index.bdmv”, and a MovieObject file, which is a file named as “MovieObject.bdmv” are accommodated just below the BDMV directory.

A BACKUP directory, a PLAYLIST directory, a CLIPINF directory, and a STREAM directory are provided below the BDMV directory.

PlayList files which are files describing a PlayList are accommodated in the PLAYLIST directory. In each of PlayList files, a name made by combining a 5-digit number and an extension “.mpls” is set. In one PlayList file shown in FIG. 24, a file name of “00000.mpls” is set.

Clip Information files are accommodated in the CLIPINF directory. In each of the Clip Information files, a name made by combining a 5-digit number and an extension “.clpi” is set.

In three Clip Information files of FIG. 24, file names of “00001.clpi”, “00002.clpi”, and “00003.clpi” are set. Hereinafter, a Clip Information file is appropriately referred to as a clpi file.

For example, a clip file of “00001.clpi” is a file describing information on the Clip of Base view video.

The clpi file of “00002.clpi” is a file describing information on the Clip of D2 view video.

The clpi file of “00003.clpi” is a file describing information on the Clip of D1 view video.

Stream files are accommodated in the STREAM directory. In each of the stream files, a name made by combining a 5-digit number and an extension of “.m2ts” or a name made by combining a 5-digit number and an extension of “.ilvt” is set. Hereinafter, a file set with the extension of “.m2ts” is appropriately referred to as an m2ts file. In addition, a file set with the extension of “.ilvt” is referred to as an ilvt file.

The m2ts file of “00001.m2ts” is a file for 2D playback, and by designating the file, reading of a Base view video stream is performed.

The m2ts file of “00002.m2ts” is a file of the D2 view video stream, and the m2ts file of “00003.m2ts” is a file of the D1 view video stream.

The ilvt file of “10000.ivt” is a file for B-D1 playback, and by designating the file, reading of the Base view video stream and the D1 view video stream is performed. The ilvt file for the B-D1 playback corresponds to the 3D type 1 playback file described above.

The ilvt file of “20000.ivt” is a file for B-D2 playback, and by designating the file, reading of the Base view video stream and the D2 view video stream is performed. The ilvt file for the B-D2 playback corresponds to the 3D type 2 playback file described above.

In addition to the directories shown in FIG. 24, directories accommodating files of audio streams are provided below the BDMV directory.

### Syntax of Each Data

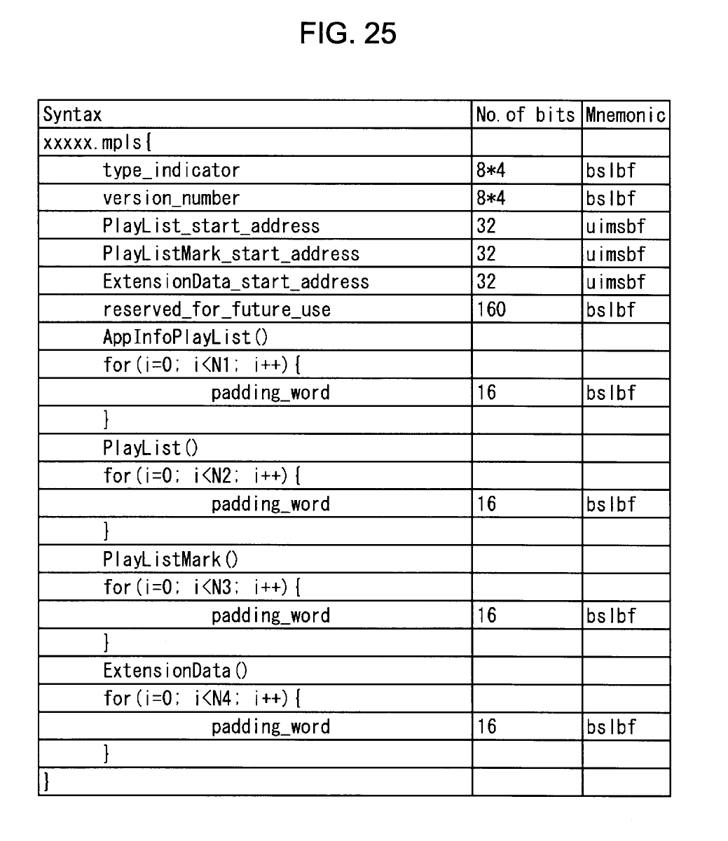

FIG. 25 is a diagram illustrating the syntax of a PlayList file.

The PlayList file is a file set with the extension of “.mpls” accommodated in the PLAYLIST directory of FIG. 24.

The type indicator in FIG. 25 indicates a kind of a file named “xxxxx.mpls”.

The version_number indicates a version number of “xxxx.mpls”. The version_number includes a 4-digit number. For example, a PlayList file for 3D playback is set with “0240” indicating “3D Spec version”. The PlayList described in the PlayList file set with “0240” is 3D_PlayList to be described later.

The PlayList_start_address indicates a base address of PlayList( ) with a unit of the number of relative bytes from the leading byte of the PlayList file.

The PlayListMark_start_address indicates a base address of PlayListMark( ) with a unit of the number of relative bytes from the leading byte of the PlayList file.

The ExtensionData_start_address indicates a base address of ExtensionData( ) with a unit of the number of relative bytes from the leading byte of the PlayList file.

Below the ExtensionData_start_address, 160-bit reserved_for_future_use is included.

In the AppInfoPlayList( ) a parameter relating to playback control of the PlayList, such as playback limit or the like, is accommodated.

In the PlayList( ), a parameter relating to Main Path, Sub Path or the like is accommodated. The contents of the PlayList( ) will be described later.

In the PlayListMark( ), information is accommodated which is mark information of the PlayList, in other words, information about a mark, which is a jumping destination (jump point) in a user operation or command instructing chapter jump or the like.

The ExtensionData( ) is configured such that private data can be inserted thereinto.

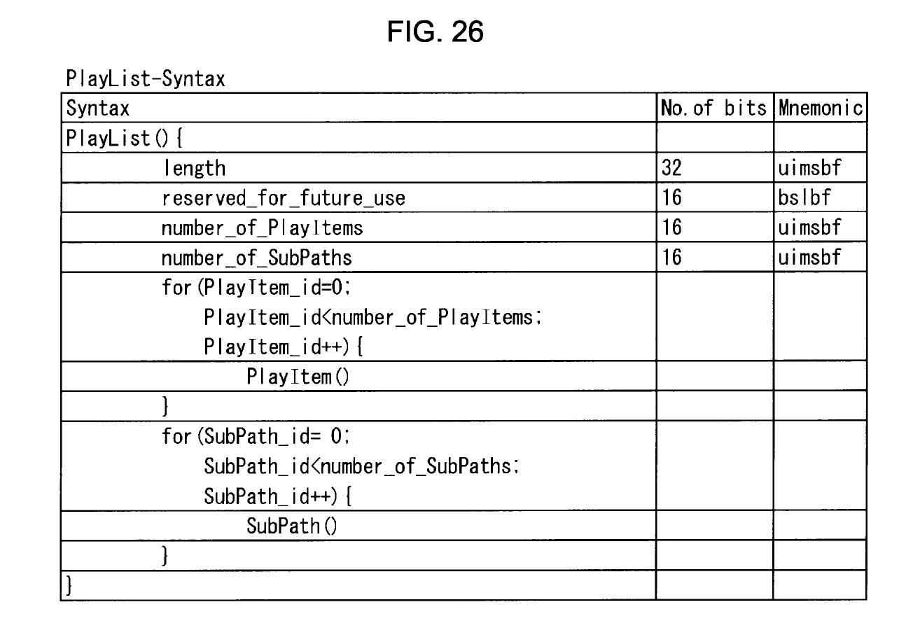

FIG. 26 is a diagram illustrating the syntax of the PlayList( ) of FIG. 25.

The length is a 32-bit unsigned integer indicating the number of bytes from that immediately following the length field to the end of the PlayList( ), In other words, the length indicates the number of bytes from the reserved_for_future_use to the final end of the PlayList.

Below the length, 16-bit reserved_for_future_use is prepared.

The number_of_PlayItems is a 16-bit field indicating the number of PlayItems in the PlayList. In case of the example in FIG. 23, the number of PlayItems is three. The value of PlayItem_id is allocated from 0 in the order in which PlayItem( ) appears in the PlayList. For example, PlayItem_id=0, 1, and 2 are allocated in FIG. 23.

The number_of_SubPaths is a 16-bit field indicating the number of Sub Paths in the PlayList. In case of the example in FIG. 23, the number of Sub Paths is three. The value of SubPath_id is allocated from 0 in the order in which SubPath( ) appears in the PlayList. For example, Subpath_id=0, 1, and 2 are allocated in FIG. 23. In the for statement thereafter, the PlayItem( ) is referred to as many as the number of PlayItems and the SubPath( ) is referred to as many as the number of Sub Paths.

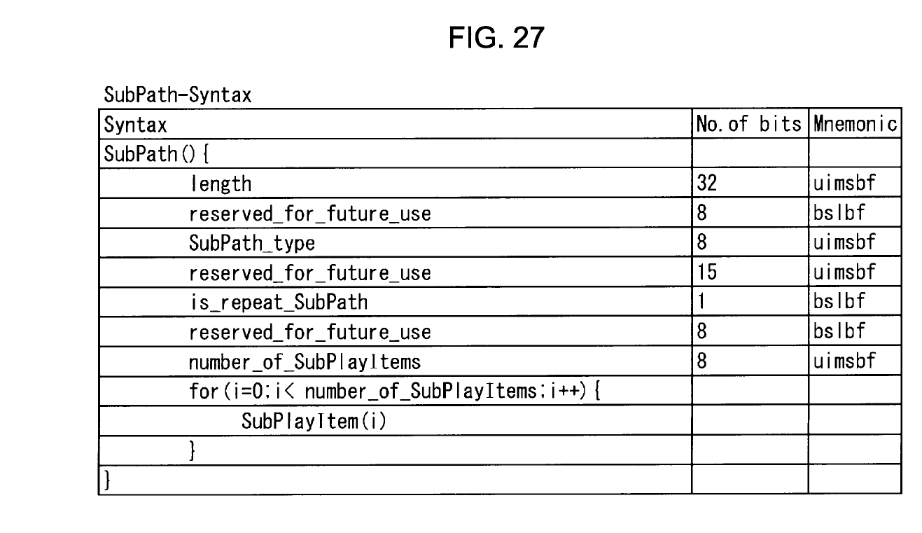

FIG. 27 is a diagram illustrating the syntax of the SubPath( ) in FIG. 26.

The length is a 32-bit unsigned integer indicating the number of bytes from the immediate next of the length field to the final end of the SubPath( ). In other words, the length indicates the number of bytes from reserved_for_future_use to the final end of the PlayList.

Below the length, 16-bit reserved_for_future_use is prepared.

The SubPath_type is an 8-bit field indicating the kind of application of the Sub Path. The SubPath_type is used, for example, for indicating the type such as whether the Sub Path is audio, bitmap subtitles or text subtitles.

Below the SubPath_type, 15-bit reserved_for_future_use is prepared.

The is_repeat_SubPath is a 1-bit field for designating the playback method of the Sub Path, and indicates whether the playback of the Sub Path is to be repeated between the playback of the Main Path or the playback of the Sub Path is to be performed once. For example, the is_repeat_SubPath is used when playback timings are different for the Clip that the Main Path refers to and the Clip that the Sub Path refers to (when the Main Path is used as a path of a slide show for still images and the Sub Path is used as a path for audio for BGM, or the like).

Below the Is_repeat_SubPath, 8-bit reserved_for_future_use is prepared.

The number_of_SubPlayItems is an 8-bit field indicating the number of (entry number of) SubPlayItems in one Sub Path. For example, the number_of_SubPlayItems of the SubPlayItem of SubPath_id=0 in FIG. 23 is 1, and the number_of_SubPlayItems of SubPlayItem of SubPath_id=1 is 2. In the for statement thereafter, the SubPlayItem( ) is referred to as many as the number of SubPlayItems.

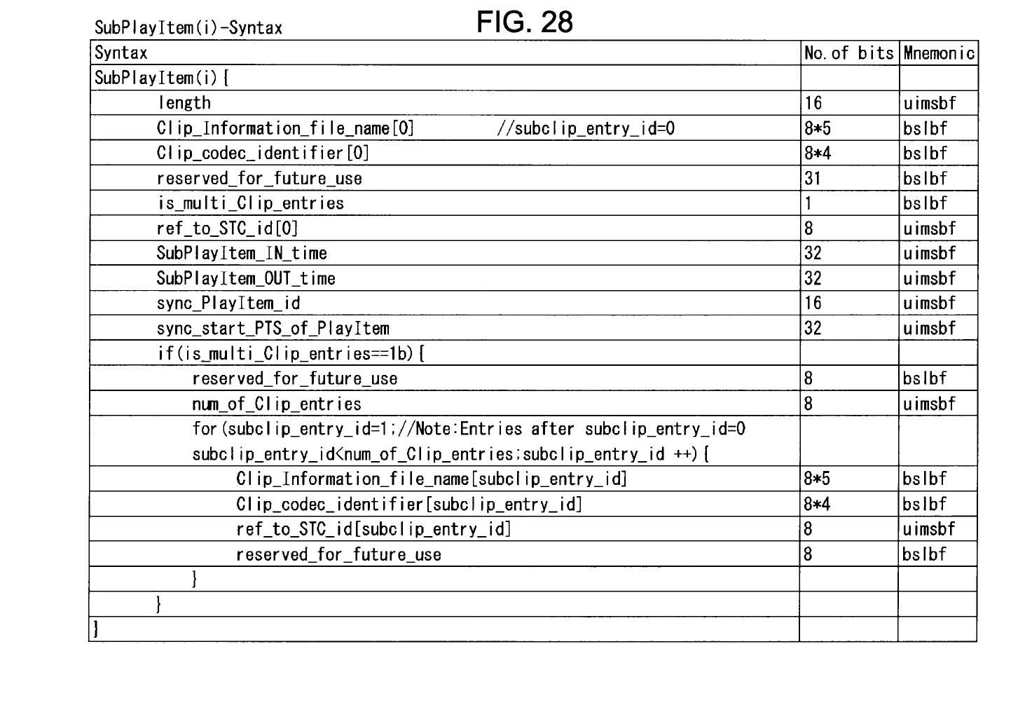

FIG. 28 is a diagram illustrating the syntax of the SubPlayItem(i) in FIG. 27.

The length is a 16-bit unsigned integer indicating the number of bytes from that immediately following the length field to the end of the SubPlayItem( ).

The SubPlayItem(i) in FIG. 28 is described with being divided into a case where the SubPlayItem refers to one Clip and a case where the SubPlayItem refers to a plurality of Clips.

The case where the SubPlayItem refers to one Clip will be described.

The Clip_Information_file_name[0] indicates a name of the Clip Information file of the Clip that the SubPlayItem refers to.

The Clip_codec_identifier[0] indicates a codec mode of the Clip. Below the Clip_codec_identifier[0], reserved_for_future_use is included.

The is_multi_Clip_entries is a flag indicating the existence of registration of a multi Clip. When the flag of the is_multi_Clip_entries is set, the syntax for a case when the SubPlayItem refers to a plurality of Clips is referred to.

The ref_to_STC_id[0] is information relating to an STC discontinuous point (a discontinuous point of a system time base).

The SubPlayItem_IN_time indicates a starting position of the playback zone of the Sub Path, and the SubPlayItem_OUT_time indicates an ending position thereof.

The sync_PlayItem_id and the sync_start_PTS_of_PlayItem indicate a time when the playback of the Sub Path is started on the time axis of the Main Path.

The SubPlayItem_IN_time, SubPlayItem_OUT_time, sync_PlayItem_id, and sync_start_PTS_of_PlayItem are used together in the Clip that the SubPlayItem refers to.

A case will be described where “if(is_multi_Clip_entries==1b)” and the SubPlayItem refers to a plurality of Clips.

The num_of_Clip_entries indicates the number of Clips to be referred to. The number of Clip_Information_file_name[SubClip_entry_id] designates the number of Clips excluding the Clip_Information_file_name[0].

The Clip_codec_identifier[SubClip_entry_id] indicates a codec mode of the Clip.

The ref_to_STC_id[SubClip_entry_id] is information on an STC discontinuous point (a discontinuous point of a system time base). Below the ref_to_STC_id[SubClip_entry_id], the reserved_for_future_use is included.

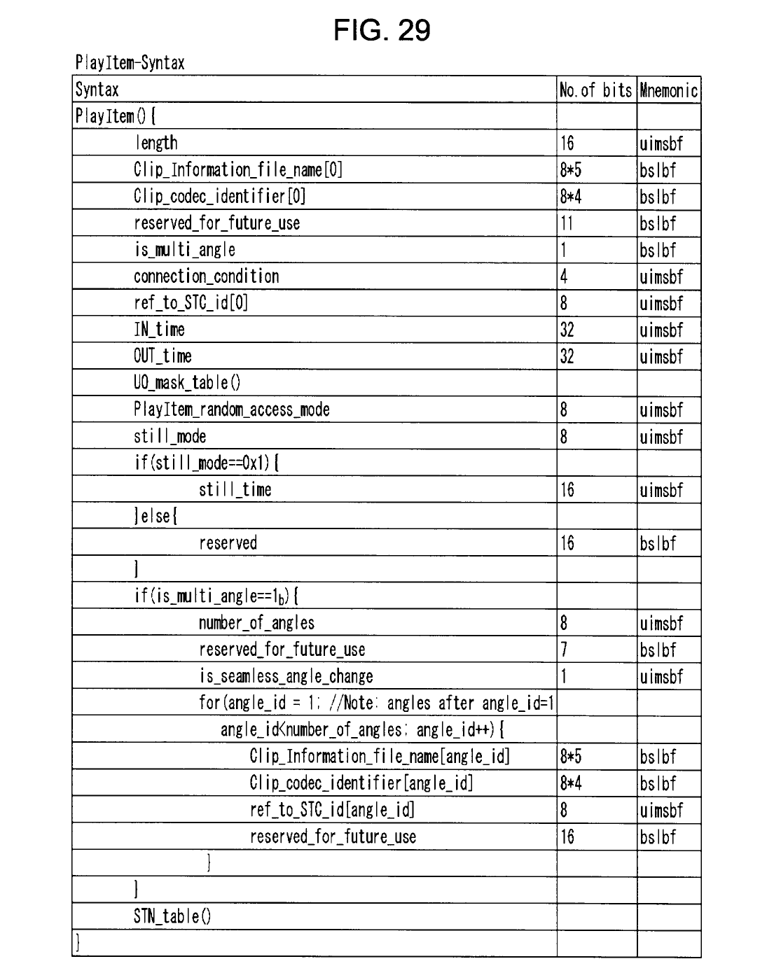

FIG. 29 is a diagram illustrating the syntax of the PlayItem( ) of FIG. 26.

The length is a 16-bit unsigned integer indicating the number of bytes from that immediately following the length field to the end of the PlayItem( ).

The Clip_Information_file_name[0] indicates the name of a Clip Information file of the Clip that the PlayItem refers to. Furthermore, the file name of an mt2s file including the Clip, and the file name of a Clip Information file corresponding thereto includes the same 5-digit number.

The Clip_codec_identifier[0] indicates a codec mode of the Clip. Below the Clip_codec_identifier[0], reserved_for_future_use is included. Below the reserved_for_future_use, is_multi_angle, and connection_condition are included.

The ref_to_STC_id[0] is information on an STC discontinuous point (a discontinuous point of a system time base).

The IN_time indicates a starting point of the playback zone of the PlayItem, and the OUT_time indicates the ending point thereof.

Below the OUT_time, UO_mask_table( ), PlayItem_random_access_mode, and still_mode are included.

In the STN_table( ), the information of AV stream that a target PlayItem refers to is included. In addition, when there is Sub Path to be played back in association with the target PlayItem, the information of AV stream that SubPlayItem forming the Sub Path refers to is also included.

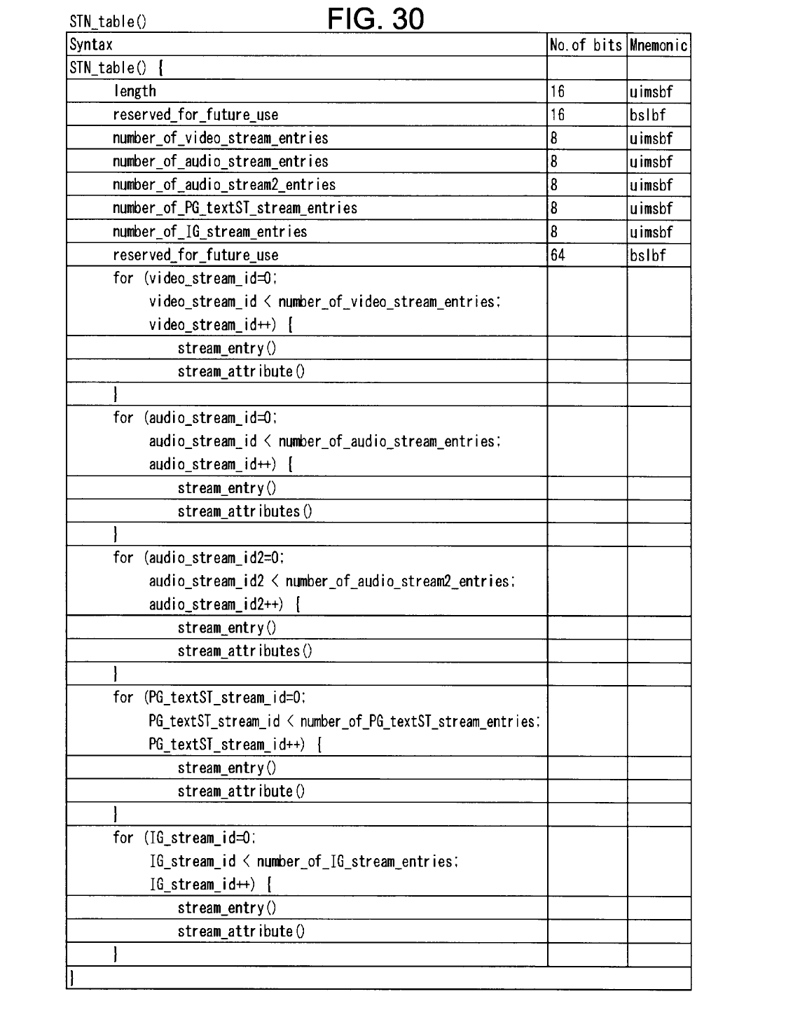

FIG. 30 is a diagram illustrating the syntax of the STN_table( ) of FIG. 29.

The STN_table( ) is set as an attribute of the PlayItem.

The length is a 16-bit unsigned integer indicating the number of bytes from that immediately following the length field to the end of the STN_table( ). Below the length, 16-bit reserved_for_future_use is prepared.

The number_of_video_stream_entries indicates the number of streams that is given with the video_stream_id and gains an entry (registered) in the STN_table( ).

The video_stream_id is information for identifying a video stream. For example, the Base view video stream is specified by video_stream_id.

The ID of the Dependent view video stream may be defined in the STN_table( ), and may be acquired by calculating such as addition of a predetermined value to the ID of the Base view video stream.

The video_stream_number is a video stream number shown to a user that is used for video switching.

The number_of_audio_stream_entries indicates the number of streams of a first audio stream that is given to audio_stream_id and gains an entry in the STN_table( ). The audio_stream_id is information for identifying an audio stream, and the audio_stream_number is an audio stream number shown to a user that is used for audio switching.

The number_of_audio_stream2_entries indicates the number of streams of a second audio stream that is given to audio_stream_id2 and gains an entry in the STN_table( ). The audio_stream_id2 is information for identifying an audio stream, and the audio_stream_number is an audio stream number shown to a user that is used for audio switching. In this example, it is possible to switch audio to be played back.

The number_of_PG_txtST_stream_entries indicates the number of streams that is given to PG_txtST_stream_id and gains an entry in the STN_table( ). Among these, the PG stream obtained by subjecting the bitmap subtitles to run-length encoding and a text subtitle file (txtST) gain entries. The PG_txtST_stream_id is information for identifying a subtitle stream and the PG_txtST_stream_number is a subtitle stream number shown to a user that is used for subtitle switching.

The number_of_IG_stream_entries indicates the number of streams that is given to IG_stream_id and gains an entry in the STN_table( ). Among these, an IG stream gains an entry. The IG_stream_id is information for identifying the IG stream, and the IG_stream_number is a graphic stream number shown to a user that is used in graphic switching.

The IDs of Main TS and Sub TS are also registered in the STN_table( ). The fact that the IDs are not elementary stream but IDs of TS is described in the stream_attribute( ).

### Specific Example of PlayList

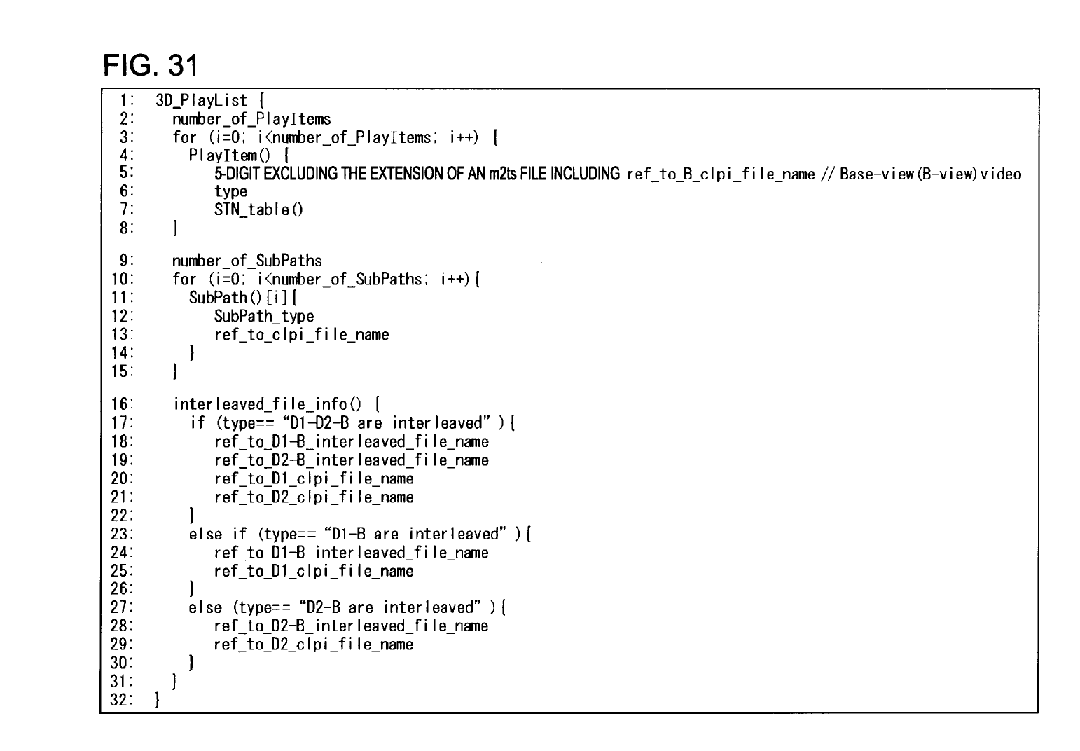

FIG. 31 is a diagram illustrating a specific example of 3D_PlayList which is PlayList for 3D playback.

For convenience of explanation, the left side of FIG. 31 shows numbers indicating the number of rows and “:”. The numbers and the “:” do not form the 3D_PlayList.

The number_of_PlayItems in the second row corresponds to the number_of_PlayItems of FIG. 26, and indicates the number of PlayItems in the 3D_PlayList. From the second row to the eighth row describes PlayItems. In other words, from the third row to the eighth row correspond to the description of the PlayItem using the for statement of FIG. 26.

The ref_to_B_clpi_file_name in the fifth row corresponds to the Clip_Information_file_name[0] of FIG. 29, and indicates the five-digit number excluding the extension “.m2ts” from the file name of an m2ts file accommodating the Base view video stream. With the description an m2ts to be referred to and a clpi file of a Clip of the Base view video are specified.

The type in the sixth row indicates a type of arrangement of the Base view video and data of D1/D2 view video in association therewith on the optical disc 202. The type is set, for example by using the reserved_for_future_use that continues to the Clip_codec_identifier[0] of FIG. 29.

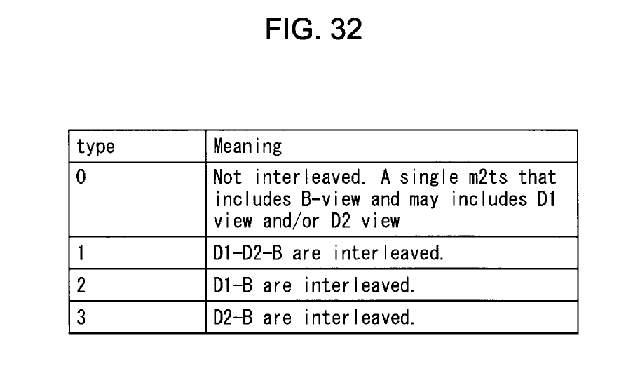

FIG. 32 is a diagram illustrating the meanings of types.

The fact that the value of a type is 0 indicates that the Base view video, the D1 view video, and the D2 view video are not interleaved.

In this case, both or any one of packets of the existing D1/D2 view videos are or is multiplexed to one MPEG2-TS together with a packet of the Base view video.

The fact that the value of a type is 1 indicates that all of the Base view video, D1 view video, and D2 view video are interleaved.

In this case, three TSs of the first TS including the Base view video, the second TS including the D1 view video, and the third TS including the D2 view video are interleaved on the optical disc 202 in an Extent unit.

The fact that the value of a type is 2 indicates that the Base view video and the D1 view video are interleaved.

In this case, two TSs of the first TS including a packet of the Base view video, and the second TS including a packet of the D1 view video are interleaved on the optical disc 202 in an Extent unit. The first TS may have a packet of the D2 view video multiplexed therein. In addition, the second TS may have a packet of the D2 view video multiplexed therein.

The fact that the value of a type is 3 indicates that the Base view video and the D2 view video are interleaved.

In this case, two TSs of the first TS including a packet of the Base view video, and the second TS including a packet of the D2 view video are interleaved on the optical disc 202 in an Extent unit. The first TS may have a packet of the D1 view video multiplexed therein. In addition, the second TS may have a packet of the D1 view video multiplexed therein.

To return to the description of FIG. 31, the STN_table in the seventh row corresponds to the STN_table( ) of FIG. 29. As described with reference to FIG. 30, the STN_table has a description of the ID of each stream to be referred to in the 3D_PlayList.

The number_of_SubPaths in the ninth row corresponds to the number_of_SubPaths of FIG. 26, and indicates the number of SubPaths in the 3D_PlayList. From the ninth row to the fourteenth row describes the SubPath. In other words, from the tenth row to the fourteenth row corresponds to the description of the SubPath using the for statement of FIG. 26.

The SubPath_type in the twelfth row corresponds to the SubPath_type of FIG. 27 and indicates the kind of the SubPath.

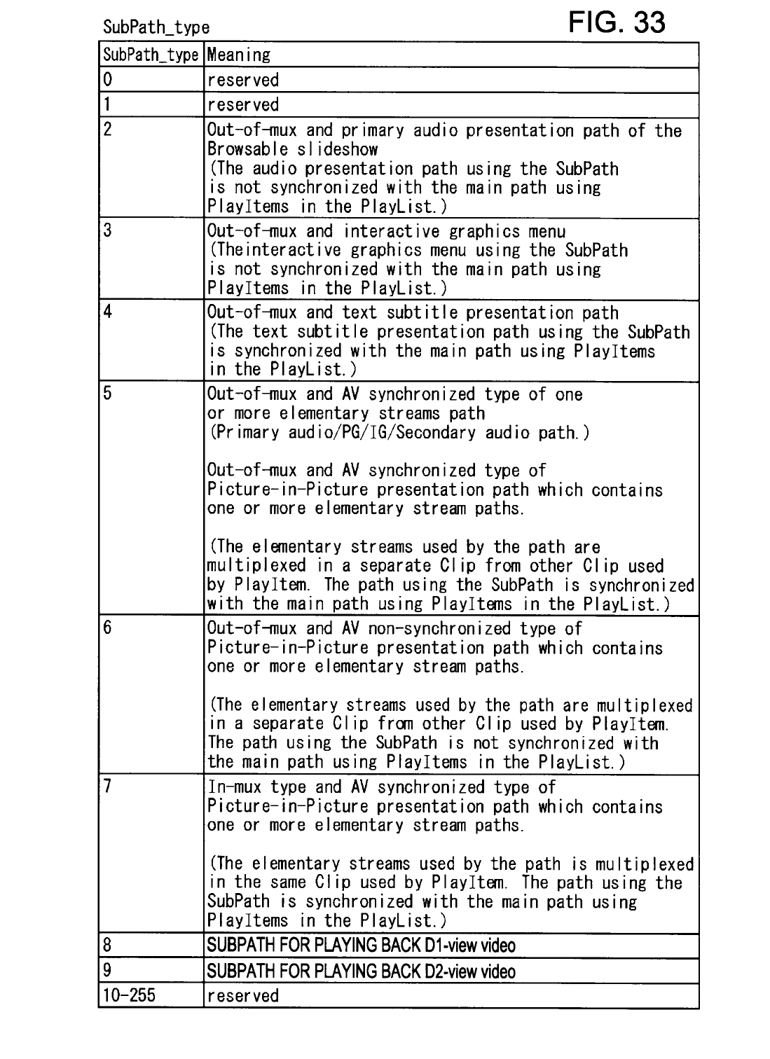

FIG. 33 is a diagram illustrating the meanings of the SubPath_type.

As a description for important facts among each value shown in FIG. 33, the fact that the value of a SubPath_type is 8 indicates that it is a SubPath to play back the D1 view video.

In addition, the fact that the value of a SubPath_type is 9 indicates that it is a SubPath to play back the D2 view video.

The ref_to_clpi_file_name in the thirteenth row of FIG. 31 corresponds to the Clip_Information_file_name[0] of FIG. 28.

When the SubPath is to be used for playing back the D1 view video, the ref_to_clpi_file_name indicates a 5-digit number excluding the extension “.m2ts” from the file name of an m2ts file accommodating the D1 view video. With the description, a clpi file to be referred to is specified.

On the other hand, the ref_to_clpi_file_name in the thirteenth row indicates a 5-digit number excluding the extension “.m2ts” from the file name of an m2ts file accommodating the D2 view video, when the SubPath is to be used for playing back the D2 view video.

From the sixteenth row to the thirtieth row are descriptions of interleaved_file_info( ), that is, ilvt files. For example, using the reserved_for_future_use in the PlayItem( ), and the SubPath( ), descriptions of ilvt files are prepared.

From the seventeenth row to the twenty-second row are descriptions to be referred to when the value of the type in the sixth row is 1, and all of the Base view video, D1 view video, and D2 view video are interleaved.

The ref_to_D1-B_interleaved_file_name in the eighteenth row indicates a 5-digit number excluding the extension “.ilvt” from the file name of an ilvt file for the Base view video and D1 view video playback.

The ref_to_D2-B_interleaved_file_name in the nineteenth row indicates a 5-digit number excluding the extension “.ilvt” from the file name of an ilvt file for the Base view video and D2 view video playback.

The ref_to_D1_clpi_file_name in the twentieth row indicates a 5-digit number excluding the extension “.m2ts” from the file name of an m2ts file accommodating the D1 view video. With the description, a clpi file to be referred to during playback of the m2ts file of the D1 view video is specified.

The ref_to_D2_clpi_file_name in the twenty-first row indicates a 5-digit number excluding the extension “.m2ts” from the file name of an m2ts file accommodating the D2 view video. With the description, a clpi file to be referred to during playback of the m2ts file of the D2 view video is specified.

From twenty-third row to the twenty-sixth row are descriptions to be referred to when the value of the type in the sixth row is 2 and the Base view video and D1 view video are interleaved.

The ref_to_D1-B_interleaved_file_name in the twenty-fourth row indicates a 5-digit number excluding the extension “.ilvt” from the file name of an ilvt file for the Base view video and D1 view video playback.

The ref_to_D1_clpi_file_name in the twenty-fifth row indicates a 5-digit number excluding the extension “.m2ts” from the file name of an m2ts file accommodating the D1 view video. With the description, a clpi file to be referred to during playback of the m2ts file of the D1 view video is specified.

From the twenty-seventh row to the thirtieth row are descriptions to be referred to when the value of the type in the sixth row is 3 and the Base view video and D2 view video are interleaved.

The ref_to_D2-B_interleaved_file_name in the twenty-eighth row indicates a 5-digit number excluding the extension “.ilvt” from the file name of an ilvt file for the Base view video and D2 view video playback.

The ref_to_D2_clpi_file_name in the twenty-ninth row indicates a 5-digit number excluding the extension “.m2ts” from the file name of an m2ts file accommodating the D2 view video. With the description, a clpi file to be referred to during playback of the m2ts file of the D2 view video is specified.

As such, in the 3D_PlayList, when data is interleaved on the optical disc 202, information that can specify the file name of a clpi file corresponding to the Clip AV stream is described for the D1 view video and, the D2 view video.

### Example of Composition of Playback Device 201

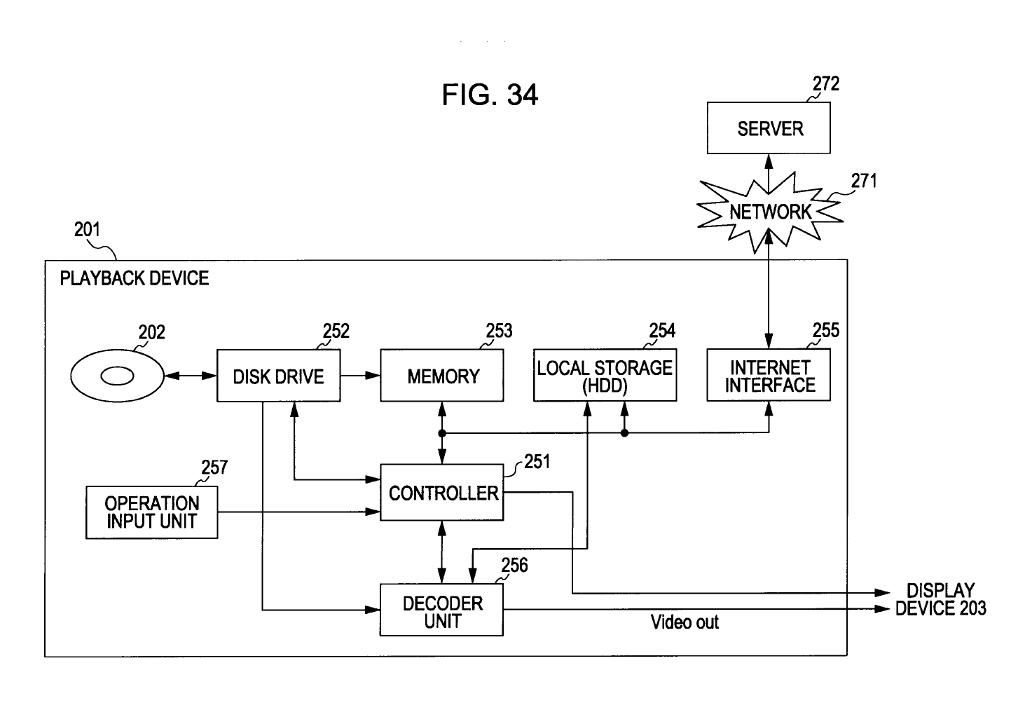

FIG. 34 is a block diagram illustrating an example of a composition of a playback device 201.

A controller 251 executes a control program prepared in advance, and controls the operation of the entire playback device 201.

For example, the controller 251 controls a disk drive 252, and reads a PlayList file for 3D playback. In addition, the controller 251 reads Main TS and Sub TS based on the ID registered in the STN_table and supplies to a decoder unit 256.

The disk drive 252 reads data from the optical disc 202 according to the control of the controller 251 and outputs the read data to the controller 251, a memory 253, or the decoder unit 256.

The memory 253 appropriately stores data or the like necessary for the controller 251 to execute various processes.

A local storage 254 includes, for example, a hard disk drive (HDD). The local storage 254 has D1/D2 view video streams, or the like downloaded from a server 272 recorded therein. The streams recorded in the local storage 254 are appropriately supplied to the decoder unit 256.

An Internet interface 255 performs communication with the server 272 via a network 271 according to the control of the controller 251, and supplies data downloaded from the server 272 to the local storage 254.

Data obtained by updating the data recorded on the optical disc 202 is downloaded from the server 272. With the combined use of the downloaded D1/D2 view video streams and the Base view video stream recorded on the optical disc 202, it is possible to realize 3D playback of content different from that in the optical disc 202. When the D1/D2 view video streams are downloaded, the content of the PlayList is appropriately updated.

The decoder unit 256 decodes a stream supplied from the disk drive 252 or the local storage 254, and outputs an obtained video signal to the display device 203. An audio signal is also output to the display device 203 via a predetermined path.

An operation input unit 257 includes input devices such as a button, a key, a touch panel, a jog dial, a mouse and the like and receiving units that receive signals such as an infrared ray transmitted from a predetermined remote commander. The operation input unit 257 detects the operation of a user and supplies signals indicating the content of the detected operation to the controller 251.

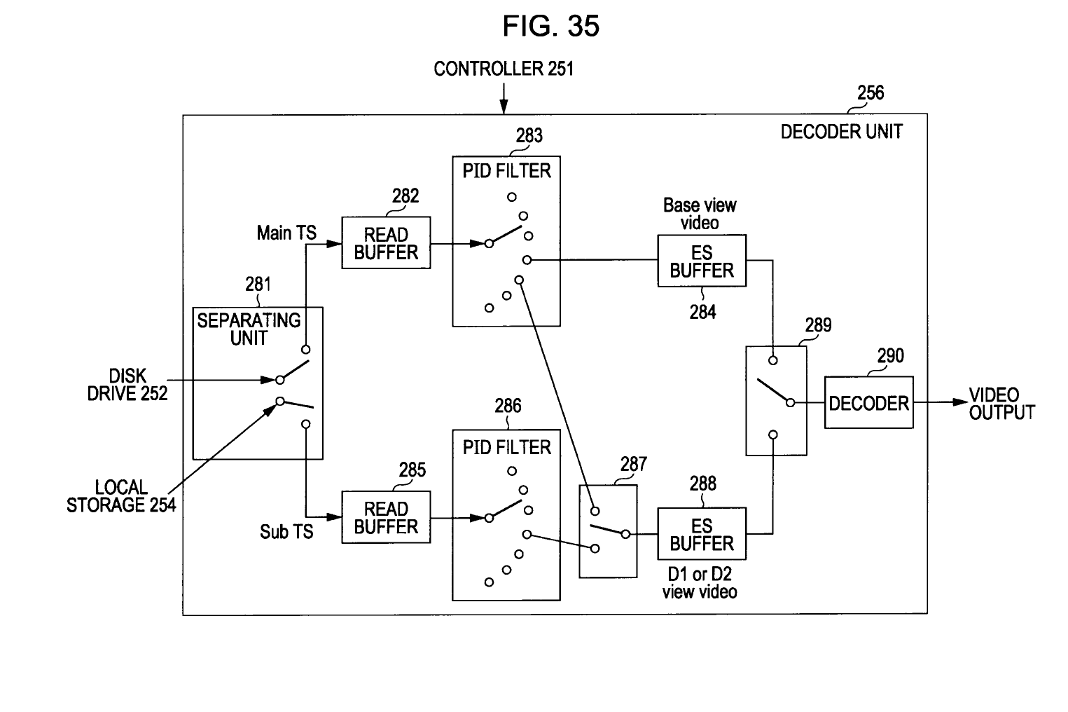

FIG. 35 is a diagram illustrating an example of the composition of the decoder unit 256.

A separating unit 281 separates data supplied from the disk drive 252 to data of packets forming the Main TS and packets forming the Sub TS according to the control by the controller 251. For example, TS read from the optical disc 202 based on the stream ID described in the STN_table( ) of the 3D PlayList file is supplied to the separating unit 281.

The separating unit 281 outputs the packets forming the separated Main TS to a read buffer 282 to store them, and outputs the packets forming the Sub TS to a read buffer 285 to store them.

In addition, the separating unit 281 outputs the packets forming the Sub TS supplied from the local storage 254 to the read buffer 285 to store them.

As described above, there is a case where the D1/D2 view videos downloaded from the server 272 are stored in the local storage 254. When the videos are instructed to be played back with the Base view video recorded on the optical disc 202, the D1/D2 view video streams as the Sub TS are read from the local storage 254 and supplied to the separating unit 281.

The PID filter 283 sorts the packets forming the Main TS stored in the read buffer 282 based on a PID set for each packet. The controller 251 designates a PID of the packet forming the Base view video, a PID of the packet forming the D1 view video, and a PID of the packet forming the D2 view video.

The PID filter 283 reads the packet of the Base view video included in the Main TS to the read buffer 282 and outputs to an ES buffer 284 to store. The ES buffer 284 stores elementary streams (ES) formed by the packet of the Base view video.

In addition, the PID filter 283 extracts the packets based on the PID and outputs to a switch 287 when the packets of the D1/D2 view videos in the Main TS are multiplexed.

A PID filter 286 reads the packets of the D1/D2 view videos included in the Sub TS from the read buffer 285 and outputs to the switch 287.

Furthermore, only the process of the video streams of the Base view video, and the D1/D2 view videos are described herein, but as described with reference to FIG. 19, graphic data such as PG, IG, or the like may be multiplexed in the Main TS. In the same manner, as described with reference to FIG. 20, subtitle data or graphic data may be multiplexed in the Sub TS, in addition to the D1/D2 view videos.

The PID filter 283 and the PID filter 286 appropriately sort such data based on the PIDs, and outputs to a predetermined output destination. Terminals (circles) of the output destination shown in blocks of the PID filter 283 and the PID filter 286 of FIG. 35 are connected to an encoder or the like that encodes graphic data.

The switch 287 outputs the packets of the D1/D2 view videos supplied from the PID filter 283 to the ES buffer 288 to store them. In addition, the switch 287 outputs the packets of the D1/D2 view videos supplied from the PID filter 286 to the ES buffer 288 to store them. The ES buffer 288 stores ESs formed by the packets of the D1/D2 view videos.

A switch 289 outputs a packet to be a target of decoding to the decoder 290 among the packets of the Base view video stored in an ES buffer 284 and the packets of the D1/D2 view videos stored in the ES buffer 288. Time information such as a decoding time stamp (DTS) or the like is set in PES packets of the Base view video and the D1/D2 view video, and reading from a buffer is performed based on the time information.

A video decoder 290 decodes packets supplied from the switch 289 and outputs data of the Base view video or the D1/D2 view videos obtained by the decoding.

### 3D_PlayList Example 1

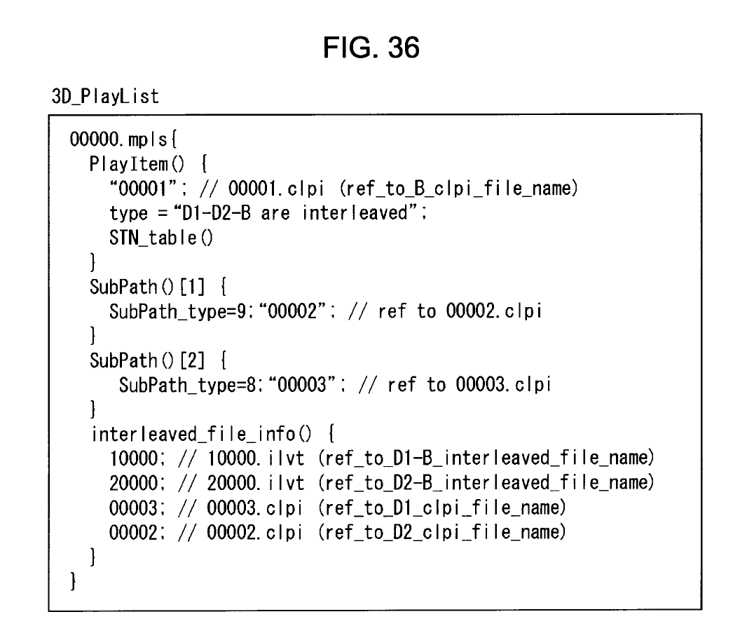

FIG. 36 is a diagram illustrating an example of the 3D_PlayList.

The 3D_PlayList described in the PlayList file of “0000.mpls” of FIG. 36 is a PlayList for managing the playback of the optical disc 202 where all of the Base view video, D1 view video, and D2 view video are interleaved. In other words, the value of a type is 1.

In the example of FIG. 36, the ref_to_B_clpi_file_name of PlayItem( ) is “00001”. From the description, when “00001.m2ts” that is an m2ts file of the Base view video is played back, it is specified that a clpi file of “00001.clpi” of FIG. 24 is referred to.

In addition, the SubPath_type of SubPath( )[1] is “9”. The fact that the SubPath_type is “9” indicates that the first SubPath is a SubPath for playing back the D2 view video.

The ref_to_clpi_file_name of the SubPath( )[1] is “00002”. Form the description, it is specified that a clpi file of “00002.clpi” of FIG. 24 is referred to when the D2 view video is played back.

The SubPath_type of the SubPath( )[2] is “8”. The fact that the SubPath_type is “8” indicates that the second SubPath is a SubPath for playing back the D1 view video.

The ref_to_clpi_file_name of the SubPath( )[2] is “00003”. From the description, it is specified that the clpi file of “00003.clpi” of FIG. 24 is referred to when the D1 view video is played back.

The ref_to_D1-B_interleaved_file_name of the interleaved_file_info( ) is “10000”. From the description, it is specified that the ilvt file of “10000.ilvt” of FIG. 24 is referred to when the playback of the D1-B is performed.

In addition, the ref_to_D2-B_interleaved_file_name is “20000”. From the description, it is specified that the ilvt file of the “20000.ilvt” of FIG. 24 is referred to when the playback of the D2-B is performed.

The ref_to_D1_clpi_file_name is “00003”. From the description, it is specified that the file of the “00003.clpi” of FIG. 24 is referred to when playback of the D1 view video is performed.

The ref_to_D2_clpi_file_name is “00002”. From the description, it is specified that the file of the “00002.clpi” of FIG. 24 is referred to when playback of the D2 view video is performed.

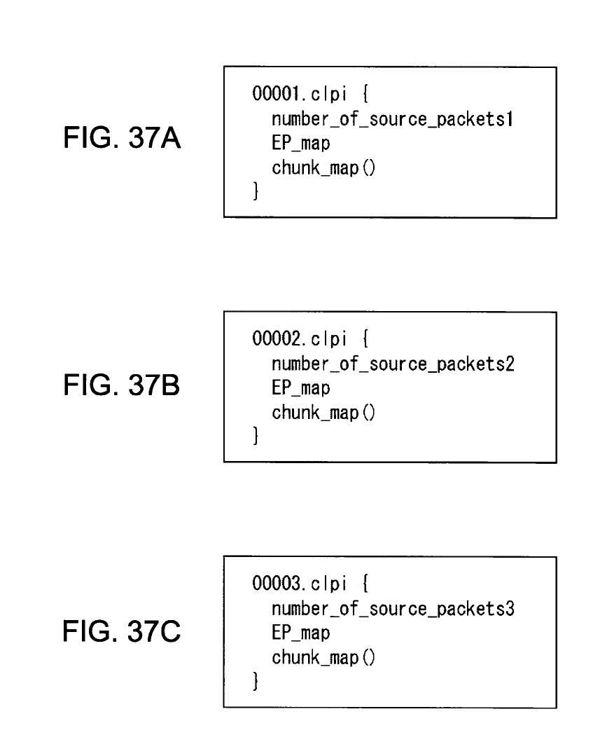

FIGS. 37A to 37C are diagrams illustrating the syntax of the clpi file to be used with the 3D_PlayList of FIG. 36.

FIG. 37A is a diagram illustrating an example of the clpi file of the “00001.clpi”. As described above, the clpi file of the “00001.clp”i is a file to be referred to when the “00001.m2ts” that is an m2ts file of the Base view video is played back.

The number_of_source_packets1 indicates the number of source packets included in the m2ts file of the “00001.m2ts”.

The EP_map indicates position information of an entry point (EP) in TS included in the m2ts file of the “00001.m2ts”.

The chunk_map( ) indicates a source packet number (SPN) representing a starting position of each chunk in the order from a head chunk for the TS included in the m2ts file of the “00001.m2ts”.

A chunk is a gathering of source packets that belong to one TS and are consecutively arranged on the optical disc 202. Here, that one chunk corresponds to one Extent arranged on the optical disc 202 will be described.

The chunk_map( ) indicates a length of each chunk. A specific example of the chunk_map( ) will be described later.

FIG. 37B is a diagram illustrating an example of the clpi file of the “00002.clpi”. The clpi file of the “00002.clpi” is a file to be referred to when the D2 view video is played back.

FIG. 37C is a diagram illustrating an example of the clpi file of the “00003.clpi”. The clpi file of the “00003.clpi” is a file to be referred to when the D1 view video is played back. The descriptions of the FIG. 37B and FIG. 37C are the same as that shown by FIG. 37A.

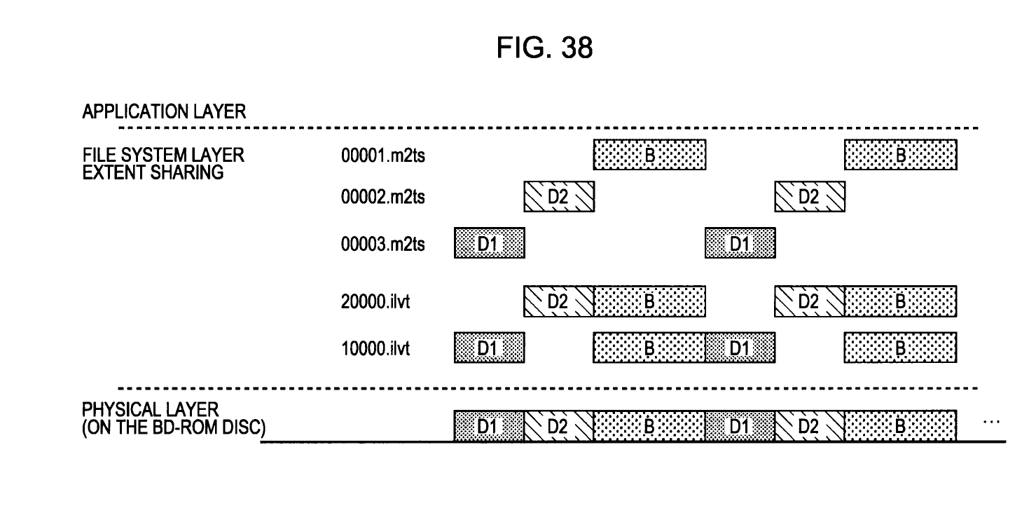

FIG. 38 is a diagram illustrating the concept of file management performed by using the data of FIG. 36 and FIGS. 37A to 37C.

As shown in FIG. 38, the file management is performed in the form of a three-layer structure including a physical layer, a file system layer, and an application layer. The 3D_PlayList of FIG. 36 and the clpi file of FIG. 36 become information of the application layer.

The physical layer is a layer of the optical disc 202 used for recording in a state where the Base view video, the D1 view video, and the D2 view video are all interleaved.

In the example of FIG. 38, the chunk of the D1 view video, the chunk of the D2 view video, and the chunk of the Base view video are arranged in that order. In FIG. 38, blocks written with the character “B” therein indicate the chunks of the Base view video, and blocks written with the character “D1” indicate the chunks of the D1 view video. Blocks written with the character “D2” indicate the chunks of the D2 view video.

As such, each Extent (chunk) of the Base view video, D1 view video, and D2 view video are in the interleaving arrangement on the optical disc 202. The interleaving arrangement stands for a periodical arrangement in which Extents of the same kind of streams are not adjacent to each other as described above.

In the file system layer, stream files that an application designates as a file name (m2ts file and ilvt file) corresponds to each chunk of the optical disc 202. The file system is a UDF file system, for example.

As shown in FIG. 38, the m2ts file of the “00001.m2ts” is formed with chunks of the Base view video arranged on the optical disc 202.

In addition, the m2ts file of the “00002.m2ts” is formed with chunks of the D2 view video arranged on the optical disc 202.

The m2ts file of the “00003.m2ts” is formed with chunks of the D1 view video arranged on the optical disc 202.

The file of the “20000.ilvt” is formed with the chunks of the D2 view video and the chunks of the Base view video arranged on the optical disc 202.

The file of “10000.ilvt” is formed with the chunks of the D1 view video and the chunks of the Base view video arranged on the optical disc 202.

When reading of data is instructed by designating the “00001.m2ts” from the application in order to perform the 2D playback, the chunks of the Base view video are read according to the management by the file system.

In addition, when reading of data is instructed by designating the “10000.ilvt” from the application in order to perform the B-D1 playback, the chunks of the Base view video and the chunks of the D1 view video are read according to the management by the file system.

When reading of data is instructed by designating the “20000.ilvt” from the application in order to perform the B-D2 playback, the chunks of the Base view video and the chunks of the D2 view video are read according to the management by the file system.

### Operation Example 1

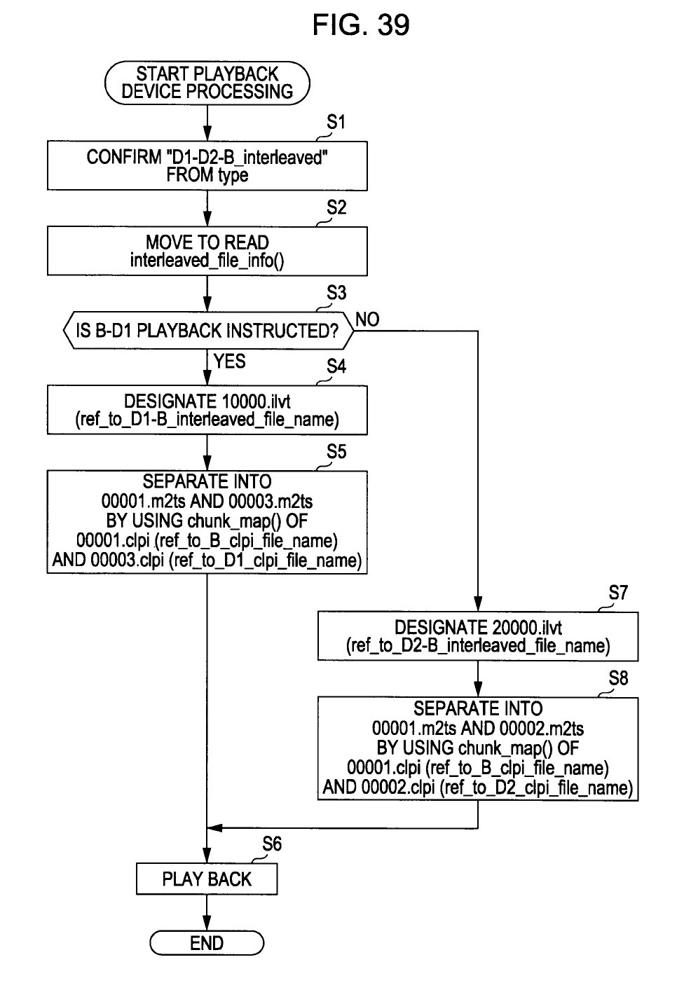

Herein, a playback process performed according to the 3D_PlayList file of FIG. 36 will be described with reference to the flowchart of FIG. 39.

In Step S1, the controller 251 confirms from the value of a type that all of the Base view video, D1 view video, and D2 view video are interleaved.

In this case, in Step S2, the controller 251 moves to read the interleaved_file_info( ).

In Step S3, the controller 251 determines whether the B-D1 playback is instructed or not, based on the operation of a user or the like.

When the B-D1 playback is instructed is determined in Step S3, in Step S4, the controller 251 designates the “10000.ilvt” (ref_to_D1-B_interleaved_file_name) described in the interleaved_file_info( ), and reads the chunks of the Base view video and the chunks of the D1 view video from the optical disc 202 through the UDF file system.

The chunks of the Base view video and the chunks of the D1 view video read by the disk drive 252 are supplied to the separating unit 281 of the decoder unit 256.

In Step S5, the separating unit 281 separates the supplied data to the data of the m2ts file of the “00001.m2ts” and the data of the m2ts file of “00003.m2ts” based on the chunk_map( ) of the “00001.clpi” (ref_to_B_clpi_file_name) and the chunk_map( ) of the “00003.clpi” (ref to D1_clpi_file_name) of FIGS. 37A to 37C. The separating unit 281 outputs data of the m2ts file of the “00001.m2ts” to the read buffer 282 and outputs data of the m2ts file of the “00003.m2ts” to the read buffer 285. The separation of data performed by using the chunk_map( ) will be described later.

The data of the m2ts file of the “00001.m2ts” stored in the read buffer 282 are supplied to the decoder 290 via the PID filter 283, the ES buffer 284, and the switch 289. The data of the m2ts file of “00003.m2ts” stored in the read buffer 285 are supplied to the decoder 290 via the PID filter 286, the switch 287, the ES buffer 288, and the switch 289.

In Step S6, the decoder 290 decodes (plays back) the packets supplied orderly from the switch 289.

On the other hand, in Step S3, when it is determined that the B-D1 playback is not instructed, in other words, the B-D2 playback is not instructed, in Step S7, the controller 251 designates the “20000.ilvt” (ref_to_D2-B_interleaved_file_name) described in the interleaved_file_info( ), and reads the chunks of the Base view video and the chunks of the D2 view video from the optical disc 202 through the UDF file system.

In Step S8, the separating unit 281 separates the supplied data to data of the m2ts file of the “00001.m2ts” and data of the m2ts file of the “00002.m2ts” based on the chunk_map( ) of the “00001.clpi” (ref_to_B_clpi_file_name) and the chunk_map( ) of the “00002.clpi” (ref_to_D2_clpi_file_name). The separating unit 281 outputs the m2ts file of the “00001.m2ts” to the read buffer 282 and outputs the m2ts file of the “00002.m2ts” to the read buffer 285.

Thereafter, the data of the m2ts file of the “00001.m2ts” and data of the m2ts file of the “00002.m2ts” are supplied to the decoder 290 in the same manner as the case of the B-D1 playback, and played back in Step S6.

Separation of Data using Chunk_map( ).

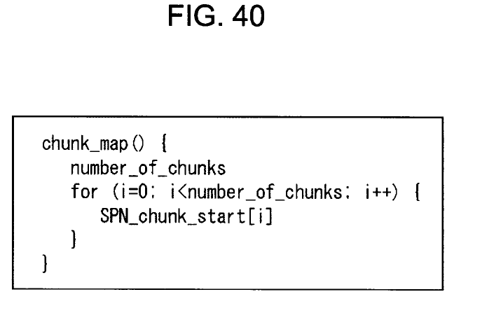

FIG. 40 is a diagram illustrating an example of the syntax of the chunk_map( ).

The number_of_chunks indicates the number of chunks to be referred to. Below the number_of_chunks, information of chunks as many as the number designated herein is described.

The SPN_chunk_start[i] indicates SPN (length) from a base position to the starting position of each chunk based on, for example, the starting position of the head chunk. The SPN to the starting point of each chunk is described orderly from that of the head chunk.

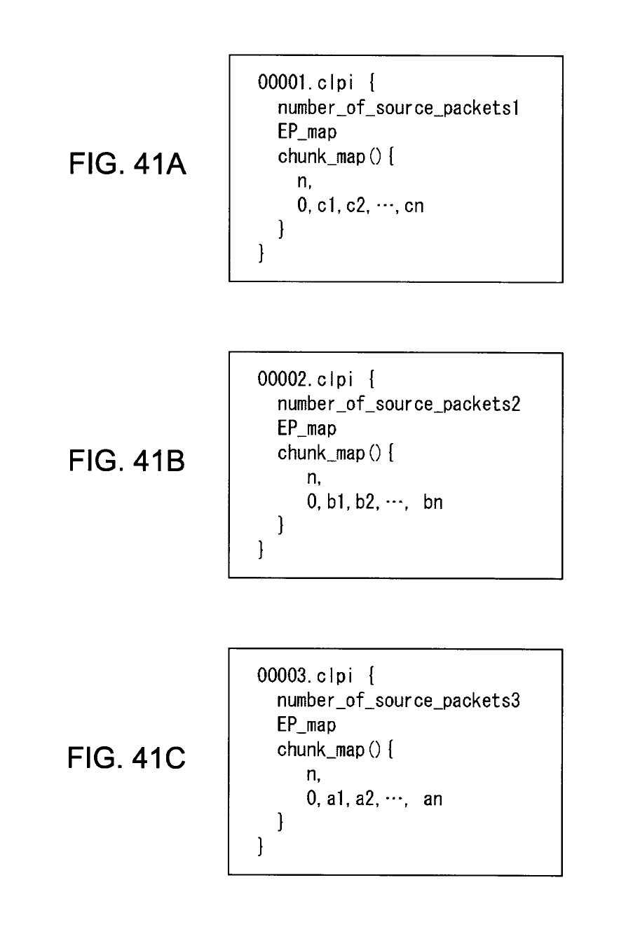

FIGS. 41A to 41C are diagrams illustrating specific examples of the chunk_map( ).

FIG. 41A is the chunk_map( ) described in the clpi file of the “00001.clpi” and the number_of_chunks is n.

In addition, the SPN_chunk_start[i] are 0, c1, c2, . . . and cn.

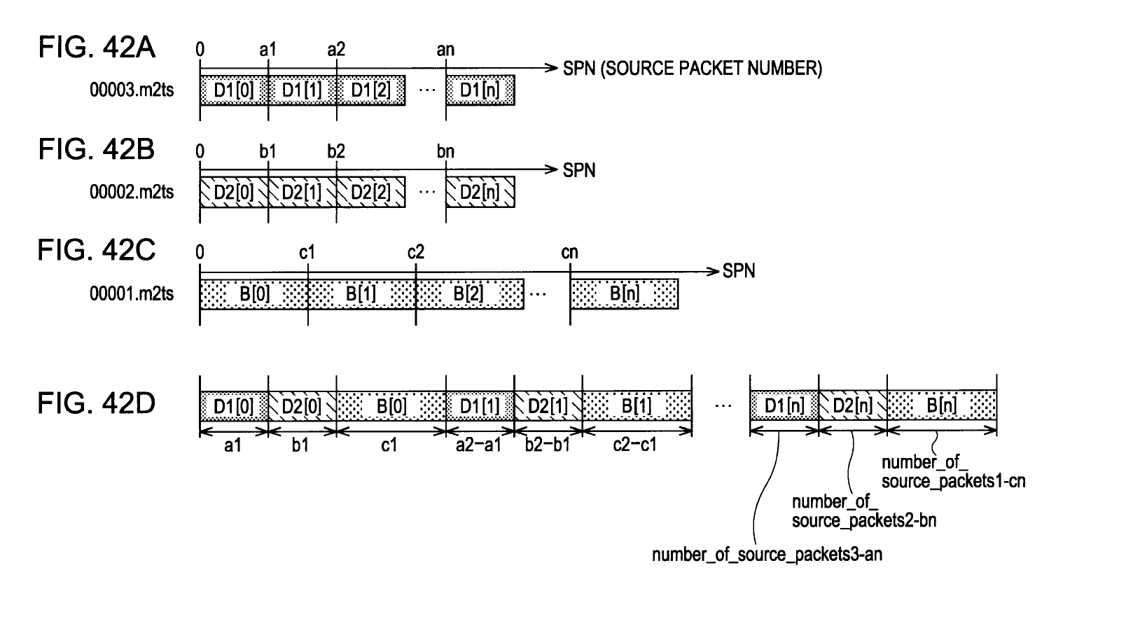

The first value of 0 indicates that the SPN from a base position to the starting position of the first chunk (B[0]) based on the starting position of the head chunk of the Base view video included in the m2ts file of the “00001.m2ts” is 0, as shown in FIG. 42C.

The second value of c1 indicates that the SPN from the base position to the starting position of the second chunk (B[1]) is c1.

The third value of the c2 indicates that the SPN from the base position to the starting position of the third chunk (B[2]) is c2.

The n+1-th value of cn indicates that the SPN from the base position to the starting position of the n+1-th chunk (B[n]) is cn.

FIG. 41B is the chunk_map( ) described in the clpi file of the “00002.clpi” and the number_of_chunks is n.

In addition, the SPN_chunk_start[i] is 0, b1, b2, . . . and bn.

The first value of 0 indicates that the SPN from a base position to the starting position of the first chunk (D2[0]) based on the starting position of the head chunk of the D2 view video included in the m2ts file of the “00002.m2ts” is 0, as shown in FIG. 42B.

The second value of b1 indicates that the SPN from the base position to the starting position of the second chunk (D2[1]) is b1.

The third value of the b2 indicates that the SPN from the base position to the starting position of the third chunk (D2[2]) is b2.

The n+1-th value of bn indicates that the SPN from the base position to the starting position of the n+1-th chunk (D2[n]) that is the final chunk is bn.

FIG. 41C is the chunk_map( ) described in the clpi file of the “00003.clpi”, and the number_of_chunks is n.

In addition, the SPN_chunk_start[i] is 0, a1, a2, . . . and an.

As shown in FIG. 42A, the first value of 0 indicates that the SPN from a base position to the starting position of the first chunk (D1[0]) based on the starting position of the head chunk of the D1 view video included in the m2ts file of the “00003.m2ts” is 0.

The second value of a1 indicates that the SPN from the base position to the starting position of the second chunk (D1[1]) is a1.

The third value of the a2 indicates that the SPN from the base position to the starting position of the third chunk (D1[2]) is a2.

The n+1-th value of an indicates that the SPN from the base position to the starting position of the n+1-th chunk (D1[n]) that is the final chunk is an.

D1[i], D2[i], and B[i] are periodically arranged on the optical disc 202 in the order shown in FIG. 42D.

When the data read from the optical disc 202 are supplied from the disk drive 252, the separating unit 281 separates the data as much as the SPN corresponding to a1 from the head of the supplied data as D1[0] based on the description of three chunk_map( )s of FIGS. 41A to 41C.

In addition, the separating unit 281 separates the data as much as the SPN corresponding to b1 from the ending position of the D1[0] as D2[0], and separates the data as much as the SPN corresponding to c1 from the ending position of the D2[0] as B[0].

The separating unit 281 separates the data as much as the SPN corresponding to a2-a1 from the ending position of the B[0] as D1[1].

The separating unit 281 separates the data as much as the SPN corresponding to b2-b1 from the ending position of the D1[1] as D2[1], and separates the data as much as the SPN corresponding to c2-c1 from the ending position of the D2[1] as B[1].

Furthermore, the chunks as a separation target are only D1[i] and B[i] when B-D1 playback is performed, and are only D2[i] and B[i] when B-D2 playback is performed.

As such, the separation of the data by the separating unit 281 is performed by using information on the length of each chunk described in the chunk_map( ).

Description of the chunk_map( ) will be made up.

When type=0, a chunk_map( ) is optional (may be omitted) for the clpi file referred to by ref_to_B_clpi_file_name. In addition, when there is a chunk_map( ), a player is supposed to ignore the chunk_map( ).

In addition, a chunk_map( ) is optional (may be omitted) for the clpi file corresponding to the m2ts file on the local storage 254. Furthermore, when there is a chunk_map( ) a player is supposed to ignore the chunk_map( ).

When type=1, three TSs including the corresponding TS of the Base view video, TS of the D1 view video, and TS of the D2 view video are split into the same number n of chunks each. In other words, for D1[i], D2[i], and B[i] of FIG. 42, a group of chunks having the same value for the suffix i is split so as to have the same playback time.

In the same manner, when type=2, two TSs including the corresponding TS of the Base view video, and TS of the D1 view video are split into the same number n of chunks each. In other words, for the interleaved D1[i] and B[i], a group of chunks having the same value for the suffix i is split so as to have the same playback time.

When type=3, two TSs including the corresponding TS of the Base view video, and TS of the D2 view video are split into the same number n of chunks each. In other words, for the interleaved D2[i] and B[i], a group of chunks having the same value for the suffix i is split so as to have the same playback time.

### 3D_PlayList Example 2

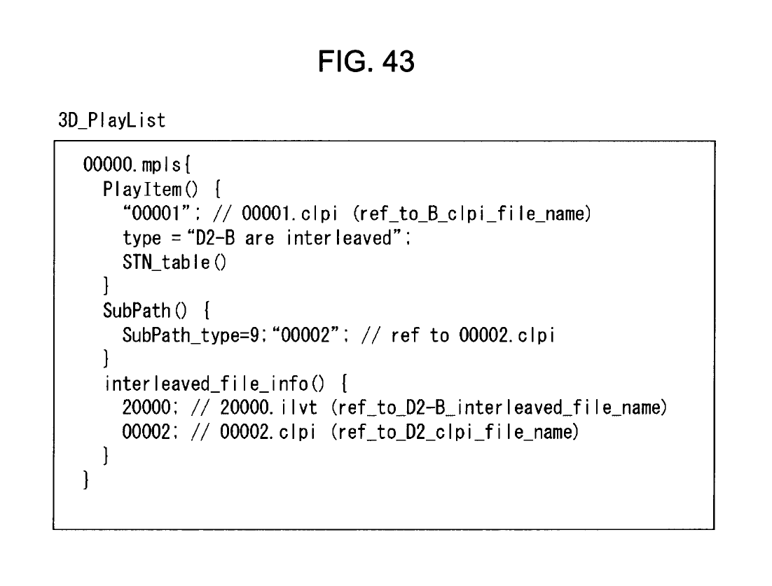

FIG. 43 is a diagram illustrating another example of the 3D_PlayList.

The 3D_PlayList described in the PlayList file of the “0000.mpls” of FIG. 43 is a PlayList for managing the playback of the optical disc 202 where the Base view video and the D2 view video are interleaved. In other words, the value of a type is 3.

Except that the description of the SubPath is only the description of the SubPath that the D2 view video refers to and that the description of the interleaved_file_info( ) is different, the description of the 3D_PlayList of FIG. 43 is the same as that of FIG. 36.

In other words, the SubPath_type of the SubPath( ) is “9”. The fact that the SubPath_type is “9” indicates that the SubPath is a SubPath to play back the D2 view video.

In addition, the ref_to_clpi_file_name is “00002”.

Ref_to_D2-B_interleaved_file_name of the interleaved_file_info( ) of FIG. 43 is “20000”. With the description, when the D2-B playback is performed, it is specified that the ilvt file of the “20000.ilvt” of FIG. 24 is referred to.

In addition, the ref_to_D2_clpi_file_name is “00002”. With the description, when the D2 view video is played back, it is specified that the clpi file of the “00002.clpi” of FIG. 24 is referred to.

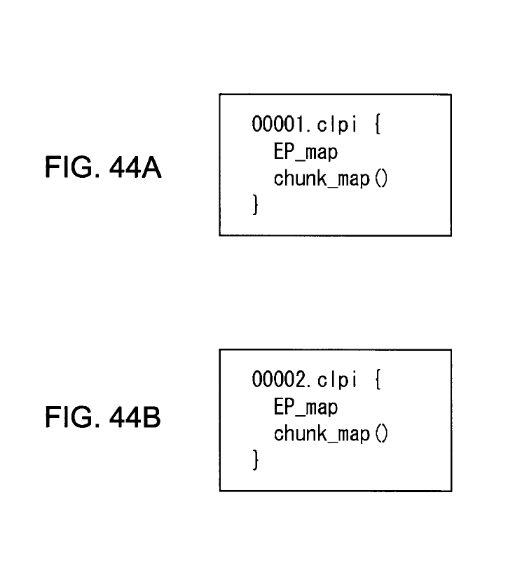

FIGS. 44A and 44B are diagrams illustrating the syntax of the clpi file used together with the 3D_PlayList of FIG. 43.

FIG. 44A is a diagram illustrating an example of the clpi file of the “00001.clpi”, and FIG. 44B is a diagram illustrating an example of the clpi file of the “00002.clpi”. Both of the clpi files include the description of the EP_map and the chunk_map( ) described above.

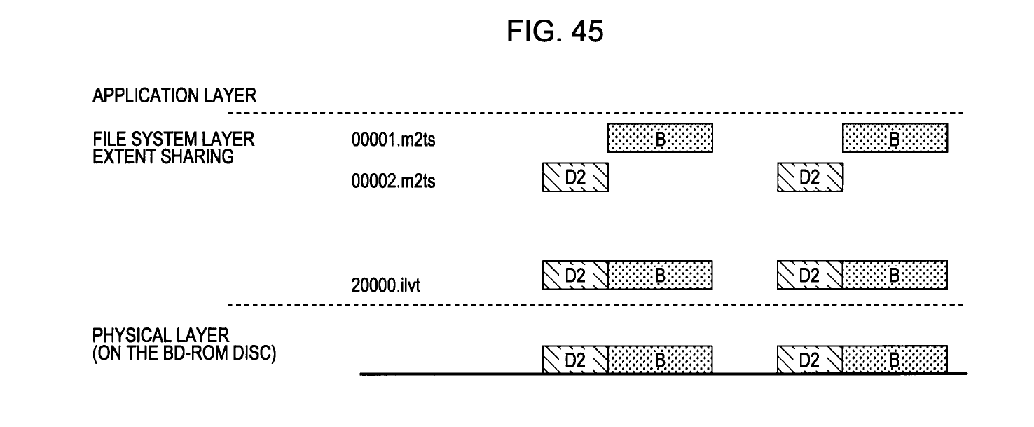

FIG. 45 is a diagram illustrating the concept of the file management performed by using the data of FIG. 43 and FIGS. 44A and 44B.

As shown in FIG. 45, the physical layer forms a layer of the optical disc 202 on which the Base view video and the D2 view video are recorded in an interleaved state.

The m2ts file of the “00001.m2ts” is formed with the chunks of the Base view video arranged on the optical disc 202.

In addition, the m2ts file of the “00002.m2ts” is formed with the chunks of the D2 view video arranged on the optical disc 202.

The ilvt file of the “20000.ilvt” is formed with the chunks of the Base view video and the D2 view video arranged on the optical disc 202.

When reading of data is instructed by designating the “00001.m2ts” from an application in order to perform 2D playback, the chunks of the Base view video are read according to the management by the file system.

When reading of data is instructed by designating the “20000.ilvt” from the application in order to perform B-D2 playback, the chunks of the Base view video and the chunks of the D2 view video are read according to the management by the file system.

### Operation Example 2

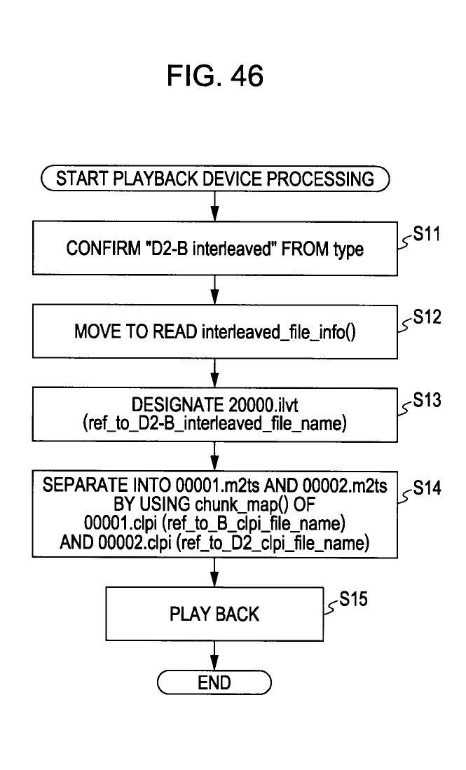

A playback process performed according to the 3D_PlayList file of FIG. 43 will be described with reference to the flowchart of FIG. 46.

In Step S11, the controller 251 confirms that the Base view video and the D2 view video are interleaved from the value of a type.

In this case, in Step S12, the controller 251 moves to read the interleaved_file_info( ).

When the B-D2 playback is instructed, in Step S13, the controller 251 designates the “20000.ilvt” (ref_to_D2-B_interleaved_file_name) described in the interleaved_file_info( ) and reads the chunks of the Base view video and the chunks of the D2 view video from the optical disc 202 through the UDF file system.

The chunks of the Base view video and the chunks of the D2 view video read by the disk drive 252 are supplied to the separating unit 281 of the decoder unit 256.

In Step S14, the separating unit 281 separates the supplied data to the data of the m2ts file of the “00001.m2ts” and the data of the m2ts file of the “00002.m2ts” based on the chunk_map( ) of the “00001.clpi” (ref_to_B_clpi_file_name) and the chunk_map( ) of the “00002.clpi” (ref to D2_clpi_file_name). The separating unit 281 outputs the data of the m2ts file of the “00001.m2ts” to the read buffer 282 and outputs the data of the m2ts file of the “00002.m2ts” to the read buffer 285.

The data of the m2ts file of the “00001.m2ts” stored in the read buffer 282 are supplied to the decoder 290 via the PID filter 283, the ES buffer 284, and the switch 289. On the other hand, the data of the m2ts file of the “00002.m2ts” stored in the read buffer 285 are supplied to the decoder 290 via the PID filter 286, the switch 287, the ES buffer 288, and the switch 289.

In Step S15, the decoder 290 decodes the packets in order supplied from the switch 289.

### 3D_PlayList Example 3

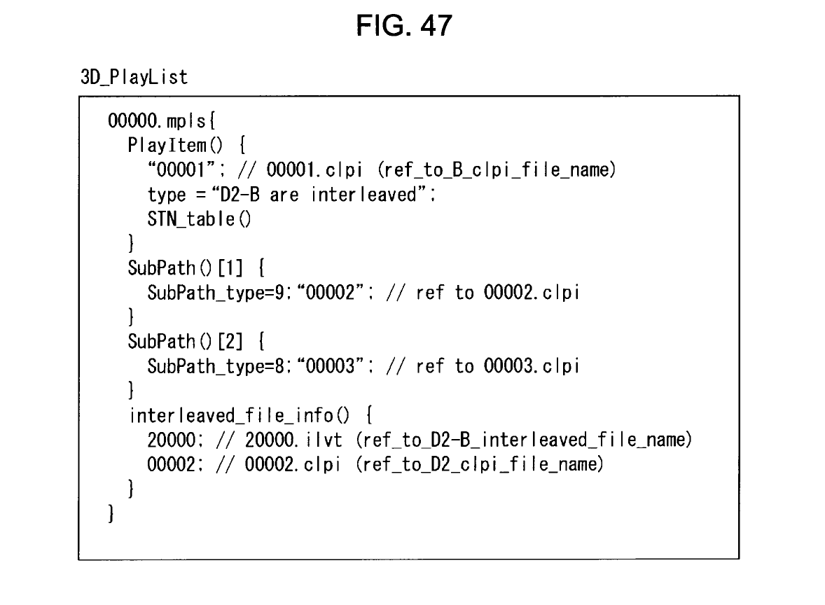

FIG. 47 is a diagram illustrating still another example of the 3D_PlayList.

The 3D_PlayList described in the PlayList file of the “0000.mpls” in FIG. 47 is a PlayList for managing the playback of the Base view video and the D2 view video recorded on the optical disc 202 and the D1 view video recorded in the local storage 254. On the optical disc 202, the Base view video and the D2 view video are interleaved.

The value of a type of the PlayItem( ) is 3 because it indicates the type of the arrangement of data on the optical disc 202.

The SubPath_type of the SubPath( )[1] is “9”. The fact that the SubPath_type is “9” indicates that the first SubPath is a SubPath for playing back the D2 view video.

The ref_to_clpi_file_name of the SubPath( )[1] is “00002”. With the description, it is specified that the clpi file of the “00002.clpi” of FIG. 24 is referred to when the D2 view video is played back.

The SubPath_type of the SubPath( )[2] is “8”. The fact that the SubPath_type is “8” indicates that the second SubPath is a SubPath for playing back the D1 view video.

The ref_to_clpi_file_name of the SubPath( )[2] is “00003”. With the description, it is specified that the clpi file of the “00003.clpi” recorded in the local storage 254 is referred to when the D1 view video is played back.

The description of the second SubPath will be added, for example, when the D1 view video is downloaded.

The ref_to_D2-B_interleaved_file_name of the interleaved_file_info( ) is “20000”. With the description, it is specified that the ilvt file of the “20000.ilvt” of FIG. 24 is referred to when the B-D2 playback is performed.

In addition, the ref_to_D2_clpi_file_name is “00002”. With the description, it is specified that the clpi file of the “00002.clpi” of FIG. 24 is referred to when the D2 view video is played back.

Furthermore, since the D1 view video is not interleaved on the local storage 254, the ilvt file for the D1 view video is not necessary.

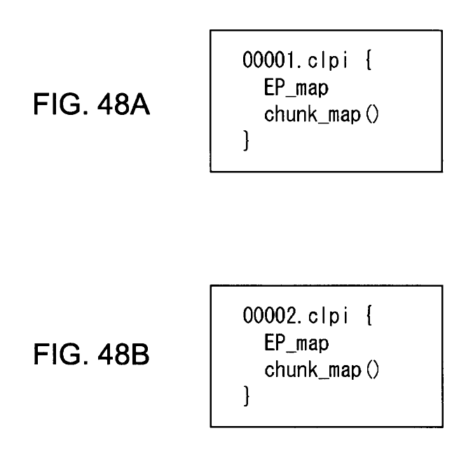

FIGS. 48A and 48B are diagrams illustrating the syntax of the clpi file used together with the 3D_PlayList of FIG. 47.

FIG. 48A is a diagram illustrating an example of the clpi file of the “00001.clpi”, and FIG. 48B is a diagram illustrating an example of the clpi file of the “00002.clpi”. Both of the clpi files include the description of the EP_map and the chunk_map( ).

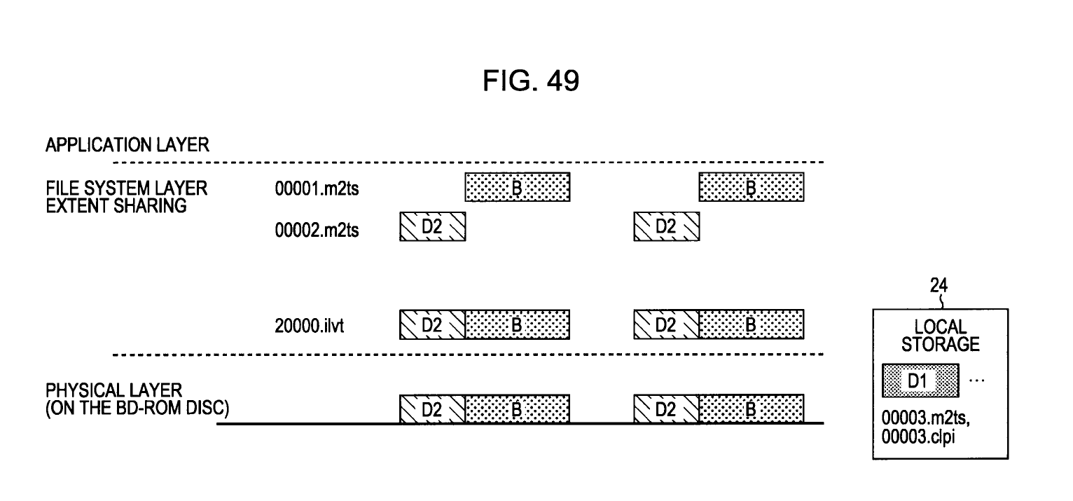

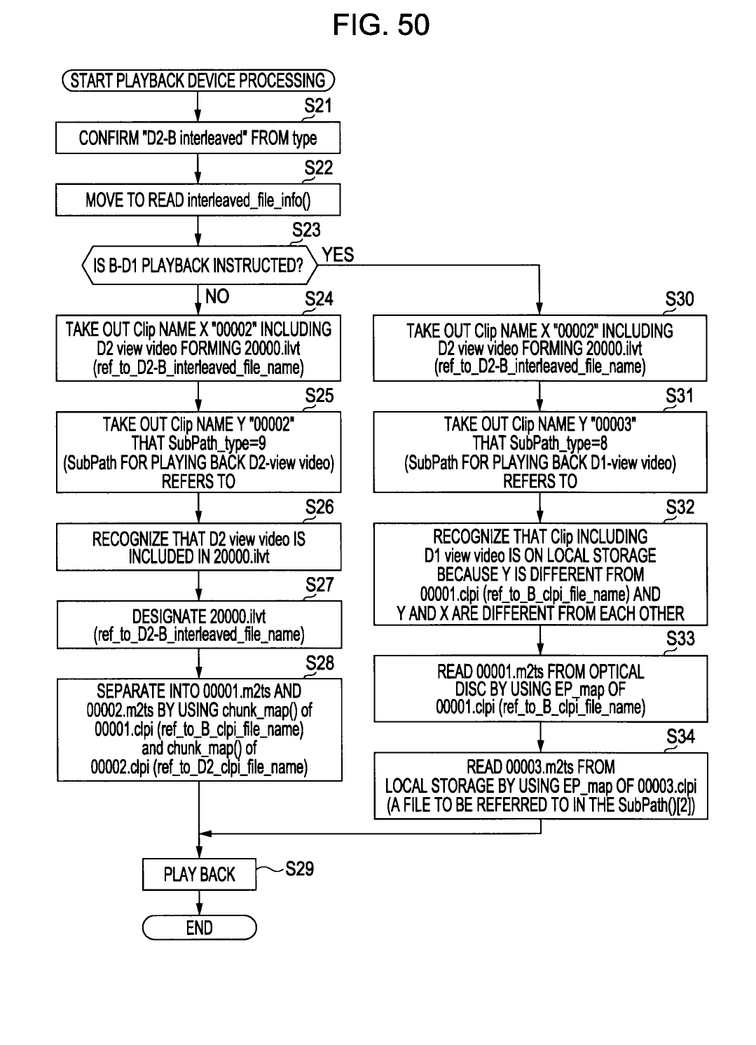

FIG. 49 is a diagram illustrating the concept of the file management performed by using the data of FIG. 47 and FIGS. 48A and 48B.

As shown in FIG. 49, the physical layer is a layer of the optical disc 202 on which the Base view video and the D2 view video are recorded in the interleaved state, and the local storage 254 in which the file of the D1 view video that the second SubPath refers to is recorded.

In the example of FIG. 49, the file name of the m2ts file accommodating the D1 view video is “00003.m2ts”. In addition, the file name of the clpi file corresponding to the “00003.m2ts” is “00003.clpi”.

The m2ts file of the “00001.m2ts” is formed with the chunks of the Base view video arranged on the optical disc 202.

In addition, the m2ts file of the “00002.m2ts” is formed with the chunks of the D2 view video arranged on the optical disc 202.

The ilvt file of the “20000.ilvt” is formed with the chunks of the D2 view video and the chunks of the Base view video arranged on the optical disc 202.

When reading of data is instructed by designating the “00001.m2ts” from the application in order to the 2D playback is performed, the chunks of the Base view video are read according to the management by the file system.

When reading of data is instructed by designating the “00001.m2ts” from the application in order to the B-D1 playback is performed, the chunks of the Base view video are read according to the management by the file system. In addition, the m2ts file of the D1 view video is read from the local storage 254 by designating the “00003.m2ts” according to the description of the second SubPath of the 3D_PlayList of FIG. 47.

When reading of data is instructed by designating the “20000.ilvt” from the application in order to the B-D2 playback is performed, the chunks of the D2 view video and the chunks of the Base view video are read according to the management by the file system.

### Operation Example 3

A playback process performed according to the 3D_PlayList file of FIG. 47 will be described with reference to the flowchart of FIG. 50.

In Step S21, the controller 251 confirms that the Base view video and the D2 view video are interleaved from the value of a type.

In this case, in Step S22, the controller 251 moves to read the interleaved_file_info( ).

In Step S23, the controller 251 determines whether the B-D1 playback is to be instructed or not.

When the B-D1 playback is performed, the data recorded on the optical disc 202 and the data recorded in the local storage 254 are used. On the other hand, when the B-D2 playback is performed, the data recorded on the optical disc 202 is used.

In Step S23, when it is determined that the B-D1 playback is not instructed, in other words, the B-D2 playback is not instructed, the controller 251 takes out a Clip name X “00002” (a portion excluding the extension in the name of the m2ts file including the D2 view video) including the D2 view video forming the “20000.ilvt” (ref_to_D2-B_interleaved_file_name) described in the interleaved_file_info( ) in Step S24.

In Step S25, the controller 251 takes out a Clip name Y “00002” that SubPath_type=9 (a SubPath for playing back the D2-view video) refers to.

In Step S26, the controller 251 recognizes that the D2 view video is included in the “20000.ilvt” based on the fact that the Y and the X are the same. Here, if the Y and the X are different from each other, the Clip including the D2 view video exists on the local storage 254.

In Step S27, the controller 251 designates the “20000.ilvt” (ref_to_D2-B_interleaved_file_name) described in the interleaved_file_info( ), and reads the chunks of the Base view video and the chunks of the D2 view video from the optical disc 202 through the UDF file system.

The chunks of the Base view video and the chunks of the D2 view video read by the disk drive 252 are supplied to the separating unit 281 of the decoder unit 256.

In Step S28, the separating unit 281 separates the supplied data to the data of the m2ts file of the “00001.m2ts” and the data of the m2ts file of the “00002.m2ts” based on the chunk_map( ) of the “00001.clpi” (ref_to_B_clpi_file_name) and the chunk_map( ) of the “00002.clpi” (ref to D2_clpi_file_name). The separating unit 281 outputs the data of the m2ts file of the “00001.m2ts” to the read buffer 282, and outputs the data of the m2ts file of the “00002.m2ts” to the read buffer 285.

The data of the m2ts file of the “00001.m2ts” stored in the read buffer 282 are supplied to the decoder 290 via the PID filter 283, the ES buffer 284, and the switch 289. On the other hand, the m2ts file of the “00002.m2ts” stored in the read buffer 285 are supplied to the decoder 290 via the PID filter 286, the switch 287, the ES buffer 288, and the switch 289.

In Step S29, the decoder 290 decodes the packets in order supplied from the switch 289.

On the other hand, when it is determined that the B-D1 playback is instructed in Step S23, the controller 251 takes out the Clip name X “00002” including the D2 view video forming the “20000.ilvt” (ref_to_D2-B_interleaved_file_name) described in the interleaved_file_info( ) in Step S30.

In Step S31, the controller 251 takes out the Clip name Y “00003” that SubPath_type=8 (SubPath for playing back the D1-view video) refers to.

In Step S32, the controller 251 recognizes that the Clip of the D1 view video exists on the local storage 254 based on the fact that the Y is different from the portion excluding the extension from the “00001.clpi” (ref_to_B_clpi_file_name) and the Y and the X are different from each other. Here, when the Y is the same as the portion excluding the extension from the “00001.clpi” or the Y and the X are the same, the D1 view video is included in the “20000.ilvt”.

In Step S33, the controller 251 reads the m2ts file of the “00001.m2ts” in the disk drive 252 by using the EP_map of the “00001.clpi” (ref_to_B_clpi_file_name). The EP_map of the “00001.clpi” includes information on an entry point that is to be a starting point of decoding the m2ts file of the “00001.m2ts”.

In Step S34, the controller 251 reads the m2ts file of the “00003.m2ts” from the local storage 254 by using the EP_map of the “00003.clpi” (a file to be referred to in the SubPath( )[2]). The EP_map of the “00003.clpi” includes information on an entry point that is to be a starting point of decoding the m2ts file of the “00003.m2ts”.

The chunks of the Base view video and the chunks of the D1 view video that have been read are supplied to the separating unit 281 of the decoder unit 256.

The data of the m2ts file of the “00001.m2ts” read from the optical disc 202 are stored in the read buffer 282 and then supplied to the decoder 290 via the PID filter 283, the ES butter 284 and the switch 289.

In addition, the data of the m2ts file of the “00003.m2ts” read from the local storage 254 are stored in the read buffer 285 and then supplied to the decoder 290 via the PID filter 286, the switch 287, the ES butter 288 and the switch 289.

In Step S29, the decoder 290 decodes the packets orderly supplied from the switch 289.

Method of Random Access Playback of “10000.ilvt” by Using Chunk_map( )

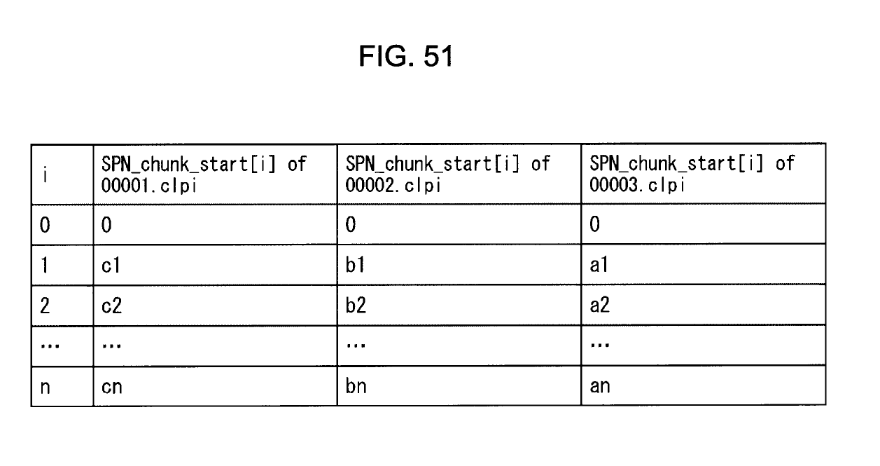

FIG. 51 is a diagram illustrating the summary of contents of the chunk_map( ) described with reference to FIGS. 41A to 41C.

If the SPN_chunk_start (SPN (length) from a base position) described in the chunk_map( ) of each clpi file is arranged on the basis of i in the vertical direction, the result is as shown in FIG. 51.

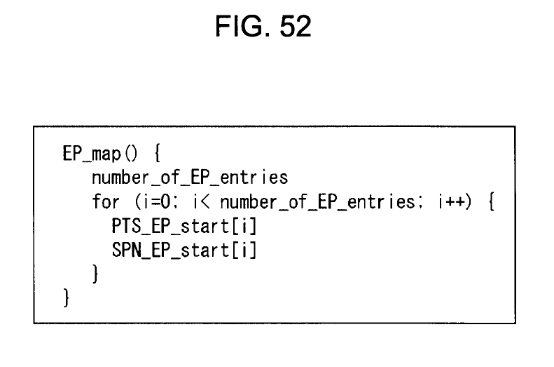

FIG. 52 is a diagram illustrating the syntax of the EP_map( ) described in each clpi file also in the chunk_map( ).

The EP_map( ) is referred to for specifying a decoding starting position when random access or the like is performed.

The number_of_EP_entries indicates the number of EPs (entry points).

Description below the number_of_EP_entries is prepared for each EP. PTS_EP_start[i] indicates PTS of EP, and SPN_EP_start[i] indicates SPN of EP. As such, the EP_map is registered with the PTS and the SPN for each entry point in the corresponding manner.

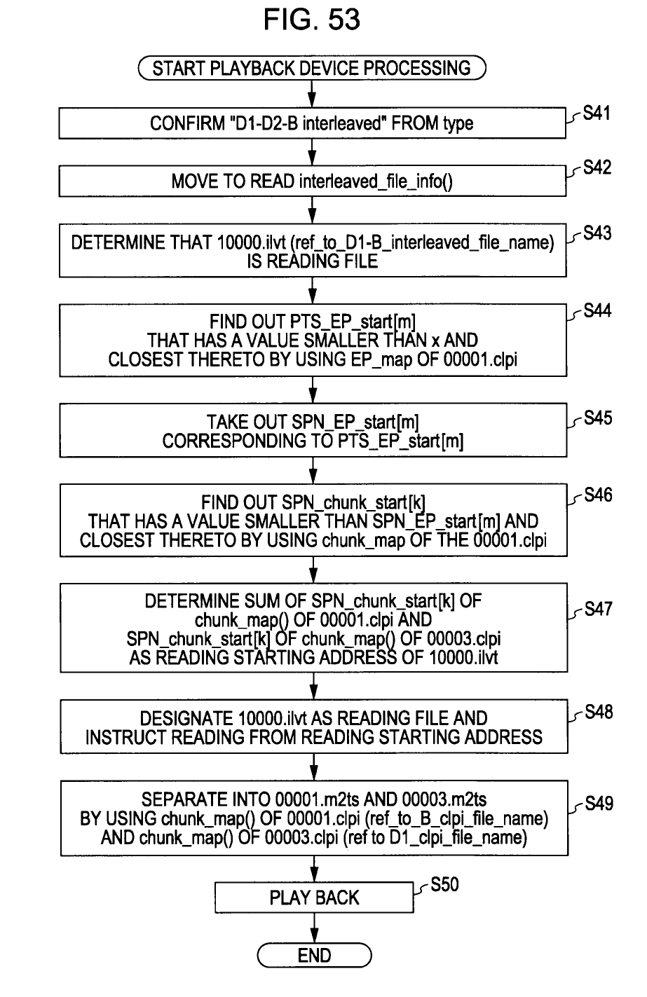

A process of the playback device 201 will be described with reference to the flowchart of FIG. 53.

Herein, a case where the B-D1 playback is performed with reference to the 3D_PlayList of FIG. 36 and random access is performed will be described.

In Step S41, the controller 251 confirms that all of the Base view video, the D1 view video, and the D2 view video are interleaved from the value of a type.

In this case, in Step S42, the controller 251 moves to read the interleaved_file_info( ).

In Step S43, the controller 251 determines that the “10000.ilvt” (ref_to_D1-B_interleaved_file_name) described in the interleaved_file_info( ) is a reading file.

When a playback is started from the time x for the 3D_PlayList file of the “00000.mpls”, the controller 251 finds out the PTS_EP_start[m] that has a value smaller than X and closest thereto by using the EP_map of the “00001.clpi” (ref_to_B_clpi_file_name) in Step S44.

In Step S45, the controller 251 takes out the SPN_EP_start[m] corresponding to the PTS_EP_start[m]. As described with reference to FIG. 52, the EP_map is registered with the PTS_EP_start[i] and the SPN_EP_start[i] in a corresponding manner.

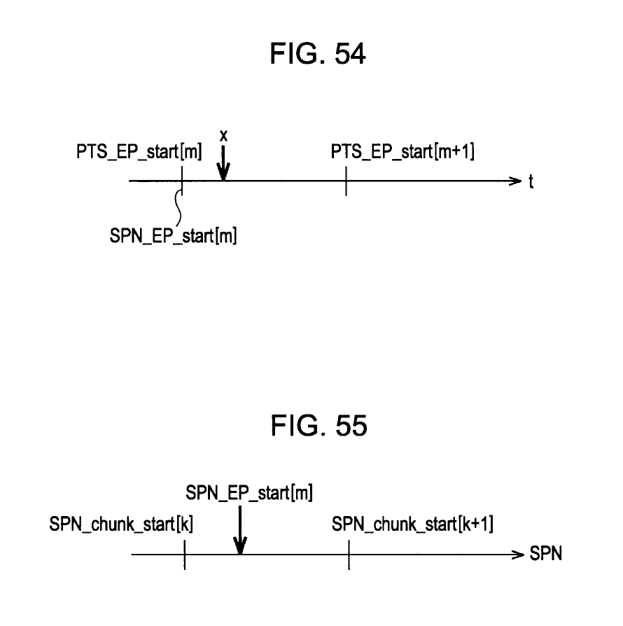

FIG. 54 is a diagram illustrating an example of a position specified by processes of Steps S44 and S45.

As shown in FIG. 54, when a playback is started from the time x on the time axis, the PTS_EP_start[m] that has a value smaller than x and closest thereto is specified in Step S44. In addition, the SPN_EP_start[m] corresponding to the PTS_EP_start[m] is specified in Step S45.

In Step S46, the controller 251 finds out the SPN_chunk_start[k] that has a value smaller than the SPN_EP_start[m] and closest thereto by using the chunk_map of the “00001.clpi”. The SPN_chunk_start[k] specified by the process of Step S46 is shown in FIG. 55.

In Step S47, the controller 251 determines the sum of the SPN_chunk_start[k] of the chunk_map( ) of the “00001.clpi” and the SPN_chunk_start[k] of the chunk_map( ) of the “00003.clpi” (ref to D1_clpi_file_name) as a reading starting address of the “10000.ilvt”.

The reading starting address of the “10000.ilvt” determined herein shows a starting address the chunks of the D1[k] in “10000.ilvt”.

In Step S48, the controller 251 designates “10000.ilvt” (ref_to_D1-B_interleaved_file_name) and reads the chunks of the Base view video and the chunks of the D1 view video from the determined address in Step S47 through the UDF file system.

The chunks of the Base view video and the chunks of the D1 view video that have been read are supplied to the separating unit 281 of the decoder unit 256.

In Step S49, the separating unit 281 separates the supplied data to the data of the m2ts file of the “00001.m2ts” and the data of the m2ts file of the “00003.m2ts” based on the chunk_map( ) of the “00001.clpi” (ref_to B_clpi_file_name) and the chunk_map( ) of the “00003.clpi” (ref to D1_clpi_file_name). The separating unit 281 outputs the data of the m2ts file of the “00001.m2ts” to the read buffer 282 and outputs the data of the m2ts file of the “00003.m2ts” to the read buffer 285.

The data of the m2ts file of the “00001.m2ts” stored in the read buffer 282 are supplied to the decoder 290 via the PID filter 283, the ES buffer 284, and the switch 289. The data of the m2ts file of the “00003.m2ts” stored in the read buffer 285 are supplied to the decoder 290 via the PID filter 286, the switch 287, the ES buffer 288, and the switch 289.

In Step S50, the decoder 290 decodes the packets orderly supplied from the switch 289.

The random access of the ilvt file is performed as described above.

### Regarding EP_map

Herein, the EP_map will be described.

EP_map is set for the D1/D2 view video in the same manner as described for the EP_map of the Base view video. For example, when an entry point is set to a picture of the Base view video, entry points are set also to pictures corresponding to the D1/D2 view video.

The picture of the Base view video and the picture of the D1/D2 view video in the same position when pictures of each stream are arranged in the encoding order, decoding order, or displaying order are corresponding pictures.

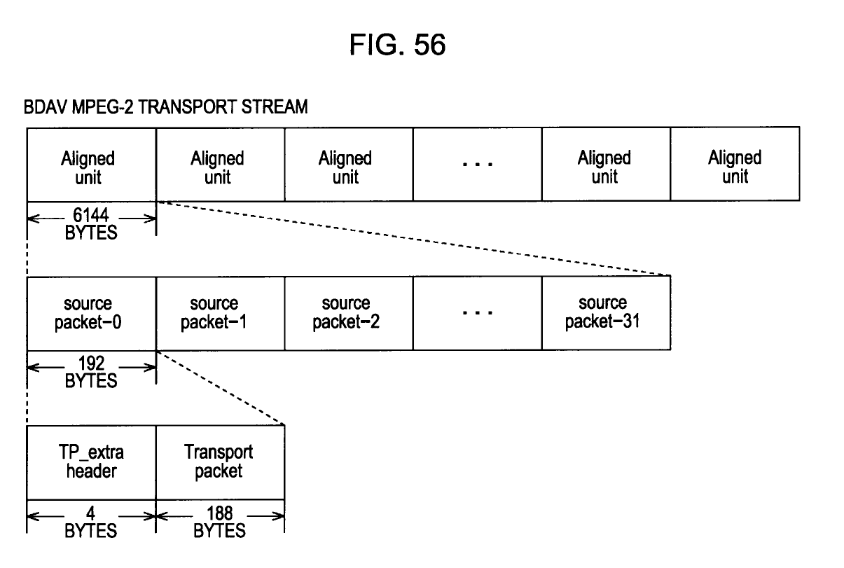

FIG. 56 is a diagram illustrating the structure of the AV stream recorded on the optical disc 202.

The TS including the Base view video stream is formed of aligned units as many as the number of integers having the size of 6144 bytes.

An aligned unit includes 32 source packets. A source packet has 192 bytes. One source packet includes a 4-byte transport packet extra header (TP_extra header) and a 188-byte transport packet.

The data of Base view video is made to be an MPEG2 PES packet. A PES packet header is added to a data unit of a PES packet and thereby a PES packet is formed. In the PES packet header, a stream ID that specifies a type of an elementary stream transmitted by a PES packet is included.

A PES packet is further made to be a transport packet. In other words, a PES packet is divided into the size of a payload of a transport packet, a transport packet header is added to the payload and thereby a transport packet is formed. The transport packet header includes a PID which is information for identifying data accommodated in a payload.

Furthermore, a source packet number that increases one by one for each source packet is given to a source packet with the head of a Clip AV stream set to be, for example, 0. In addition, an aligned unit begins from a first byte of a source packet.

The EP_map is used for searching a data address where reading of data is to be started in Clip AV stream files when a time stamp of an access point of a Clip is given. The EP_map is a list of entry points extracted from elementary streams and transport streams.

The EP_map has address information for searching an entry point where decoding is started in an AV stream. One piece of EP data in the EP_map is formed of a pair of a PTS and an address of an Access Unit corresponding to the PTS in the AV stream. In the AVC/H.264, data as much as one picture is accommodated in one Access Unit.

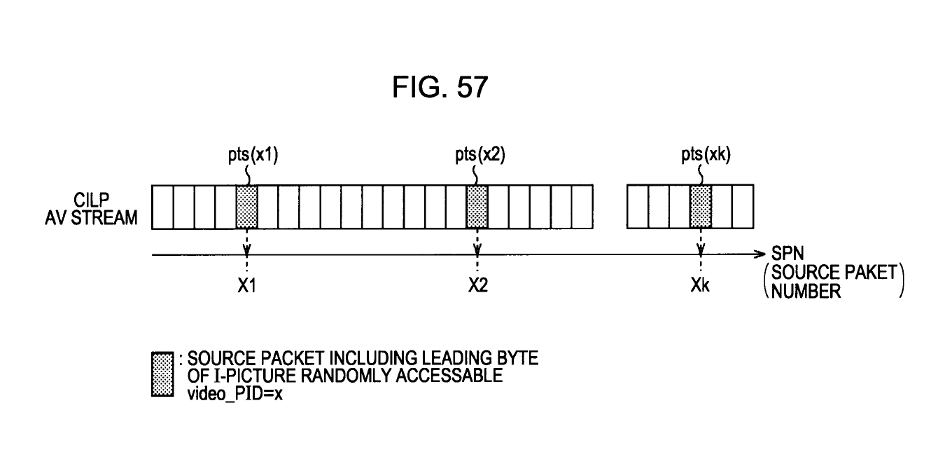

FIG. 57 is a diagram illustrating an example of the Clip AV stream.

The Clip AV stream of FIG. 57 is a video stream (Base view video stream) formed of source packets identified with PID=x. The video stream is distinguished for each source packet by a PID included in the header of the transport packet in the source packet.

In FIG. 57, source packets including the head byte of instantaneous decoding refresh (IDR) pictures among source pictures of the video stream are colored. Squares not colored indicate source packets including data that are not random access points or source packets including data of other streams.

An IDR picture is an I-picture and decoded for the first in the GOP including the IDR picture. When the IDR picture is decoded, all information regarding the state of a reference picture buffer, a frame number that has been managed until that time, and decoding of a picture order count (POC) is reset.

For example, a source packet with a source packet number X1 including a head byte of an IDR picture of the video stream that is distinguished with PID=x and randomly accessible is placed at a position of PTS=pts(x1) on the time axis of the Clip AV stream.

In the same manner, a source packet including a head byte of the IDR picture that is randomly accessible to the next is a source packet with a source packet number X2 and placed at a position of PTS=pts(x2).

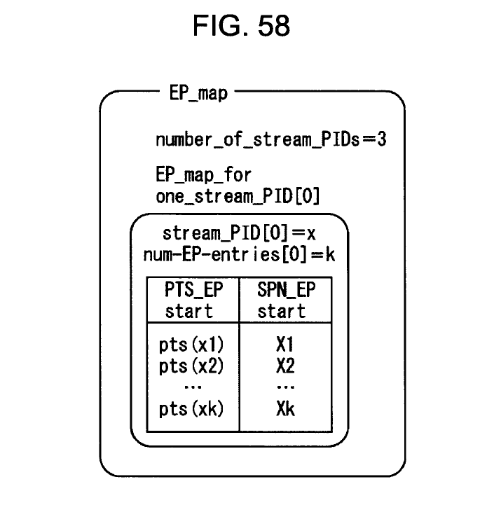

FIG. 58 is a diagram conceptually illustrating an example of the EP_map corresponding to the Clip AV stream of FIG. 57.

As shown in FIG. 58, the EP_map includes stream_PID, PTS_EP_start, and SPN_EP_start.

The stream_PID indicates a PID of a transport packet transmitting a video stream.

The PTS_EP_start indicates a PTS of an Access Unit starting from an IDR picture that is randomly accessible.

The SPN_EP_start indicates an address of a source packet including a first byte of an Access Unit referred by the value of the PTS_EP_start.

The PID of the video stream is accommodated in the stream_PID, and EP_map_for_one_stream_PID( ) which is table information indicating the corresponding relation between the PTS_EP_start and the SPN_EP_start is generated.

For example, in the EP_map_for_one_stream_PID[0] of the video stream with PID=x, there is a description whereby PTS=pts(x1) and the source packet number X1, PTS=pts(x2) and the source packet number X2, . . . , and PTS=pts(xk) and the source packet number Xk correspond to each other.

Such a table is multiplexed in the same Clip AV stream and generated for each video stream. The EP_map including the generated table is accommodated in a Clip Information file corresponding to the Clip AV stream.

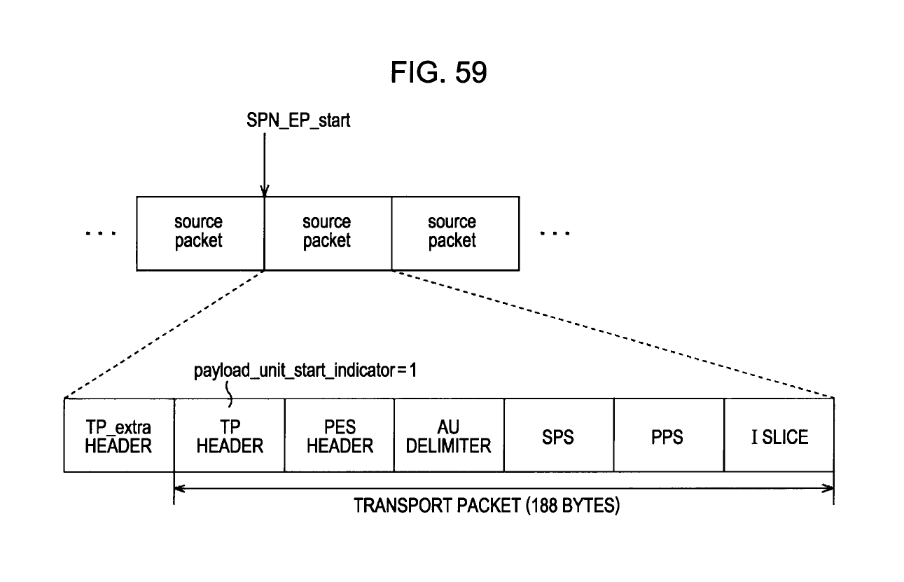

FIG. 59 is a diagram illustrating an example of the data structure of source packets that the SPN_EP_start indicates.

As described above, the source packets are formed in a way that a 188-byte transport packet is added with a 4-byte header. The portion of the transport packet is formed of a header part (TP header) and a payload part. The SPN_EP_start indicates a source packet number of a source packet including a first byte of an Access Unit starting from an IDR picture.

In the AVC/H.264, an Access Unit, that is, a picture starts from an Access Unit Delimiter (AU Delimiter). Next to the AU Delimiter, an SRS and a PPS continue. Next to that, the head part or all of the data of a slice of an IDR picture is accommodated.

The fact that the value of the payload_unit_start_indicator in the TP header of the transport packet is 1 indicates that a new PES packet starts from the payload of the transport packet. An Access Unit starts from the source packet.

Such EP_map is prepared for each of the Base view video stream and the Dependent view video stream.

### Third Embodiment

In the above, the clpi files of the D1/D2 view video are referred to based on the description of the PlayList, but the clpi file of the Base view video may be referred to.

### Reference Example 1

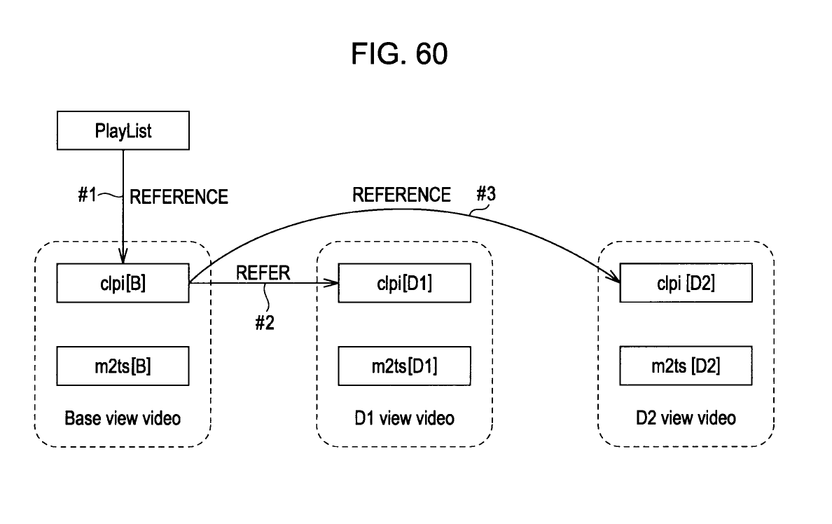

FIG. 60 is a diagram illustrating an example of the file management by the playback device 201.

In FIG. 60, a clpi file that the PlayList can refer to is the clpi file of the Base view video as shown by the arrow #1.

The clpi file of the Base view video includes at least a part of the file name of the clpi file of the D1/D2 view video. By using the file name, the clpi file of the D1 view video is referred to as shown by the arrow #2, and the clpi file of the D2 view video is referred to as shown by the arrow #3.

The clpi[B] of FIG. 60 indicates a clpi file of the m2ts file (m2ts[B]) accommodating the Base view video. In addition, the clpi[D1] indicates a clpi file of the m2ts file (m2ts[D1]) accommodating the D1 view video. The clpi[D2] indicates a clpi file of the m2ts file (m2ts[D2]) accommodating the D2 view video.

A 2-bit 3D_Clip_type and a 2-bit 3D_App_type are set in each clpi file.

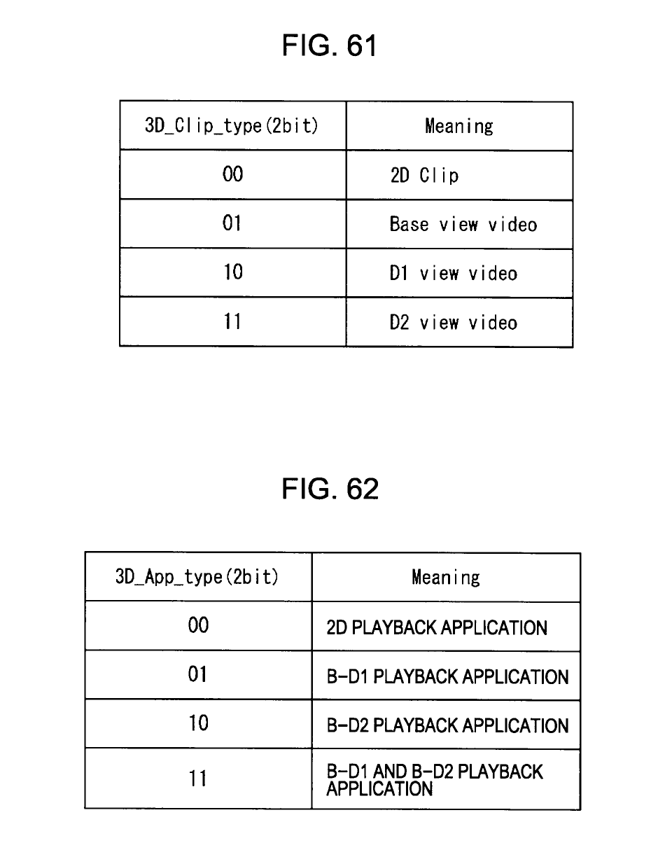

FIG. 61 is a diagram illustrating the meanings of the 3D_Clip_type.

00 of the value of the 3D_Clip_type indicates a Clip used in the 2D playback. This is for securing the compatibility with a player only for the 2D playback. The m2ts file corresponding to the clpi file including 3D_Clip_type=00 becomes a file of 2D playback video (for example, a file of the Base view video).

01 of the value of the 3D_Clip_type indicates a Clip of the Base view video.

10 of the value of the 3D_Clip_type indicates a Clip of the D1 view video.

11 of the value of the 3D_Clip_type indicates a Clip of the D2 view video.

FIG. 62 is a diagram illustrating the meanings of the 3D_App_type.

00 of the value of the 3D_App_type indicates a Clip that may be referred to by a 2D playback application. The 2D playback application is an application for controlling the 2D playback.

01 of the value of the 3D_App_type indicates a Clip that may be referred to by a B-D1 playback application. The B-D1 playback application is an application for controlling the B-D1 playback.

10 of the value of the 3D_App_type indicates a Clip that may be referred to by a B-D2 playback application. The B-D2 playback application is an application for controlling the B-D2 playback.

11 of the value of the 3D_App_type indicates a Clip that may be referred to by both the B-D1 playback application and the B-D2 playback application.

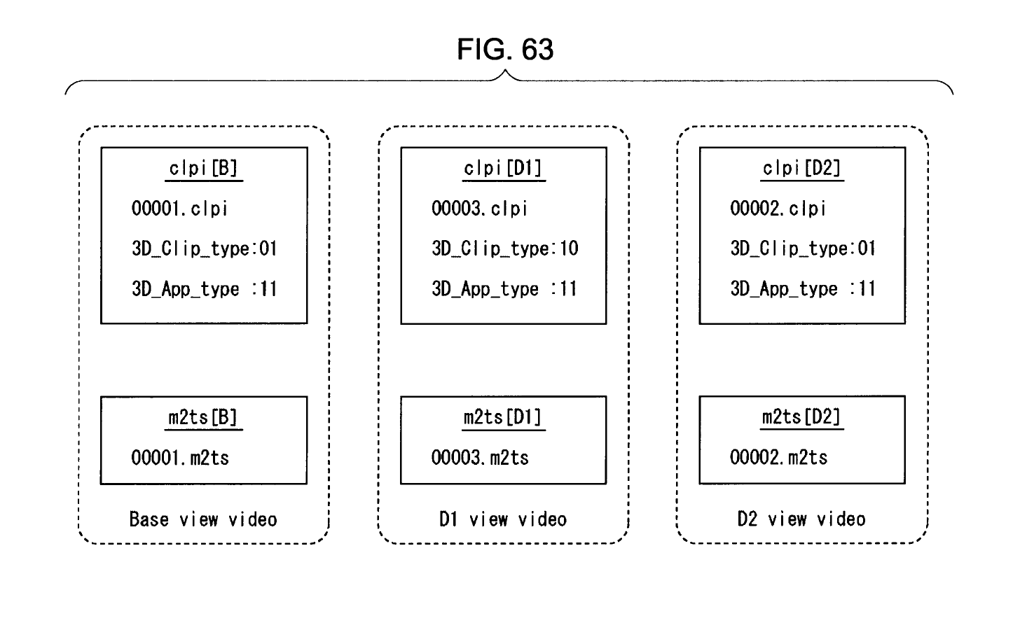

FIG. 63 is a diagram illustrating an example of the setting of the 3D_Clip_type and the 3D_App_type.

In the example of the FIG. 63, the clpi file of the Base view video is set with 01 as the value of the 3D_Clip_type, and 11 as the value of the 3D_App_type. The file name of the clpi file of the Base view video is “00001.clpi”.

The file name of the m2ts file of the Base view video is “00001.m2ts”. As such, the corresponding clpi file and m2ts file are set with file names formed with the same 5-digit number and respective extensions.

In addition, the clpi file of the D1 view video is set with 10 as the value of the 3D_Clip_type, and 11 as the value of the 3D_App_type. The file name of the clpi file of the D1 view video is “00003.clpi”, and the file name of the corresponding m2ts file is “00003.m2ts”.

The clpi file of the D2 view video is set with 01 as the value of the 3D_Clip_type, and 11 as the value of the 3D_App_type. The file name of the clpi file of the D2 view video is “00002.clpi”, and the file name of the corresponding m2ts file is “00002.m2ts”.

The clpi file of the Base view video includes the description of a portion excluding the extension from the file name set to the clpi file of the D1/D2 view video as information indicating the clpi file of the D1/D2 view video used for the 3D playback together with the Base view video.

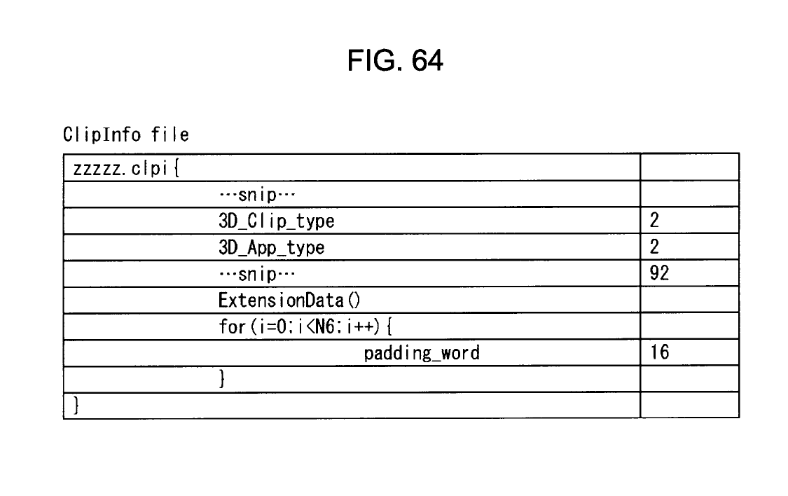

FIG. 64 is a diagram illustrating the syntax of the clpi file.

As shown in FIG. 64, values of the 3D_Clip_type and the 3D_App_type are each set for the clpi file.

In addition, when the clpi file is the clpi file of the Base view video, information indicating the clpi file of the D1/D2 view video used for the 3D playback together with the Base view video is described in the ExtensionData( ).

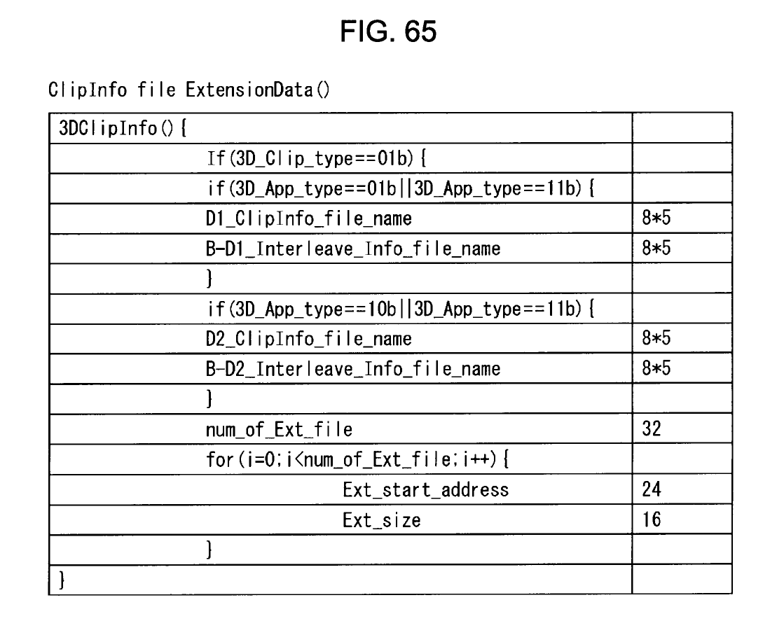

FIG. 65 is a diagram illustrating a specific example of the description of the clpi file in the ExtensionData( ).

As shown in FIG. 65, for example, various information to be referred during the 3D playback is described as 3DClipInfo( ).

“If(3D_Clip_type==01b)” indicates that the description of FIG. 65 is referred to when the value of the 3D_Clip_type is 01.

“if(3D_App_type==01b∥3D_App_type==11b)” indicates that the next D1_Clip_Info_file_name and B-D1_Interleave_Info_file_name are referred to when the value of the 3D_App_type is 01 or 11. The D1_ClipInfo_file_name and the B-D1_Interleave_Info_file_name are descriptions for the B-D1 playback.

D1_ClipInfo_file_name indicates a 5-digit number excluding the extension from the file name of the clpi file of the D1 view video. In case of the example of FIG. 63, the “00003” is described. It may be possible to describe a whole file name including the extension.

The B-D1_Interleave_Info_file_name indicates a 5-digit number or the like excluding the extension from the file name of a file designated by the file system as a reading file when the B-D1 playback is performed as the ilvt file of the “10000.ilvt” described above.

“if(3D_App_type==10b∥3D_App_type==11b)” indicates that the next D2_ClipInfo_file_name and B-D2_Interleave_Info_file_name are referred to when the value of the 3D_App_type is 10 or 11. The D2_ClipInfo_file_name and the B-D2_Interleave_Info_file_name are descriptions to be referred to when the B-D2 playback is performed.

The D2_ClipInfo_file_name indicates a 5-digit number excluding the extension from the file name of the clpi file of the D2 view video. In case of the example of FIG. 63, the “00002” is described.

The B-D2_Interleave_Info_file_name indicates a 5-digit number or the like excluding the extension from the file name of a file designated by the file system as a reading file when the B-D2 playback is performed as the ilvt file of the “20000.ilvt” described above.

Num_of_Ext_file indicates how many Extents the m2ts file corresponding to the clpi file including the descriptions of FIG. 65 includes.

Below the num_of_Ext_file, information of each Extent is described.

Ext_start_address indicates a starting address of an Extent on the optical disc 202.

Ext_size indicates the length of an Extent. The length of an Extent is expressed by, for example, an SPN as described above.

For example, when the clpi file including the descriptions of FIG. 65 is the clpi file of the Base view video, information on the Extent of the Base view video on the optical disc 202 is described below the num_of_Ext_file.

In addition, the clpi file including the descriptions of FIG. 65 is the clpi file of the D1 view video, information on the Extent of the D1 view video on the optical disc 202 is described below the num_of_Ext_file.

When the clpi file including the descriptions of FIG. 65 is the clpi file of the D2 view video, information on the Extent of the D2 view video on the optical disc 202 is described below the num_of_Ext_file.

Furthermore, in the descriptions of FIG. 65, descriptions from the “If(3D_Clip_type==01b)” in the second row to one row above the num_of_Ext_file are described only in the clpi file of the Base view video. The clpi file of the D1 view video and the clpi file of the D2 view video include descriptions about Extents.

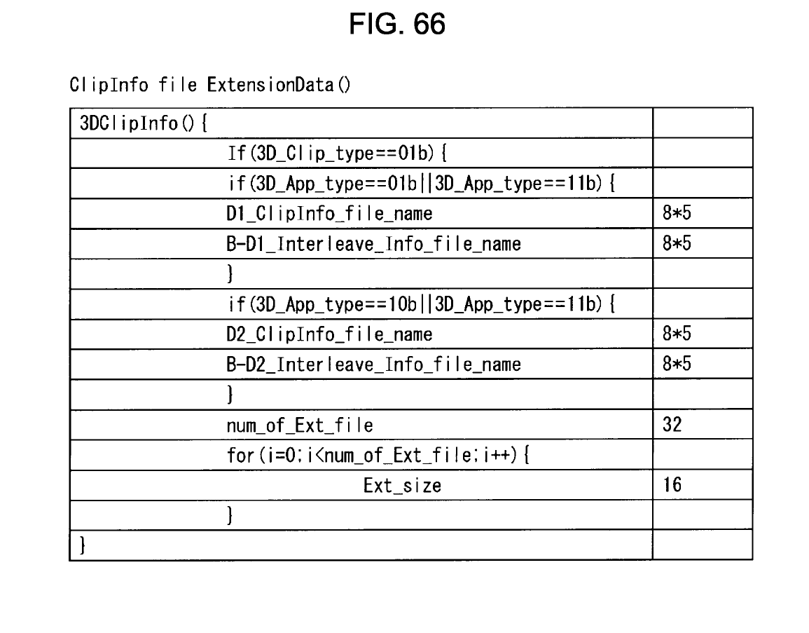

FIG. 66 is a diagram illustrating another specific example of the clpi file in the ExtensionData( ).

The descriptions of FIG. 66 are different from the descriptions of FIG. 65 in that the former does not include “Ext_start_address” that is a description on an Extent. When it is possible to specify an address of each Extent by referring to other information or the like, each Extent can be specified and extracted by using the “Ext_size”, not using the “Ext_start_address”.

### Reference Example 2

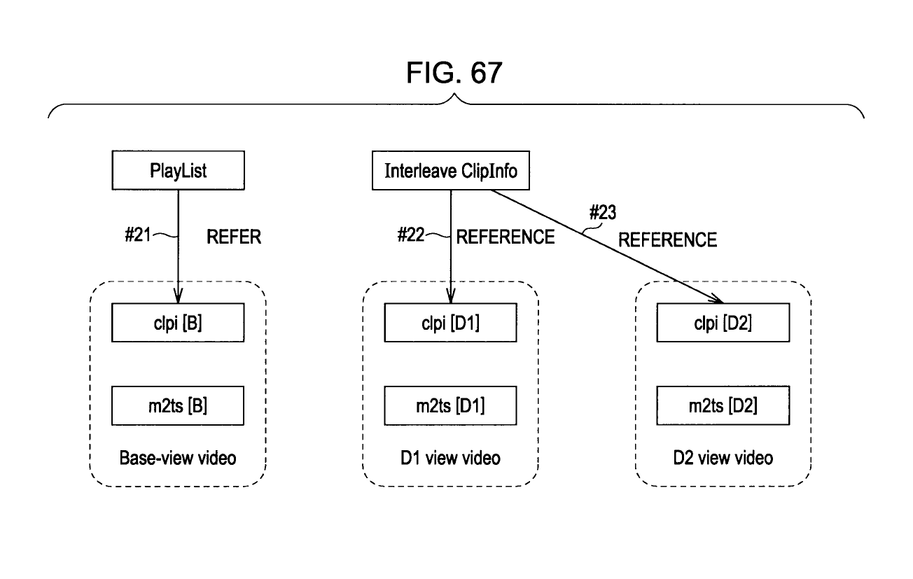

FIG. 67 is a diagram illustrating another example of the file management by the playback device 201.

It may be possible to separately prepare a file for referring to the clpi file of the D1/D2 view video and use the file without the clpi file of the Base view video for referring to the clpi file of the D1/D2 view video.

In the example of FIG. 67, a clpi file that can be referred to from PlayList is only the clpi file of the Base view video as shown by the arrow #21.

It may be possible to refer to the clpi file of the D1 view video as shown by the arrow #22 and the clpi file of the D2 view video as shown by the arrow #23 from Interleave ClipInfo provided separately from the PlayList.

The Interleave ClipInfo includes at least one of a file name of the clpi file of the D1/D2 view video.

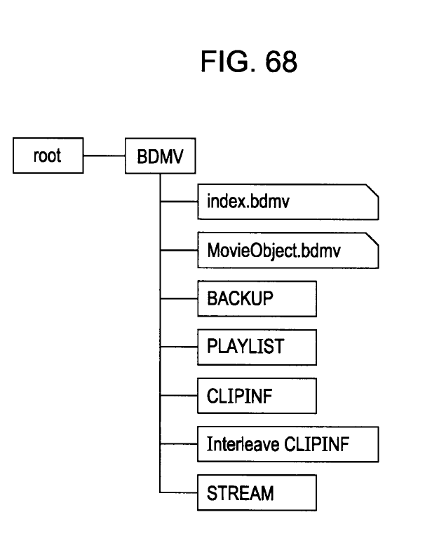

FIG. 68 is a diagram illustrating an example of the file management structure.

As shown in FIG. 68, for example, new directories such as “Interleave CLIPINF” or the like are provided in the lower ranks of the “BDMV” directory and the next of the “CLIPINF” directory or the like. The “Interleave CLIPINF” directory accommodates an Interleave ClipInfo file that is a file for referring to a clpi file of the D1/D2 view video.

When the 3D playback is performed, the playback device 201 refers to the Interleave ClipInfo file in the “Interleave CLIPINF” directory and specifies the clpi file of the D1/D2 view video used in the 3D playback together with the Base view video.

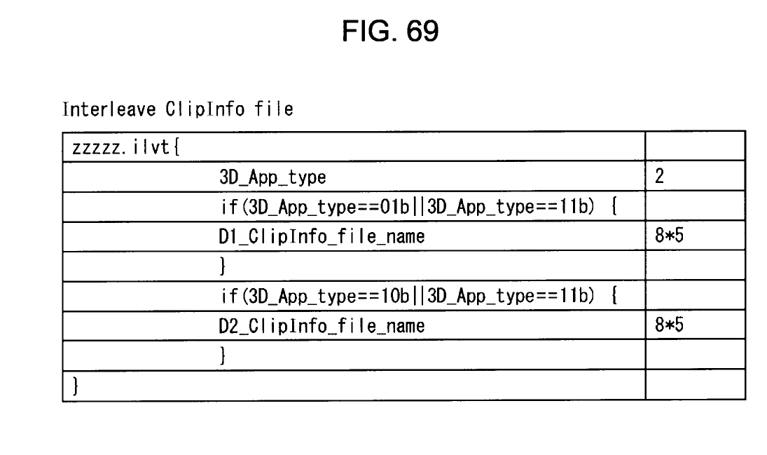

FIG. 69 is a diagram illustrating the syntax of the Interleave ClipInfo file.

The file name of the Interleave ClipInfo file of FIG. 69 is “zzzzz.ilvt”.

The 3D_App_type is set with any value described with reference to FIG. 62.

When 3D_App_type=01, for example, a B-D1 playback application refers to the Interleave ClipInfo file. In addition, when 3D_App_type=10, a B-D2 playback application refers to the Interleave ClipInfo file. When 3D_App_type=11, the B-D1 playback application and the B-D2 playback application refers to the Interleave ClipInfo file.

“if(3D_App_type==01b∥3D_App_type==11b)” indicates that the next D1_ClipInfo_file_name is referred to when the value of the 3D_App_type is 01 or 11. The D1_ClipInfo_file_name is the description to be referred to when the B-D1 playback is performed.

The D1_ClipInfo_file_name indicates a 5-digit number excluding the extension from the file name of the clpi file of the D1 view video. In case of the example of FIG. 63, the “00003” is described.

“if(3D_App_type==10b∥3D_App_type==11b)” indicates that the next D2_ClipInfo_file_name is referred to when the value of the 3D_App_type is 10 or 11. The D2_ClipInfo_file_name is a description to be referred to when the B-D2 playback is performed.

The D2_ClipInfo_file_name indicates a 5-digit number excluding the extension from the file name of the clpi file of the D2 view video. In case of the example of FIG. 63, the “00002” is described.

As such, it may be possible to newly define a file of interleaved information, and thereby, to specify the clpi file of the D1/D2 view video corresponding to the Base view video.

### Example of Composition of Recording Device

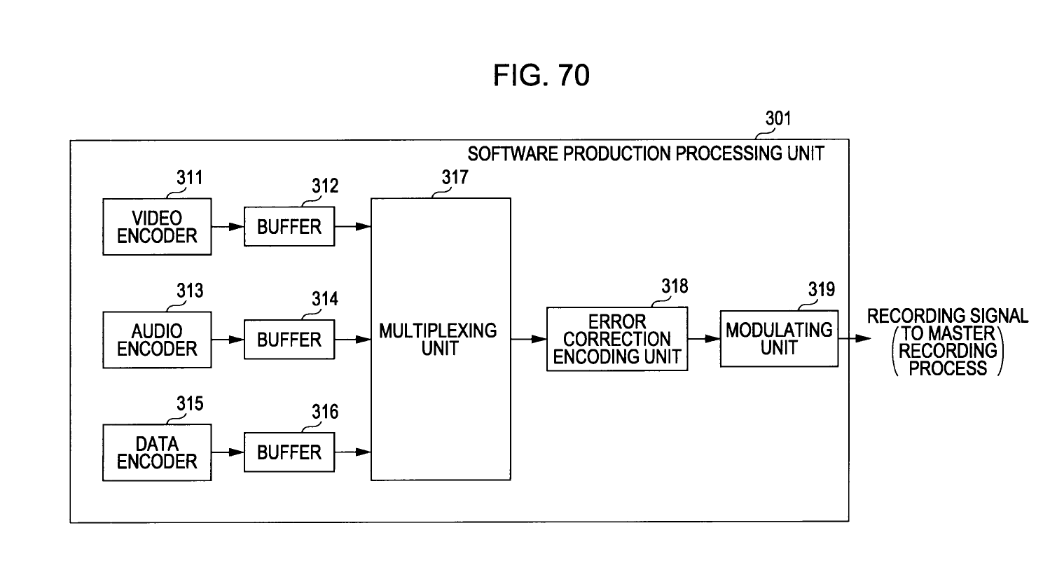

FIG. 70 is a block diagram illustrating an example of the composition of a software production processing unit 301.

A video encoder 311 has the same composition as the MVC encoder 211 of FIG. 17. The video encoder 311 generates a Base view video stream and a Dependent view video stream by encoding a plurality of video data pieces with the H.264 AVC/MVC and outputs the streams to a buffer 312.

An audio encoder 313 encodes an input audio and outputs the obtained data to the buffer 314. An audio stream recorded on a disc together with the Base view video stream and the Dependent view video stream is input to the audio encoder 313.

A data encoder 315 encodes various kinds of data described above such as the PlayList file or the like in addition to the video and the audio, and outputs the data obtained by the encoding to a buffer 316.

For example, the data encoder 315 sets a type (FIG. 32) indicating whether the data of the Base view video stream and the data of the D1/D2 view video streams are recorded on an optical disc in an Extent unit in a state of being interleaved to PlayList file.

In addition, the data encoder 315 sets the above-mentioned ilvt file to the PlayList file when the data of the Base view video stream and the data of the D1/D2 view video streams are recorded on an optical disc in a state of being interleaved. The ilvt file functions as a virtual file with which the data of the Base view video stream and the data of the D1/D2 view video streams are virtually organized and managed.

Moreover, the data encoder 315 sets the file name of a Clip Information file of each Clip to the PlayList file or sets the EP_map or the chunk_map to the Clip Information file, respectively.

The data encoder 315 sets the 3D_Clip_type (FIG. 61) and the 3D_App_type (FIG. 62) to the Clip Information file. In addition, the data encoder 315 sets information regarding Extents of the Ext_start_address, Ext_size or the like to the ExtensionData( ) that is an extended region of the Clip Information file.

A multiplexing unit 317 multiplexes video data, audio data and data other than streams stored in each buffer with synchronized signals and outputs the data to an error correction encoding unit 318.

The error correction encoding unit 318 adds error correcting codes to the data multiplexed by the multiplexing unit 317.

A modulating unit 319 carries out modulation for the data supplied from the error correction encoding unit 318 and outputs the data. The output of the modulating unit 319 forms software recorded on the optical disc 202 that can be played back in the playback device 201.

The software production processing unit 301 having such composition is provided in a recording device.

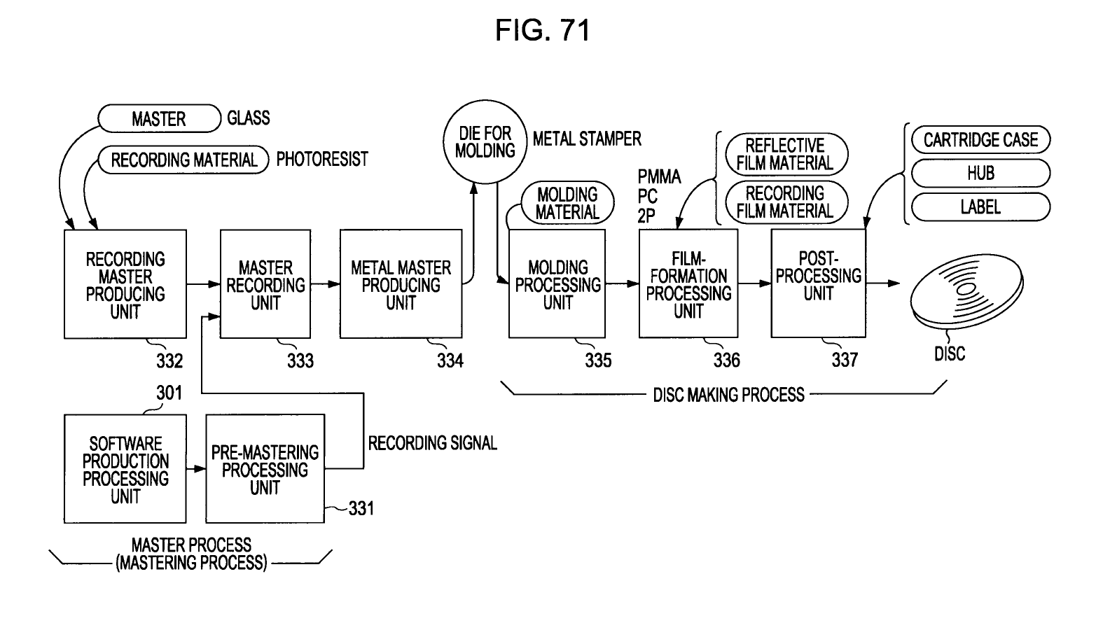

FIG. 71 is a diagram illustrating an example of the composition including the software production processing unit 301.

There is a case where a part of the composition shown in FIG. 71 is provided in a recording device.

A recording signal generated by the software production processing unit 301 is subjected to a mastering process in a pre-mastering processing unit 331, and thereby a signal of a format to be recorded on the optical disc 202 is generated. The generated signal is supplied to a master recording unit 333.

In a recording master producing unit 332, a master formed of glass or the like is prepared, and a recording material including a photoresist or the like is coated thereon. Accordingly, a recording master is produced.

In the master recording unit 333, a laser beam is modulated in response to the recording signal supplied from the pre-mastering processing unit 331, and irradiated on the photoresist on the master. Accordingly, the photoresist on the master is exposed in response to the recording signal. After that, the master is developed, and pits on the master are made to appear.

In a metal master producing unit 334, an electro-casting process is performed on the master, and a metal master where pits on the glass master are transferred is produced. A metal stamper is further produced from the metal master and the stamper becomes a die for molding.

In a molding processing unit 335, a material such as PMMA (acryl), PC (polycarbonate) or the like is poured into the die for molding by injection or the like, and fixation is performed. Or, after 2P (ultraviolet-curable resin) or the like is coated on the metal stamper, ultraviolet is irradiated to perform curing. Accordingly, pits on the metal stamper can be transferred onto a replica formed of a resin.

In a film-formation processing unit 336, a reflective film is formed on the replica by deposition, sputtering, or the like. Or, the reflective film is formed on the replica by spin-coating.

In a post-processing unit 337, a processing of inner and outer diameter is performed for the disc, and a necessary treatment such as laminating two discs or the like is performed. Furthermore, after a label is stuck or a hub is attached, the disc is inserted in a cartridge. In that way, the optical disc 202 is completed on which data played back in the playback device 201 is recorded.

A series of the processes described above can be executed by hardware, and by software. When a series of the processes is executed by software, a program forming the software is installed in a computer incorporated in dedicated hardware, or a general personal computer.

The installed program is provided by being recorded in the removable recording medium 111 of FIG. 14. In addition, the program may be provided via a wired or wireless transmission medium such as a local area network, the Internet, and digital broadcasting.

The present application contains subject matter related to that disclosed in Japanese Priority Patent Application JP 2009-093160 filed in the Japan Patent Office on Apr. 7, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
setting unit configured to set Clip type information that is information indicating a Clip of Base view video to a Clip information file describing information about a Clip that is a playback zone of a stream of the Base view video generated by encoding a plurality of video data with predetermined encoding format, and set Clip type information indicating a Clip of Dependent view video to a Clip information file of the Clip of the Dependent view video generated by the encoding.

2. The information processing apparatus according to claim 1, wherein the setting unit sets application type information that is information indicating a type of an application that performs a process by using a Clip to each of the Clip information file of the Base view video and the Clip information file of the Dependent view video.

3. The information processing apparatus according to claim 1, wherein the setting unit sets identification information of the Clip information file of the Clip of the Dependent view video used in the playback of three-dimensional images together with the data of the Clip of the Base view video to an extended region of the Clip information file of the Base view video.

4. The information processing apparatus according to claim 3, wherein the setting unit further sets identification information of a virtual file that manages data of the Clip of the Base view video and data of the Clip of the Dependent view video to an extended region of the Clip information file of the Base view video.

5. The information processing apparatus according to claim 1, wherein, when the data of the Clip of the Base view video and the data of the Clip of the Dependent view video are recorded on an optical disc in a state of being interleaved in an Extent unit that is a predetermined data unit, the setting means sets information about the Extent of the Base view video to an extended region of the Clip information file of the Base view video and sets information about the Extent of the Dependent view video to an extended region of the Clip information file of the Clip of the Dependent view video.

6. The information processing apparatus according to claim 5, wherein the information about the Extents includes position information and length information in the optical disc of each of the Extents.

7. An information processing method, comprising the steps of:
setting Clip type information that is information indicating a Clip of Base view video to a Clip information file describing information about a Clip that is a playback zone of a stream of the Base view video generated by encoding a plurality of video data with predetermined encoding format; and
setting Clip type information indicating a Clip of Dependent view video to a Clip information file of the Clip of the Dependent view video generated by the encoding.

8. A program prompting a computer to execute a process comprising the steps of:
setting Clip type information that is information indicating a Clip of Base view video to a Clip information file describing information about a Clip that is a playback zone of a stream of the Base view video generated by encoding a plurality of video data with predetermined encoding format; and
setting Clip type information indicating a Clip of Dependent view video to a Clip information file of the Clip of the Dependent view video generated by the encoding.

9. A recording medium that is set with Clip type information that is information indicating a Clip of Base view video to a Clip information file describing information about a Clip that is a playback zone of a stream of the Base view video generated by encoding a plurality of video data with predetermined encoding format, and set with Clip type information indicating a Clip of Dependent view video to a Clip information file of the Clip of the Dependent view video generated by the encoding.
